(19) United States
(12) Patent Application Publication
(10) Pub. No.: US 2026/0225046 A1
(43) Pub. Date: Aug. 6, 2026

(54) NORBORNYL BENZOCYCLOBUTENE LADDER POLYMER COMPOSITE MEMBRANES FOR FLUID SEPARATION

(71) Applicant: OSMOSES INC., Cambridge, MA (US)

(72) Inventors: Holden Wan Hong Lai, Boston, MA (US); Nicholas C. Bruno, Cambridge, MA (US)

(21) Appl. No.: 19/153,075

(22) PCT Filed: Feb. 1, 2024
(86) PCT No.: PCT/US2024/013947

§ 371 Date: Aug. 1, 2025

Related U.S. Application Data
(60) Provisional application No. 63/482,843, filed on Feb. 2, 2023.
(60) Provisional application No. 63/532,123, filed on Aug. 11, 2023.

(51) Int. Cl. B01D 69/12; B01D 53/22; B01D 67/00; B01D 69/02; B01D 69/10; B01D 71/64; C08G 73/10

(52) U.S. Cl. CPC B01D 69/1216; B01D 53/228; B01D 67/0013; B01D 67/0083; B01D 67/0095; B01D 69/02; B01D 69/107; B01D 69/1214; B01D 71/64; C08G 73/1039; C08G 73/1067; B01D 2256/10; B01D 2256/18; B01D 2257/108; B01D 2257/7025; B01D 2323/12; B01D 2325/04

(57) ABSTRACT

Provided herein are ladder polymer composite membranes comprising norbornyl benzocyclobutene moieties, and methods of separating mixtures of fluids using the same.

### CROSS-REFERENCE TO RELATED APPLICATIONS

This application claims the benefit of priority to U.S. Provisional Application No. U.S. 63/482,843, filed Feb. 2, 2023, and U.S. Provisional Application 63/532,123, filed Aug. 11, 2023, the contents of each of which are hereby incorporated in their entirety.

### BACKGROUND

Norbornyl benzocyclobutene ladder polymer membranes have been demonstrated to provide exceptional fluid separation performance through permeation experiments performed on thick films (>5 μm). However, said thick film membranes may be disadvantageous for industrial applications, and may also require long term (>150 days) aging in the form of curing before selectivity for fluid separation can be observed. Accordingly, there is a need for membranes of an industrially practical thickness that exhibit selectivity for gas separation without long-term aging.

### SUMMARY OF THE INVENTION

In certain aspects, provided herein are composite membrane comprising:
a mesoporous membrane support layer comprising a plurality of pores extending through the support layer, said support layer having a first side, a second side, and a thickness; and
optionally, a gutter layer comprising a permeable elastic polymer, said gutter layer having a first side, a second side, and a thickness;
a thin film membrane selective layer comprising a plurality of ladder polymer chains, said selective layer having a first side, a second side, and a thickness;
wherein:
when the gutter layer is present, the second side of the support layer is disposed along the first side of the gutter layer, and the second side of the gutter layer is disposed along the first side of the selective layer;
when the gutter layer is absent, the second side of the support layer is disposed along the first side of the selective layer; and
the thickness of the selective layer is less than about 10 microns.

In further aspects, provided herein are methods preparing the composite membranes of the disclosure, optionally wherein said methods comprise:
providing a support mixture comprising a support polymer precursor, a first solvent, and a second solvent, the support mixture having a first solvent:second solvent ratio;
contacting the support mixture with a substrate, thereby forming a nascent support;
curing the nascent support, the thereby forming a mesoporous support;
providing a selective solution comprising a selective polymer precursor and a third solvent;
coating the mesoporous support with the selective solution, thereby forming a nascent membrane;
annealing and drying the nascent membrane to form the composite membrane.

In yet further aspects, provided herein are methods of separating mixtures of fluids comprising a first fluid and a second fluid, the method comprising:
contacting a fluid mixture with a composite membrane of the present disclosure, thereby separating the mixture of fluids into:
a permeate comprising a first portion of the first fluid and a first portion of the second fluid; and
a retentate comprising a second portion of the second fluid.

### BRIEF DESCRIPTION OF THE DRAWINGS

FIG. 1A shows a scanning electron microscopy (SEM) image of a support dope comprising 20% PEI, 38% DMSO, 38% dioxane, 4% EtOH.

FIG. 1B shows a scanning electron microscopy (SEM) image of a composite membrane comprising an ~700 nm active layer of the polymer of Example 12 on a support dope comprising 20% PEI, 38% DMSO, 38% dioxane, 4% EtOH.

FIG. 1C shows a scanning electron microscopy (SEM) image of a composite membrane of Example 13 comprising a 1 um active layer.

FIG. 1D shows a scanning electron microscopy (SEM) image of a support dope comprising 20% Ultem, 40% DMSO, 40% dioxane.

FIG. 1E shows a scanning electron microscopy (SEM) image of a support dope comprising 20% Ultem, 68% NMP, 10% THF, 1% water, 1% lithium nitrate by weight.

FIG. 1F shows a scanning electron microscopy (SEM) image of a support dope comprising 18% Ultem, 61.5% NMP, and 20.5% dioxane by weight.

FIG. 2A shows selectivity for various gas pairs of the composite membrane of Example 12 between 30-150 psi.

FIG. 2B shows selectivity for various gas pairs of the composite membrane of Example 12 between 30-360 psi.

FIG. 3A shows selectivity for H₂/CH₄ of the composite membrane of Example 12 at varying temperatures and pressures.

FIG. 3B shows selectivity for H₂/C₂H₆ of the composite membrane of Example 12 at varying temperatures and pressures.

FIG. 3C shows selectivity for H₂/C₃H₈ of the composite membrane of Example 12 at varying temperatures and pressures.

FIG. 3D shows selectivity for H₂/C₂H₄ of the composite membrane of Example 12 at varying temperatures and pressures.

FIG. 4A shows selectivity for CO₂/fluorocarbon of the composite membrane of Example 12 at varying pressure.

FIG. 4B shows selectivity for fluorocarbon/fluorocarbon and CO₂/fluorocarbon of the composite membrane of Example 12 at varying pressure.

FIG. 5 shows H₂/CH₄ selectivity results of the TFC membranes provided in Example 27 at 35° C. and varying pressure.

FIG. 6 shows CO₂/CH₄ selectivity results of TFC membranes provided in Example 27 at 35° C. and varying pressure.

FIG. 7 shows selectivity results of TFC membranes provided in Example 27 at 35° C. and 4 bar in varying CO₂/CH₄/H₂S mixtures.

FIG. 8 shows the selectivity of TFC membranes provided in Example 33 to varying gases at varying pressures at 35° C.

FIG. 9 shows permeance and selectivities of TFC membranes provided in Example 20 to C₂F₄H₂ at 35° C. and varying pressures.

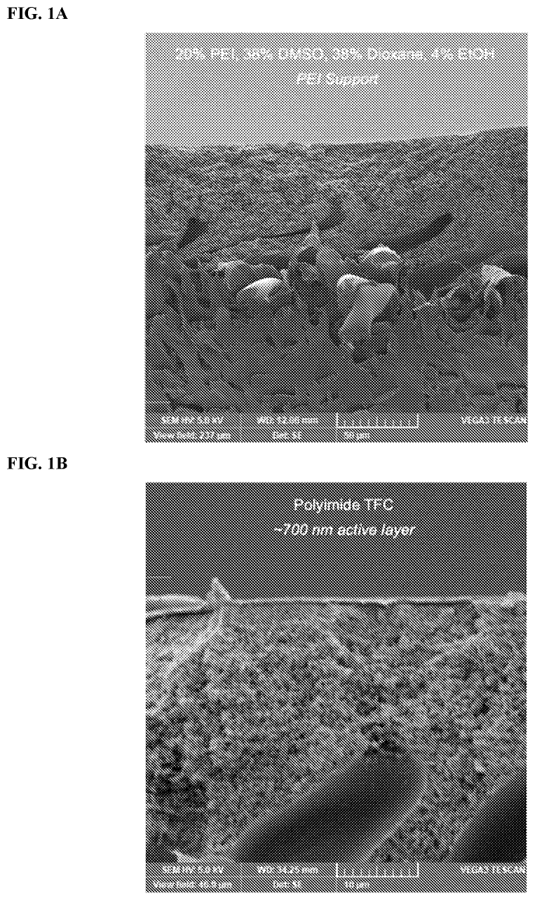

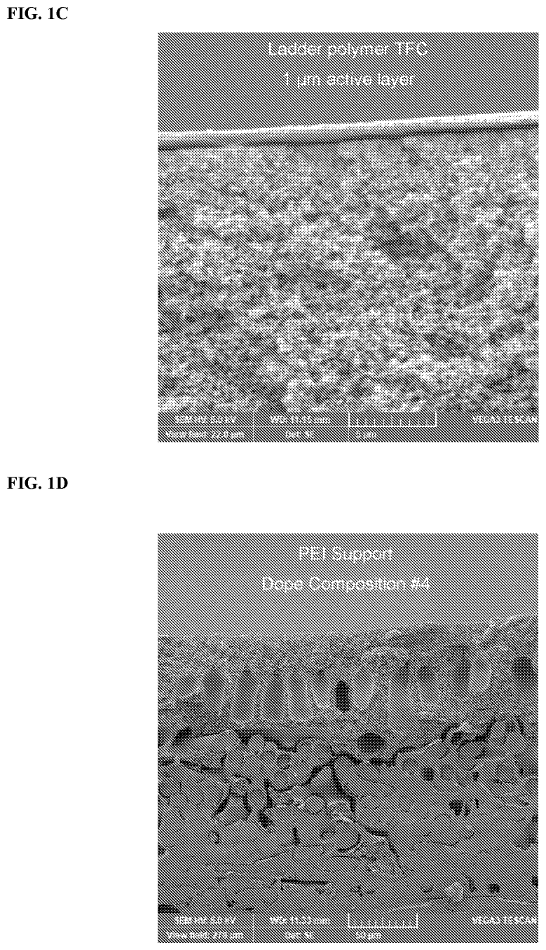

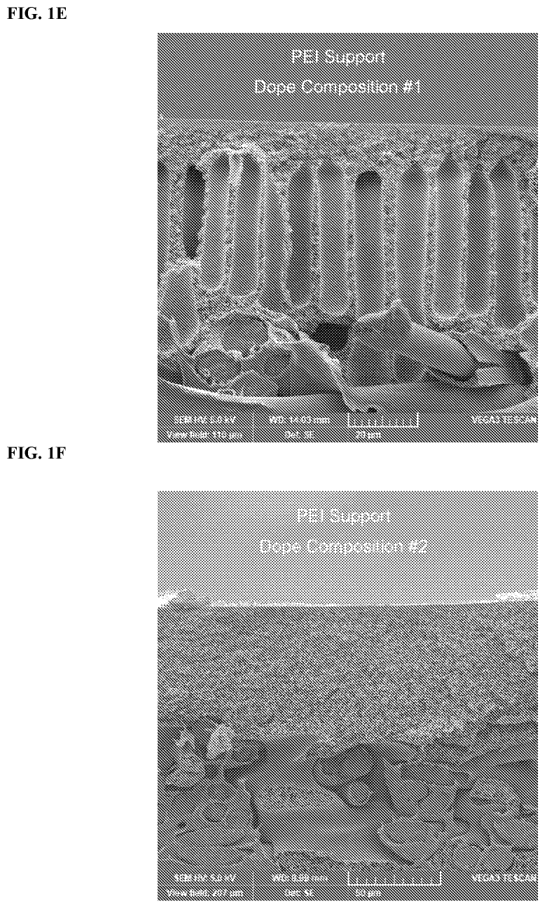

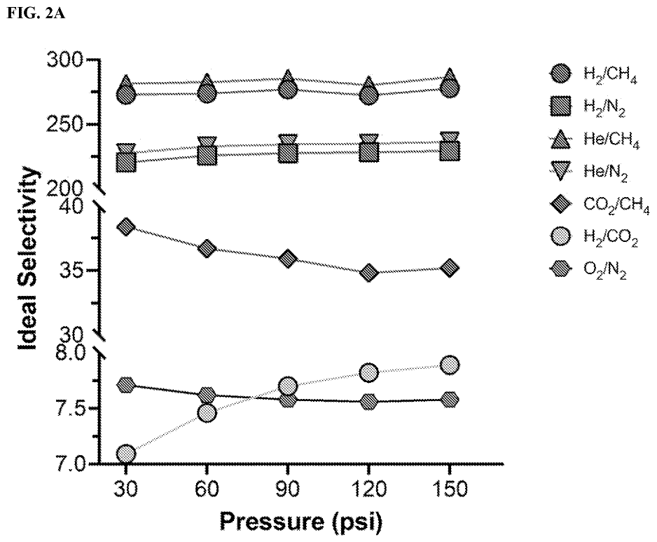

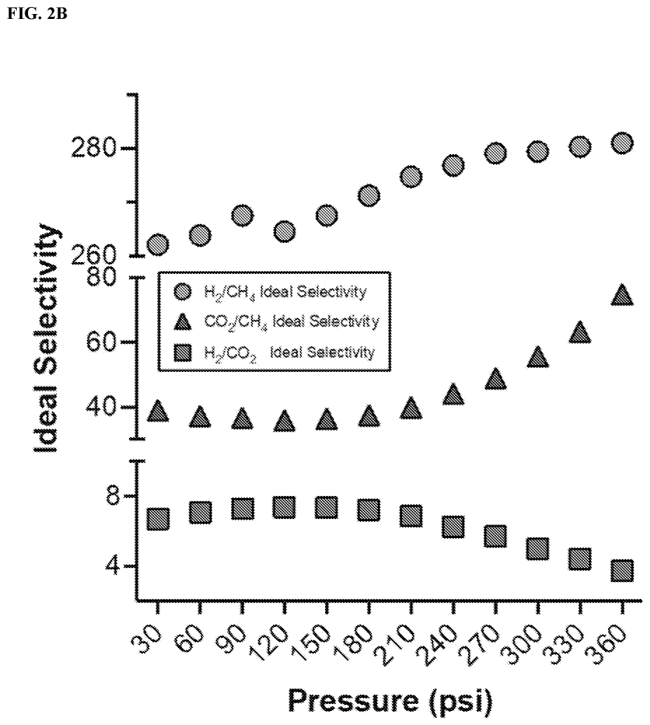

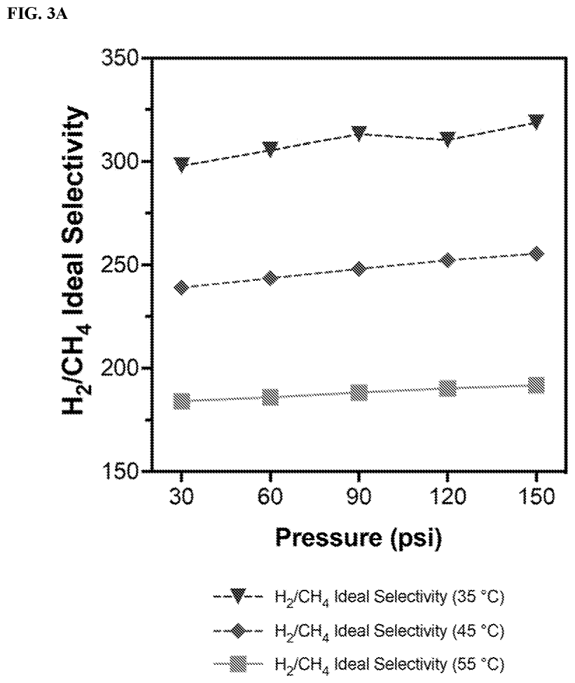

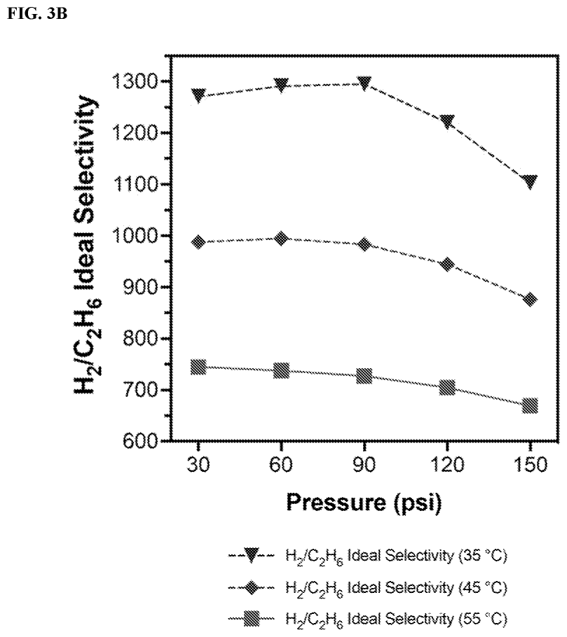

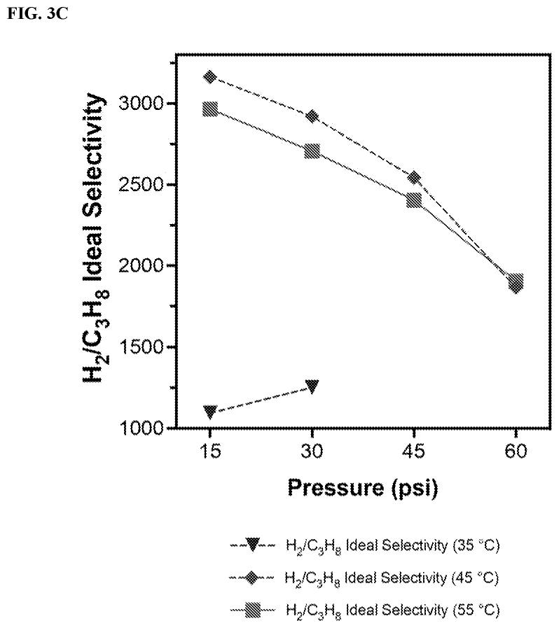

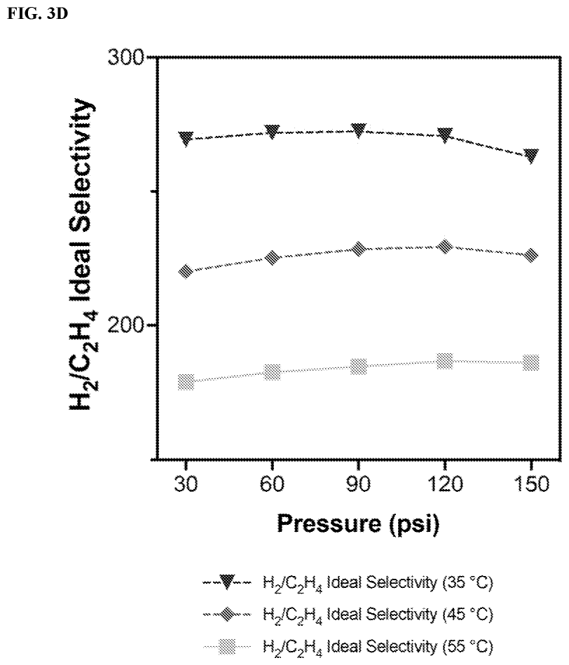

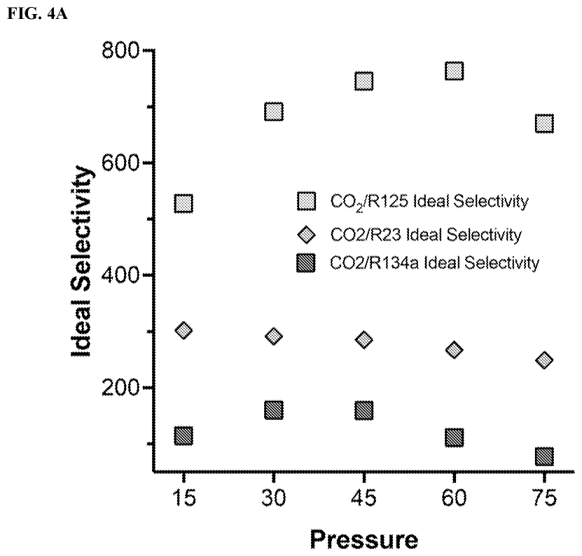

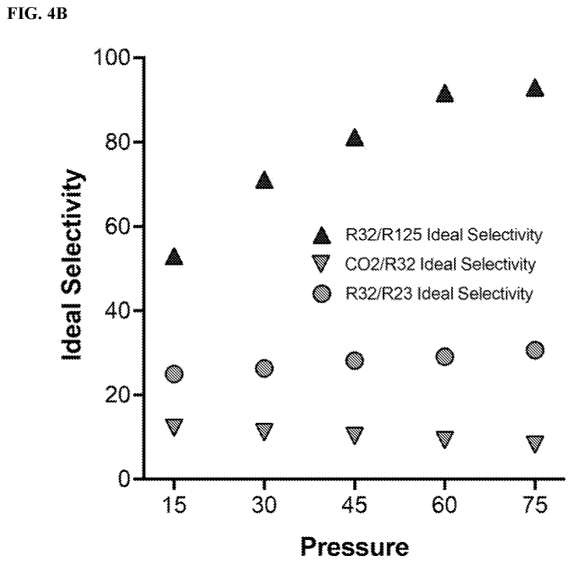

### DETAILED DESCRIPTION OF THE INVENTION

Norbornyl benzocyclobutene ladder polymers have highly rigid and contorted backbone, preventing the efficient packing of polymer chains in the solid state and leading to the formation of angstrom-sized pores in the polymer matrix. By forming the norbornyl benzocyclobutene ladder polymers into membranes, the resulting pores can be leveraged for size-selective molecular separations (WO2021101659A3). The exceptional gas separation performance of norbornyl benzocyclobutene polymer membranes have been demonstrated in permeation experiments of thick (>5 um) films (Lai et al. Science 2022, 375 (6587), 1390-1392). After aging of the polymer films, H₂/CH₄ selectivity of >600 was demonstrated in pure-gas permeation experiments, surpassing the performance of virtually all solution processable polymeric membranes. Additionally, high-pressure CO₂/CH₄ mixed-gas permeation experiments demonstrated selectivity >50. Norbornyl benzocyclobutene polymer membranes also has exceptional separation performance for other industrially relevant gas pairs such as O₂/N₂, H₂/N₂, and H₂/CO₂.

While thick polymer films can be excellent for understanding fundamental polymer properties, they are impractical for industrial applications due to their low flux. Transport resistance of membranes is generally proportional to the thickness of the selective layer. The low permeance of thick films means that much larger membrane areas would be required to achieve a certain throughput, greatly increasing membrane capital expenses. For industrial applications, norbornyl benzocyclobutene membranes with thicknesses of ~1 um are necessary. Additionally, previous work demonstrated that long-term aging (>150 days) is required for thick films of norbornyl benzocyclobutene polymer membranes to achieve the high selectivity reported. To address both of the above challenges, provided herein is a general method for the fabrication of thin-film composite (TFC) membranes with norbornyl benzocyclobutene polymers as the selective layer. Even without long-term aging of the selective layer, the thin-film composite membranes have gas selectivity exceeding those previously reported for aged thick films.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All of the above, and any other publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

It is understood that substituents and substitution patterns on the compounds described herein can be selected by one of ordinary skilled person in the art to result chemically stable compounds which can be readily synthesized by techniques known in the art, as well as those methods set forth below, from readily available starting materials. If a substituent is itself substituted with more than one group, it is understood that these multiple groups may be on the same carbon or on different carbons, so long as a stable structure results.

As used herein, the term “optionally substituted” refers to the replacement of one to six hydrogen radicals in a given structure with the radical of a specified substituent including, but not limited to: hydroxy, hydroxyalkyl, alkoxy, halogen, alkyl, nitro, silyl, acyl, acyloxy, aryl, cycloalkyl, heterocyclyl, amino, aminoalkyl, cyano, haloalkyl, haloalkoxy, —OCO—CH₂—O-alkyl, —OP(O)(O-alkyl)₂ or —CH₂—OP(O)(O-alkyl)₂. Preferably, “optionally substituted” refers to the replacement of one to four hydrogen radicals in a given structure with the substituents mentioned above. More preferably, one to three hydrogen radicals are replaced by the substituents as mentioned above. It is understood that the substituent can be further substituted.

As used herein, the term “alkyl” refers to saturated aliphatic groups, including but not limited to C₁-C₁₀ straight-chain alkyl groups or C₁-C₁₀ branched-chain alkyl groups. Preferably, the “alkyl” group refers to C₁-C₆ straight-chain alkyl groups or C₁-C₆ branched-chain alkyl groups. Most preferably, the “alkyl” group refers to C₁-C₄ straight-chain alkyl groups or C₁-C₄ branched-chain alkyl groups. Examples of “alkyl” include, but are not limited to, methyl, ethyl, 1-propyl, 2-propyl, n-butyl, sec-butyl, tert-butyl, 1-pentyl, 2-pentyl, 3-pentyl, neo-pentyl, 1-hexyl, 2-hexyl, 3-hexyl, 1-heptyl, 2-heptyl, 3-heptyl, 4-heptyl, 1-octyl, 2-octyl, 3-octyl or 4-octyl and the like. The “alkyl” group may be optionally substituted.

The term “acyl” is art-recognized and refers to a group represented by the general formula hydrocarbylC(O)—, preferably alkylC(O)—.

The term “acylamino” is art-recognized and refers to an amino group substituted with an acyl group and may be represented, for example, by the formula hydrocarbylC(O)NH—.

The term “acyloxy” is art-recognized and refers to a group represented by the general formula hydrocarbylC(O)O—, preferably alkylC(O)O—.

The term “alkoxy” refers to an alkyl group having an oxygen attached thereto. Representative alkoxy groups include methoxy, ethoxy, propoxy, tert-butoxy and the like.

The term “alkoxyalkyl” refers to an alkyl group substituted with an alkoxy group and may be represented by the general formula alkyl-O-alkyl.

The term “alkyl” refers to saturated aliphatic groups, including straight-chain alkyl groups, branched-chain alkyl groups, cycloalkyl (alicyclic) groups, alkyl-substituted cycloalkyl groups, and cycloalkyl-substituted alkyl groups. In preferred embodiments, a straight chain or branched chain alkyl has 30 or fewer carbon atoms in its backbone (e.g., C₁₋₃₀ for straight chains, C₃₋₃₀ for branched chains), and more preferably 20 or fewer.

Moreover, the term “alkyl” as used throughout the specification, examples, and claims is intended to include both unsubstituted and substituted alkyl groups, the latter of which refers to alkyl moieties having substituents replacing a hydrogen on one or more carbons of the hydrocarbon backbone, including haloalkyl groups such as trifluoromethyl and 2,2,2-trifluoroethyl, etc.

The term “C_{x-y}” or “Cₓ-C_{y}”, when used in conjunction with a chemical moiety, such as, acyl, acyloxy, alkyl, alkenyl, alkynyl, or alkoxy is meant to include groups that contain from x to y carbons in the chain. C₀alkyl indicates a hydrogen where the group is in a terminal position, a bond if internal. A C₁₋₆alkyl group, for example, contains from one to six carbon atoms in the chain.

The term “alkylamino”, as used herein, refers to an amino group substituted with at least one alkyl group.

The term “alkylthio”, as used herein, refers to a thiol group substituted with an alkyl group and may be represented by the general formula alkylS—.

The term “amide”, as used herein, refers to a group

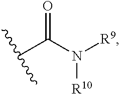

wherein R⁹ and R¹⁰ each independently represent a hydrogen or hydrocarbyl group, or R⁹ and R¹⁰ taken together with the N atom to which they are attached complete a heterocycle having from 4 to 8 atoms in the ring structure.

The terms “amine” and “amino” are art-recognized and refer to both unsubstituted and substituted amines and salts thereof, e.g., a moiety that can be represented by

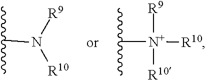

wherein R⁹, R¹⁰, and R^{10′} each independently represent a hydrogen or a hydrocarbyl group, or R⁹ and R¹⁰ taken together with the N atom to which they are attached complete a heterocycle having from 4 to 8 atoms in the ring structure.

The term “aminoalkyl”, as used herein, refers to an alkyl group substituted with an amino group.

The term “aralkyl”, as used herein, refers to an alkyl group substituted with an aryl group.

The term “aryl” as used herein includes substituted or unsubstituted single-ring aromatic groups in which each atom of the ring is carbon. Preferably the ring is a 5- to 7-membered ring, more preferably a 6-membered ring. The term “aryl” also includes polycyclic ring systems having two or more cyclic rings in which two or more carbons are common to two adjoining rings wherein at least one of the rings is aromatic, e.g., the other cyclic rings can be cycloalkyls, cycloalkenyls, cycloalkynyls, aryls, heteroaryls, and/or heterocyclyls. Aryl groups include benzene, naphthalene, phenanthrene, phenol, aniline, and the like.

The term “carbamate” is art-reco ized and refers to a group

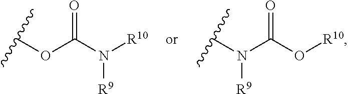

wherein R⁹ and R⁰ independently represent hydrogen or a hydrocarbyl group.

The term “carbocyclylalkyl”, as used herein, refers to an alkyl group substituted with a carbocycle group.

The term “carbocycle” includes 5-7 membered monocyclic and 8-12 membered bicyclic rings. Each ring of a bicyclic carbocycle may be selected from saturated, unsaturated and aromatic rings. Carbocycle includes bicyclic molecules in which one, two or three or more atoms are shared between the two rings. The term “fused carbocycle” refers to a bicyclic carbocycle in which each of the rings shares two adjacent atoms with the other ring. Each ring of a fused carbocycle may be selected from saturated, unsaturated and aromatic rings. In an exemplary embodiment, an aromatic ring, e.g., phenyl, may be fused to a saturated or unsaturated ring, e.g., cyclohexane, cyclopentane, or cyclohexene. Any combination of saturated, unsaturated and aromatic bicyclic rings, as valence permits, is included in the definition of carbocyclic. Exemplary “carbocycles” include cyclopentane, cyclohexane, bicyclo[2.2.1]heptane, 1,5-cyclooctadiene, 1,2,3,4-tetrahydronaphthalene, bicyclo[4.2.0]oct-3-ene, naphthalene and adamantane. Exemplary fused carbocycles include decalin, naphthalene, 1,2,3,4-tetrahydronaphthalene, bicyclo[4.2.0]octane, 4,5,6,7-tetrahydro-1H-indene and bicyclo[4.1.0]hept-3-ene. “Carbocycles” may be substituted at any one or more positions capable of bearing a hydrogen atom.

The term “carbocyclylalkyl”, as used herein, refers to an alkyl group substituted with a carbocycle group.

The term “carbonate” is art-recognized and refers to a group —OCO₂—.

The term “carboxy”, as used herein, refers to a group represented by the formula —CO₂H.

The term “cycloalkyl” includes substituted or unsubstituted non-aromatic single ring structures, preferably 4- to 8-membered rings, more preferably 4- to 6-membered rings. The term “cycloalkyl” also includes polycyclic ring systems having two or more cyclic rings in which two or more carbons are common to two adjoining rings wherein at least one of the rings is cycloalkyl and the substituent (e.g., R¹⁰⁰) is attached to the cycloalkyl ring, e.g., the other cyclic rings can be cycloalkyls, cycloalkenyls, cycloalkynyls, aryls, heteroaryls, and/or heterocyclyls.

The term “ester”, as used herein, refers to a group —C(O)OR⁹ wherein R⁹ represents a hydrocarbyl group.

The term “ether”, as used herein, refers to a hydrocarbyl group linked through an oxygen to another hydrocarbyl group. Accordingly, an ether substituent of a hydrocarbyl group may be hydrocarbyl-O—. Ethers may be either symmetrical or unsymmetrical.

Examples of ethers include, but are not limited to, heterocycle-O-heterocycle and aryl-O-heterocycle. Ethers include “alkoxyalkyl” groups, which may be represented by the general formula alkyl-O-alkyl.

The terms “halo” and “halogen” as used herein means halogen and includes chloro, fluoro, bromo, and iodo.

The terms “hetaralkyl” and “heteroaralkyl”, as used herein, refers to an alkyl group substituted with a hetaryl group.

The terms “heteroaryl” and “hetaryl” include substituted or unsubstituted aromatic single ring structures, preferably 5- to 7-membered rings, more preferably 5- to 6-membered rings, whose ring structures include at least one heteroatom, preferably one to four heteroatoms, more preferably one or two heteroatoms. The terms “heteroaryl” and “hetaryl” also include polycyclic ring systems having two or more cyclic rings in which two or more carbons are common to two adjoining rings wherein at least one of the rings is heteroaromatic, e.g., the other cyclic rings can be cycloalkyls, cycloalkenyls, cycloalkynyls, aryls, heteroaryls, and/or heterocyclyls. Heteroaryl groups include, for example, pyrrole, furan, thiophene, imidazole, oxazole, thiazole, pyrazole, pyridine, pyrazine, pyridazine, and pyrimidine, and the like.

The term “heteroatom” as used herein means an atom of any element other than carbon or hydrogen. Preferred heteroatoms are nitrogen, oxygen, and sulfur.

The term “heterocyclylalkyl”, as used herein, refers to an alkyl group substituted with a heterocycle group.

The terms “heterocyclyl”, “heterocycle”, and “heterocyclic” refer to substituted or unsubstituted non-aromatic ring structures, preferably 3- to 10-membered rings, more preferably 3- to 7-membered rings, whose ring structures include at least one heteroatom, preferably one to four heteroatoms, more preferably one or two heteroatoms. The terms “heterocyclyl” and “heterocyclic” also include polycyclic ring systems having two or more cyclic rings in which two or more carbons are common to two adjoining rings wherein at least one of the rings is heterocyclic, e.g., the other cyclic rings can be cycloalkyls, cycloalkenyls, cycloalkynyls, aryls, heteroaryls, and/or heterocyclyls. Heterocyclyl groups include, for example, piperidine, piperazine, pyrrolidine, morpholine, lactones, lactams, and the like.

The term “hydrocarbyl”, as used herein, refers to a group that is bonded through a carbon atom that does not have a ═O or ═S substituent, and typically has at least one carbon-hydrogen bond and a primarily carbon backbone, but may optionally include heteroatoms. Thus, groups like methyl, ethoxyethyl, 2-pyridyl, and even trifluoromethyl are considered to be hydrocarbyl for the purposes of this application, but substituents such as acetyl (which has a ═O substituent on the linking carbon) and ethoxy (which is linked through oxygen, not carbon) are not. Hydrocarbyl groups include, but are not limited to aryl, heteroaryl, carbocycle, heterocycle, alkyl, alkenyl, alkynyl, and combinations thereof.

The term “hydroxyalkyl”, as used herein, refers to an alkyl group substituted with a hydroxy group.

The term “lower” when used in conjunction with a chemical moiety, such as, acyl, acyloxy, alkyl, alkenyl, alkynyl, or alkoxy is meant to include groups where there are ten or fewer atoms in the substituent, preferably six or fewer. A “lower alkyl”, for example, refers to an alkyl group that contains ten or fewer carbon atoms, preferably six or fewer. In certain embodiments, acyl, acyloxy, alkyl, alkenyl, alkynyl, or alkoxy substituents defined herein are respectively lower acyl, lower acyloxy, lower alkyl, lower alkenyl, lower alkynyl, or lower alkoxy, whether they appear alone or in combination with other substituents, such as in the recitations hydroxyalkyl and aralkyl (in which case, for example, the atoms within the aryl group are not counted when counting the carbon atoms in the alkyl substituent).

The terms “polycyclyl”, “polycycle”, and “polycyclic” refer to two or more rings (e.g., cycloalkyls, cycloalkenyls, cycloalkynyls, aryls, heteroaryls, and/or heterocyclyls) in which two or more atoms are common to two adjoining rings, e.g., the rings are “fused rings”. Each of the rings of the polycycle can be substituted or unsubstituted. In certain embodiments, each ring of the polycycle contains from 3 to 10 atoms in the ring, preferably from 5 to 7.

The term “sulfate” is art-recognized and refers to the group —OSO₃H, or a pharmaceutically acceptable salt thereof.

The term “sulfonamide” is art-recognized and refers to the group represented by the general formulae

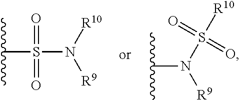

wherein R⁹ and R⁰ independently represent hydrogen or hydrocarbyl.

The term “sulfoxide” is art-recognized and refers to the group-S(O)—.

The term “sulfonate” is art-recognized and refers to the group SO₃H, or a pharmaceutically acceptable salt thereof.

The term “sulfone” is art-recognized and refers to the group —S(O)₂—.

The term “substituted” refers to moieties having substituents replacing a hydrogen on one or more carbons of the backbone. It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, etc. As used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. The permissible substituents can be one or more and the same or different for appropriate organic compounds. For purposes of this disclosure, the heteroatoms such as nitrogen may have hydrogen substituents and/or any permissible substituents of organic compounds described herein which satisfy the valences of the heteroatoms. Substituents can include any substituents described herein, for example, a halogen, a hydroxy, a carbonyl (such as a carboxyl, an alkoxycarbonyl, a formyl, or an acyl), a thiocarbonyl (such as a thioester, a thioacetate, or a thioformate), an alkoxy, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. It will be understood by those skilled in the art that the moieties substituted on the hydrocarbon chain can themselves be substituted, if appropriate.

The term “thioalkyl”, as used herein, refers to an alkyl group substituted with a thiol group.

The term “thioester”, as used herein, refers to a group —C(O)SR⁹ or —SC(O)R⁹ wherein R⁹ represents a hydrocarbyl.

The term “thioether”, as used herein, is equivalent to an ether, wherein the oxygen is replaced with a sulfur.

The term “urea” is art-recognized and may be represented by the general formula

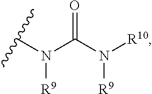

wherein R⁹ and R¹⁰ independently represent hydrogen or a hydrocarbyl.

Some of the compounds useful in the methods and compositions of this disclosure have at least one stereogenic center in their structure. This stereogenic center may be present in a R or a S configuration, said R and S notation is used in correspondence with the rules described in Pure Appl. Chem. (1976), 45, 11-30. The disclosure contemplates all stereoisomeric forms such as enantiomeric and diastereoisomeric forms of the compounds, salts, prodrugs or mixtures thereof (including all possible mixtures of stereoisomers). See, e.g., WO 01/062726.

Furthermore, certain compounds which contain alkenyl groups may exist as Z (zusammen) or E (entgegen) isomers. In each instance, the disclosure includes both mixture and separate individual isomers.

Some of the compounds may also exist in tautomeric forms. Such forms, although not explicitly indicated in the formulae described herein, are intended to be included within the scope of the present disclosure.

The term “Log of solubility”, “Log S” or “log S” as used herein is used in the art to quantify the aqueous solubility of a compound. The aqueous solubility of a compound significantly affects its absorption and distribution characteristics. A low solubility often goes along with a poor absorption. Log S value is a unit stripped logarithm (base 10) of the solubility measured in mol/liter.

The term “weight average molecular weight,” also abbreviated in some instances as Mw, as used herein refers to the sum of the molecular weights of each polymer chain in a mixture of polymer chains, divided by the total number of chains in the mixture.

The term “glass transition temperature” or “T_{G}” as used herein refers to the temperature or range of temperatures at which a polymer or mixture of polymers undergoes a phase transition from a “glassy” or amorphous solid state to a viscous liquid or semi-liquid state. In some embodiments, this transition may also be characterized by a decrease in the brittle nature of the glassy material.

The term “decomposition temperature” as used herein refers to the temperature at which a substance, e.g., a polymer of the disclosure, begins to decompose or undergo a chemical change to the composition of the substance.

The terms “statistical mixture” and “statistical copolymer” refer to copolymers in which the sequential distribution of the monomeric units obeys known statistical laws, e.g., the monomer sequence distribution may follow Markovian statistics of zeroth (Bernoullian), first, second, or higher order. The elementary processes leading to the formation of a statistical sequence of monomeric units do not necessarily proceed with equal apriori probability. These processes may, in some embodiments, lead to various types of sequence distribution comprising those in which the arrangement of monomeric units tends toward alternation, tends toward clustering of like units, or exhibits no ordering tendency at all. These terms may be used interchangeably herein.

As used herein, the term “Monomer” may refer to a sub-unit which is either present in a precursor form (e.g., a dihalide-substituted precursor) or is incorporated into a polymer's structure (e.g., units of Formula I may be referred to as monomers).

The term “dispersity,” (abbreviated D) is art-recognized, and is used herein is a measure of the distribution of sizes (e.g., molecular weight, chain length) in a mixture of polymers. This quantity can also be referred to as the polydispersity index, or PDI.

As used herein, the term “curing” or “cured” refer to a material that has undergone a process that results in the material taking on a form, shape, configuration, or structure that cannot be reprocessed, molded, or extruded into a different one. Such processing involves exposing said materials to certain conditions (e.g., heat, oxygen, chemical initiators) to initiate the curing process. Materials that have not been cured, or for which curing is not required, refer to materials that have not been aged for a period of time, or that have not been subjected to the conditions required to initiate and/or maintain a curing process, or for which a curing process is not complete.

As used herein, the term “fluid” refers to gases, liquids, supercritical fluids, and combinations thereof.

As used herein, the term “permeate” refers to fluid that has come into contact with a composite membrane of the disclosure, but has not been removed by, or adsorbed/absorbed to, said composite membrane. “Permeate” often refers to a fluid or mixture of fluids from which some or all of any impurities or undesired fluids have been removed.

As used herein, the term “retentate” refers to fluid (generally an impurity fluid) that has been removed by, and/or adsorbed/absorbed to, a composite membrane of the disclosure, and thereby separated from the permeate.

### Composite Membranes

In certain aspects, provided herein are composite membranes comprising:
a mesoporous membrane support layer comprising a plurality of pores extending through the support layer, said support layer having a first side, a second side, and a thickness; and
optionally, a gutter layer comprising a permeable elastic polymer, said gutter layer having a first side, a second side, and a thickness;
a thin film membrane selective layer comprising a plurality of ladder polymer chains, said selective layer having a first side, a second side, and a thickness;
wherein:
when the gutter layer is present, the second side of the support layer is disposed along the first side of the gutter layer, and the second side of the gutter layer is disposed along the first side of the selective layer;
when the gutter layer is absent, the second side of the support layer is disposed along the first side of the selective layer; and
the thickness of the selective layer is less than about 10 microns.

In certain embodiments, the thickness of the selective layer is from about 0.1 to about 10 microns. In further embodiments, the thickness of the selective layer is from about 0.1 to about 5 microns. In yet further embodiments, the thickness of the selective layer is from about 0.5 to about 1.5 microns.

In certain embodiments, the thickness of the selective layer is about 0.1 microns. In further embodiments, the thickness of the selective layer is about 0.2 microns. In yet further embodiments, the thickness of the selective layer is about 0.3 microns. In still further embodiments, the thickness of the selective layer is about 0.4 microns. In certain embodiments, the thickness of the selective layer is about 0.5 microns. In further embodiments, the thickness of the selective layer is about 0.6 microns. In yet further embodiments, the thickness of the selective layer is about 0.7 microns. In still further embodiments, the thickness of the selective layer is about 0.8 microns. In certain embodiments, the thickness of the selective layer is about 0.9 microns.

In certain embodiments, the thickness of the selective layer is about 1 micron. In further embodiments, the thickness of the selective layer is about 2 microns. In yet further embodiments, the thickness of the selective layer is about 3 microns. In still further embodiments, the thickness of the selective layer is about 4 microns. In certain embodiments, the thickness of the selective layer is about 5 microns. In further embodiments, the thickness of the selective layer is about 6 microns. In yet further embodiments, the thickness of the selective layer is about 7 microns. In still further embodiments, the thickness of the selective layer is about 8 microns. In certain embodiments, the thickness of the selective layer is about 9 microns.

In certain embodiments, the thickness of the selective layer is less than about 10 microns. In further embodiments, the thickness of the selective layer is less than about 9 microns. In yet further embodiments, the thickness of the selective layer is less than about 8 microns. In still further embodiments, the thickness of the selective layer is less than about 7 microns. In certain embodiments, the thickness of the selective layer is less than about 6 microns. In further embodiments, the thickness of the selective layer is less than about 5 microns. In yet further embodiments, the thickness of the selective layer is less than about 4 microns. In still further embodiments, the thickness of the selective layer is less than about 3 microns. In certain embodiments, the thickness of the selective layer is less than about 2 microns. In further embodiments, the thickness of the selective layer is less than about 1 micron.

In certain embodiments, the thickness of the selective layer is less than about 0.9 microns. In further embodiments, the thickness of the selective layer is less than about 0.8 microns. In yet further embodiments, the thickness of the selective layer is less than about 0.7 microns. In still further embodiments, the thickness of the selective layer is less than about 0.6 microns. In certain embodiments, the thickness of the selective layer is less than about 0.5 microns. In further embodiments, the thickness of the selective layer is less than about 0.4 microns. In yet further embodiments, the thickness of the selective layer is less than about 0.3 microns. In still further embodiments, the thickness of the selective layer is less than about 0.2 microns.

In certain embodiments, the thickness of the selective layer is selected from about 0.50 microns, 0.75 microns, about 1.0 micron, 1.25 microns, about 1.5 microns, about 1.75 microns, about 2 microns, about 2.25 microns, about 2.5 microns, about 2.75 microns, and about 3 microns; preferably wherein the thickness of the selective layer is about 1 micron.

Membrane pore size may be determined using any suitable method known in the art, for example, scanning electron microscopy. In certain embodiments, the plurality of pores extending through the support layer have a pore size from about 2 nm to about 50 nm. In further embodiments, the plurality of pores extending through the support layer have an average pore size of about 2 nm. In yet further embodiments, the plurality of pores extending through the support layer have an average pore size of about 5 nm. In still further embodiments, the plurality of pores extending through the support layer have an average pore size of about 10 nm. In certain embodiments, the plurality of pores extending through the support layer have an average pore size of about 20 nm. In further embodiments, the plurality of pores extending through the support layer have an average pore size of about 30 nm. In yet further embodiments, the plurality of pores extending through the support layer have an average pore size of about 40 nm. In still further embodiments, the plurality of pores extending through the support layer have an average pore size of about 50 nm.

In certain embodiments, the thickness of the support layer is from about 15 microns to about 150 microns. In further embodiments, the thickness of the support layer is about 15 microns. In yet further embodiments, the thickness of the support layer is about 30 microns. In still further embodiments, the thickness of the support layer is about 45 microns. In certain embodiments, the thickness of the support layer is about 60 microns. In further embodiments, the thickness of the support layer is about 75 microns. In yet further embodiments, the thickness of the support layer is about 90 microns. In still further embodiments, the thickness of the support layer is about 105 microns. In certain embodiments, the thickness of the support layer is about 120 microns. In further embodiments, the thickness of the support layer is about 135 microns. In yet further embodiments, the thickness of the support layer is about 150 microns.

In certain embodiments, the thickness of the support layer is selected from about 15 microns, about 30 microns, about 45 microns, about 60 microns, about 75 microns, about 90 microns, about 105 microns, about 120 microns, about 135 microns, and about 150 microns; preferably wherein the thickness of the support layer is between about 50 and about 60 microns.

The support layer can be fabricated from one or more suitable polymers known in the art. In certain embodiments, the support layer comprises a polymer selected from polyethylenimine, polyether ether ketone, polyvinylidene difluoride, polyvinylfluoride, polytetrafluoroethylene, poly(acrylonitrile), polysulfone, cellulose acetate, poly ether sulfone, and polyimide. In further embodiments, the support layer comprises a plurality of cross-linked polymers.

The selective layer may comprise one or more suitable ladder polymers known in the art. In certain embodiments, the plurality of ladder polymer chains comprises norbornyl arylcyclobutene ladder polymers. Suitable ladder polymers are disclosed in, e.g., International Application No. PCT/US2023/034879, filed Oct. 11, 2023, which is expressly incorporated herein by reference in its entirety.

In certain embodiments, the plurality of ladder polymer chains is a plurality of polymer chains comprising at least one unit of Formula I, wherein Formula I consists of a subunit of Formula I′ and a subunit of Formula I″:

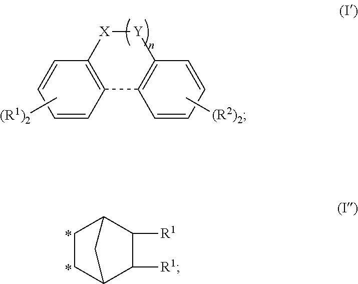

wherein:
each R¹ represents a connection point to the polymer;
each of the two^{R} groups on the subunit of Formula I′ is on an adjacent carbon to another R¹ group;
each R² represents a connection point between the subunit of Formula I′ and a carbon marked with an * on the subunit of Formula I″;
each of the two R² groups is on an adjacent carbon to another R² group;
X is, independently at each occurrence, selected from NR^{A}, O, S, CR^{B}R^{C}, S═O, and C═O;
when present, Y is, independently at each occurrence, selected from NR^{A}, O, S, CR^{B}R^{C}, and C═O;
wherein, when Y is present, at least one of X and Y is CR^{B}R^{C} or C═O;
R^{A} is, independently at each occurrence, selected from H, alkyl, —O-alkyl, and haloalkyl;
R^{B} and R^{C} are, independently at each occurrence, selected from H, OH, SH, halo, amine, alkyl, —(H)C═O, —O-alkyl, and haloalkyl;
or R^{B} and R^{C}, together with the atom to which they are attached, form a cycloalkyl, cycloalkenyl, heterocycloalkenyl, or heterocycloalkyl, which is optionally substituted with one or more R^{G}, wherein R^{G} is selected from H, alkyl, alkoxy, and hydroxy;
n is 0 or 1; and
[symbol] represents an optional bond.

In further embodiments, the plurality of polymer chains comprises polymers comprising a plurality of repeat units of Formula I. In further embodiments, the plurality of polymer chains comprises at least one unit of Formula Ia:

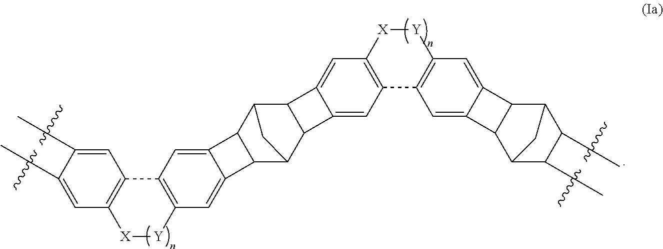

In yet further embodiments, the plurality of polymer chains further comprises polymers further comprising another co-monomer.

Additional suitable ladder polymers are disclosed in U.S. Pat. No. 9,708,443, which is expressly incorporated herein by reference in its entirety. In certain embodiments, the plurality of ladder polymer chains is a plurality of polymer chains comprising at least one unit of Formula II:

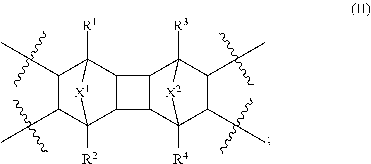

wherein R¹, R², R³, and R⁴ are, independently at each occurrence, selected from H, alkyl, aryl, heterocycloalkyl, halo, a group comprising O, a group comprising O(CO), a group comprising O(CO)O, a group comprising O(CO)N, a group comprising S, a group comprising B, a group comprising NO₂, a group comprising N, a group comprising P, a group comprising (PO), a group comprising CHO, a group comprising (CO), a group comprising (CO)O, a group comprising (CO)N, and a group comprising Si; and
wherein X¹ and X² are independently selected from —O—, —S—, —B(O)R^{a}—, —NR^{a}—, —P(O)R^{a}—, —(PO)(O)R^{a}—, —CO—, —C(O)R^{a}(O)R^{b}—, and —Si(O)R^{a}(O)R^{b}—, and R^{a} and R^{b} are independently selected from H, alkyl, aryl, and heterocyclyl.

Further suitable ladder polymers are disclosed in US Patent Publication No. 2022/0023804, which is expressly incorporated herein by reference in its entirety. In certain embodiments, the plurality of ladder polymer chains is a plurality of polymer chains comprising at least one unit of Formula III:

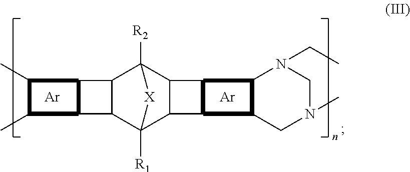

wherein:
Ar is, independently at each occurrence, selected from optionally substituted aryl;
X is selected from —O—, —S—, —B(O)R^{a}—, —NR^{a}—, —P(O)R^{a}—, —(PO)(O)R^{a}—, —CO—, —CR^{a}R^{b}—, —C(O)R^{a}(O)R^{b}—, and —Si(O)R^{a}(O)R^{b}—;
R^{a} and R^{b} are, independently at each occurrence, selected from H, alkyl, aryl, and heterocyclyl;
R₁ and R₂ are, independently at each occurrence, selected from H, linear or branched optionally substituted alkyl, optionally substituted alkoxy, optionally substituted aryl, heterocyclyl, halo, CHO, a group comprising 0, a group comprising O(CO), a group comprising O(CO)O, a group comprising O(CO)N, a group comprising S, a group comprising B, a group comprising NO₂, a group comprising N, a group comprising P, a group comprising (PO), a group comprising (CO), a group comprising (CO)O, a group comprising (CO)N, and a group comprising Si; and
n is an integer greater than 1.

Yet further suitable ladder polymers can be found in International Patent Publication No. WO 2021/101659, which is expressly incorporated herein by reference in its entirety. In certain embodiments, the plurality of ladder polymer chains is a plurality of polymer chains comprising at least one unit of Formula IV, wherein Formula IV consists of a subunit of Formula IV′ and a subunit of Formula IV″:

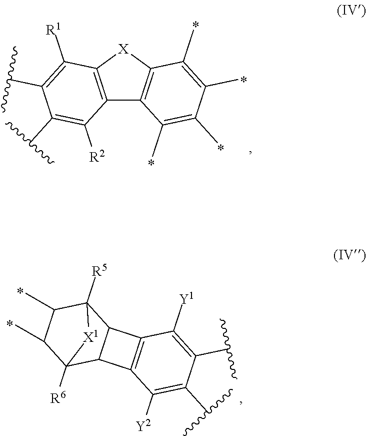

wherein:
two adjacent * of IV′ are bonds to two * of IV″, and the two remaining * of IV′ are R³ and R⁴;
X is selected from alkylene, —O—, —S—, a group comprising nitrogen, cycloalkyl, and heterocyclyl;
Y¹ and Y² are, independently at each occurrence, selected from alkyl;
R¹, R², R³, R⁴, R, and^{R} are independently selected from a group comprising O, a group comprising O(CO), a group comprising O(CO)O, a group comprising O(CO)N, a group comprising S, a group comprising B, a group comprising NO₂, a group comprising N, a group comprising P, a group comprising (PO), a group comprising CHO, a group comprising (CO), a group comprising (CO)O, a group comprising (CO)N, and a group comprising Si; and
X¹ is selected from —O—, —S—, —B(O)R^{a}—, —NR^{a}, —P(O)R^{a}—, —(PO)(O)R^{a}, —CO—, —CR^{a}R^{b}—, —C(O)R^{a}(O)R^{b}—, and —Si(O)R^{a}(O)R^{b}—; and
R^{a} and R^{b} are independently selected from H, alkyl, aryl, and heterocyclyl.

In certain embodiments, R¹, R², R³, R⁴, R⁵, and R⁶ are, independently at each occurrence, selected from H, optionally substituted alkyl, optionally substituted aryl, optionally substituted heterocyclyl, halo, —OR^{a}, —O(CO)R^{a}, —O(CO)OR^{a}, —O(CO)NR^{a}R^{b}, —SR^{a}, —B(O)R^{a}(O)R^{b}, —NO₂, —NR^{a}R^{b}, —P(O)R^{a}(O)R^{b}, —PO(O)R^{a}(O)R^{b}, —CHO, —(CO)R^{a}, —(CO)OR^{a}, —(CO)NR^{a}R^{b}, and —Si(O)R^{a}(O)R^{b}(O)R^{c}; wherein R^{a}, R^{b}, and R^{C} are, independently at each occurrence, selected from H, optionally substituted alkyl groups, optionally substituted aryl groups, and optionally substituted heterocyclyl.

Still further suitable ladder polymers can be found in Lai, H. “Synthesis of norbornyl benzocyclobutene ladder polymers and the transport of gases therein”, Dissertation, Stanford University, August 2020 (Public Access embargoed until August 2022), which is expressly incorporated herein by reference in its entirety.

In certain embodiments, the composite membranes comprise a plurality of ladder polymer chains, which comprise at least one unit of Formula Ib:

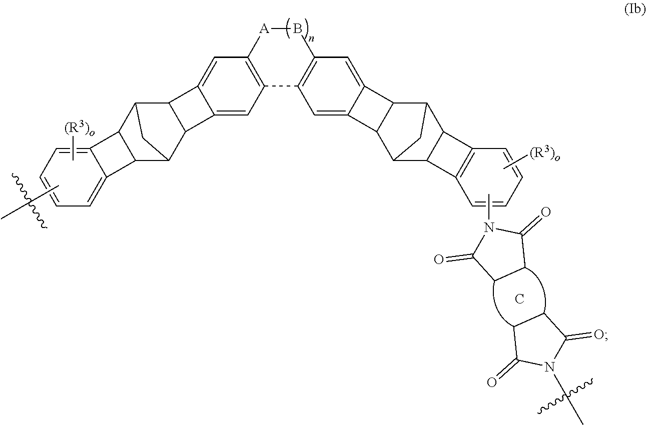

wherein:
each R³ is, independently at each occurrence, selected from C₁-C₄ alkyl, C₁-C₄ fluoroalkyl, halo, optionally substituted amino, and hydroxy;
each R⁴ and R⁵ is, independently at each occurrence, selected from H, C₁-C₄ alkyl, C₁-C₄ fluoroalkyl, halo, optionally substituted amino, and hydroxy;
A is, independently at each occurrence, selected from NR^{D}, O, S, CR^{E}R^{F}, S═O, and C═O; when present, B is, independently at each occurrence, selected from NR^{D}, O, S, CR^{E}R^{F}, and C═O;
wherein, when B is present, at least one of A and B is CR^{E}R^{F} or C═O;
R^{D} is, independently at each occurrence, selected from H, alkyl, —O-alkyl, or haloalkyl;
R^{E} and R^{F} are, independently at each occurrence, selected from H, OH, SH, halo, amine, alkyl, —(H)C═O, —O-alkyl, and haloalkyl;
or R^{E} and R^{F}, together with the atom to which they are attached, form a cycloalkyl, cycloalkenyl, heterocycloalkenyl, or heterocycloalkyl, which is optionally substituted with one or more R^{H}, wherein R^{H} is selected from H, alkyl, alkoxy, and hydroxy;
n is 0 or 1;
each o is, independently at each occurrence, 0, 1, 2, or 3;
[symbol] represents an optional bond;
C is, independently at each occurrence, selected from:

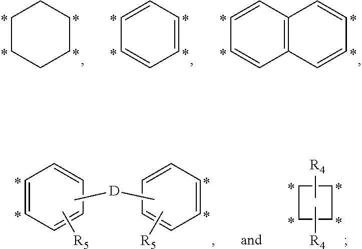

wherein each * represents a point of attachment to the unit of Formula Ib; and
D is, independently at each occurrence, a bond or selected from O, C═O, SO₂, CR₄R₄, phenylene, and

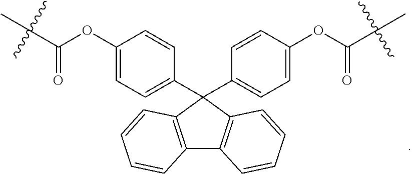 [SMILES: *C(=O)Oc1ccc(C2(c3ccc(OC(*)=O)cc3)c3ccccc3-c3ccccc32)cc1]

In further embodiments, the composite membranes comprise a plurality of ladder polymer chains, which comprise at least one unit of Formula Ib:

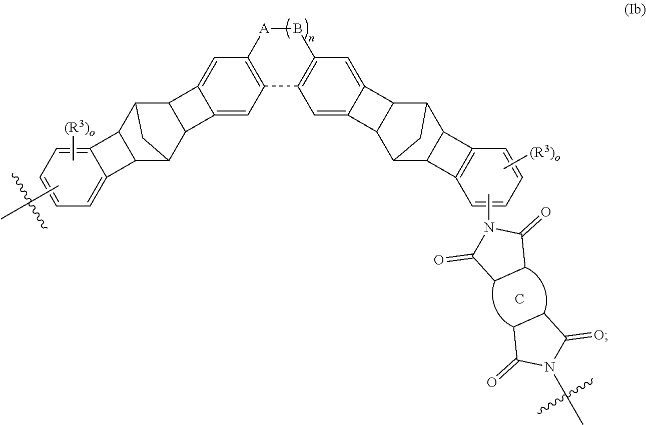

wherein:
each R³ is, independently at each occurrence, selected from C₁-C₄ alkyl, C₁-C₄ fluoroalkyl, halo, optionally substituted amino, and hydroxy;
each R⁴ and R⁵ is, independently at each occurrence, selected from H, C₁-C₄ alkyl, C₁-C₄ fluoroalkyl, halo, optionally substituted amino, and hydroxy;
A is, independently at each occurrence, selected from NR^{D}, O, S, CR^{E}R^{F}, S═O, and C═O;
when present, B is, independently at each occurrence, selected from NR^{D}, O, S, CR^{E}R^{F}, and C═O;
wherein, when B is present, at least one of A and B is CR^{E}R^{F} or C═O;
R^{D} is, independently at each occurrence, selected from H, alkyl, —O-alkyl, or haloalkyl;
R^{E} and R^{F} are, independently at each occurrence, selected from H, OH, SH, halo, amine, alkyl, —(H)C═O, —O-alkyl, and haloalkyl;
or R^{E} and R^{F}, together with the atom to which they are attached, form a cycloalkyl, cycloalkenyl, heterocycloalkenyl, or heterocycloalkyl, which is optionally substituted with one or more R^{H}, wherein R^{H} is selected from H, alkyl, alkoxy, and hydroxy;
optionally wherein R^{E} and R^{F}, together with the atoms to which they are attached, form a group selected from

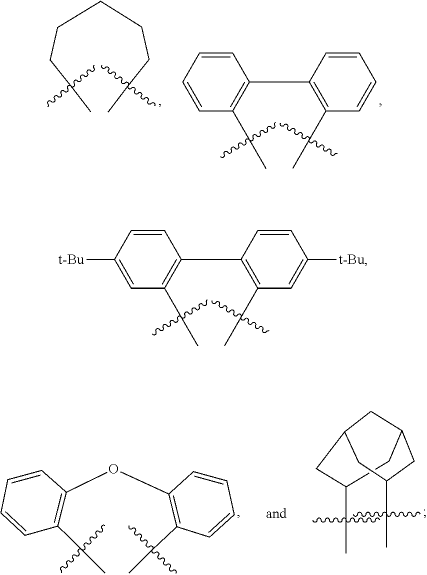

n is 0 or 1;
each o is, independently at each occurrence, 0, 1, 2, or 3;
[symbol] represents an optional bond;
C is, independently at each occurrence, selected from:

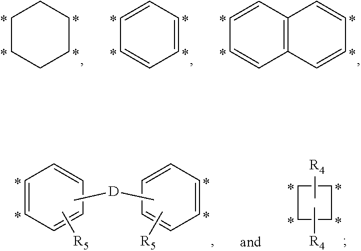

wherein each * represents a point of attachment to the unit of Formula Ib; and
D is, independently at each occurrence a bond or selected from O, C═O, SO₂, CR₄R₄, phenylene, and

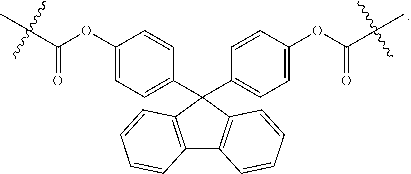 [SMILES: *C(=O)Oc1ccc(C2(c3ccc(OC(*)=O)cc3)c3ccccc3-c3ccccc32)cc1]

In certain embodiments, the R^{E} and R^{F}, together with the atoms to which they are attached, form

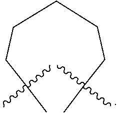 [SMILES: *CCCCC*]

In further embodiments, the R^{E} and R^{F}, together with the atoms to which they are attached, form

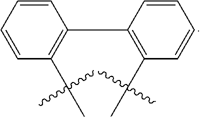 [SMILES: *c1ccccc1-c1ccccc1*]

In yet further embodiments, the R^{E} and R^{F}, together with the atoms to which they are attached, form

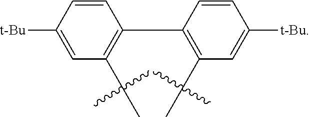 [SMILES: *c1cc(C(C)(C)C)ccc1-c1ccc(C(C)(C)C)cc1*]

In still further embodiments, the R^{E} and R^{F}, together with the atoms to which they are attached, form

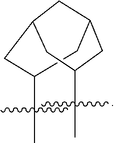 [SMILES: *C1CC2CC(*)CC(C1)C2]

In certain embodiments, the R^{E} and R^{F}, together with the atoms to which they are attached, form.

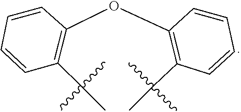 [SMILES: *c1ccccc1Oc1ccccc1*]

In certain embodiments, the at least one unit of Formula Ib is a unit of Formula Ic:

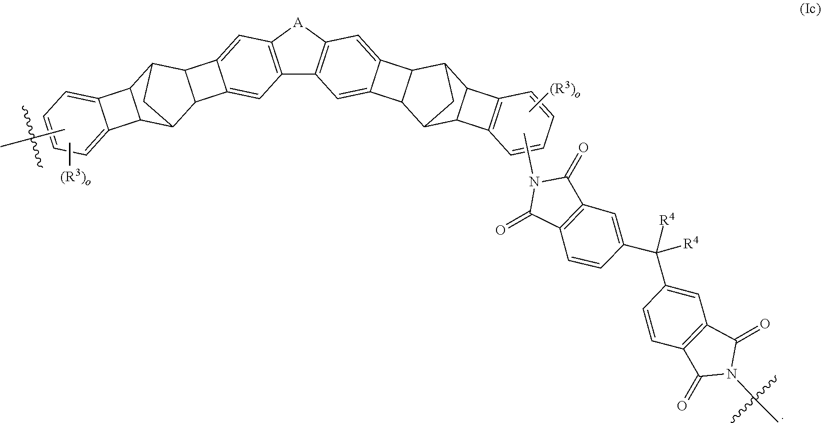

In further embodiments, the at least one unit of Formula Ic is:

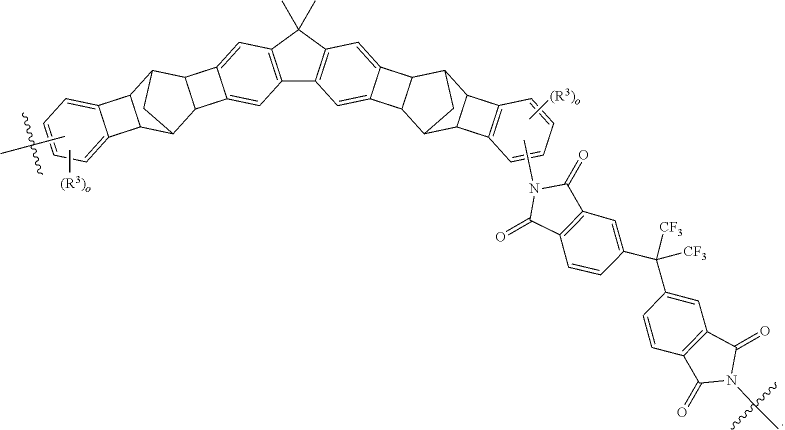

In yet fu reembodiments, the at least one unit of formula Ic is:

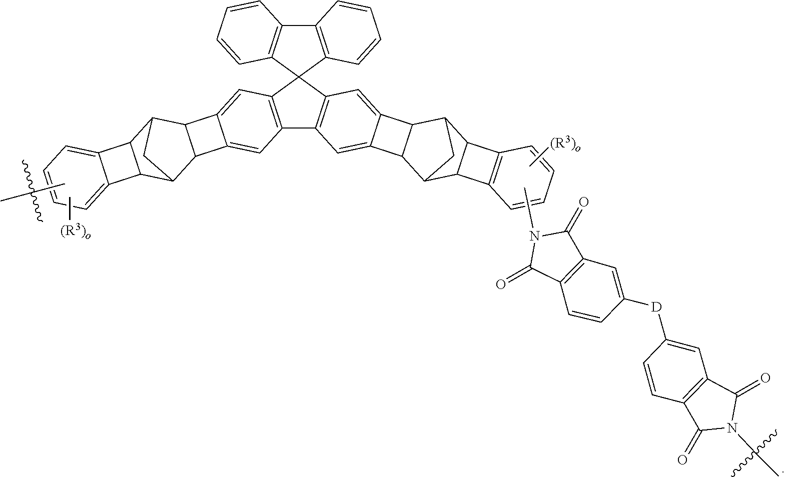

In still further embodiments, the at least one unit of formula Ic is:

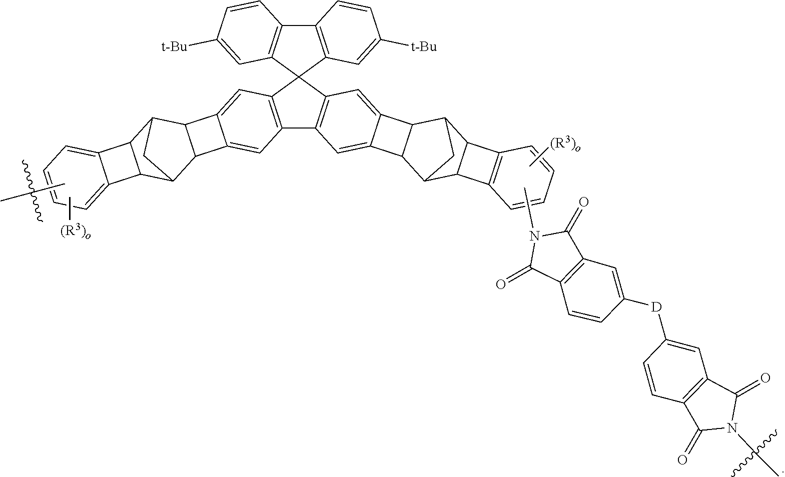

In certain embodiments, the at least one unit of formula Ic is:

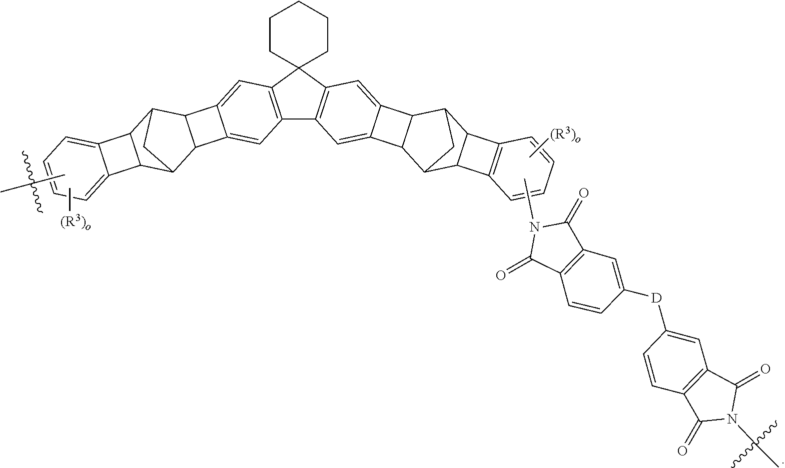

In further embodiments, the at least one unit of formula Ic is:

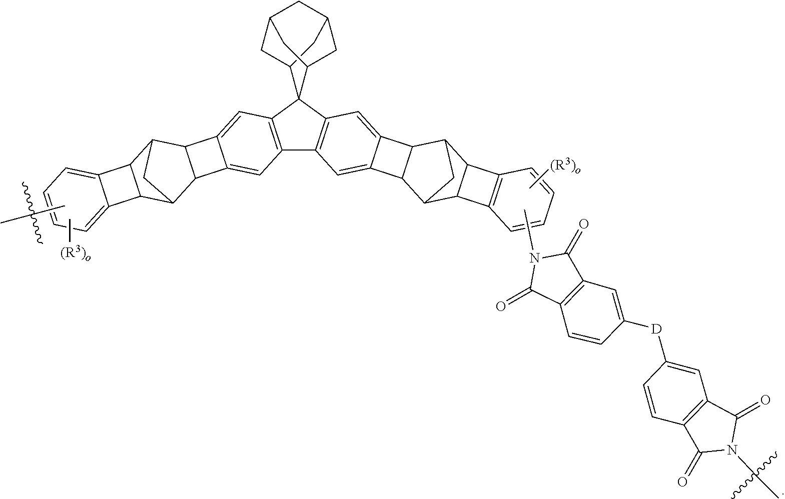

In yet further embodiments, the at least one unit of formula Ic is:

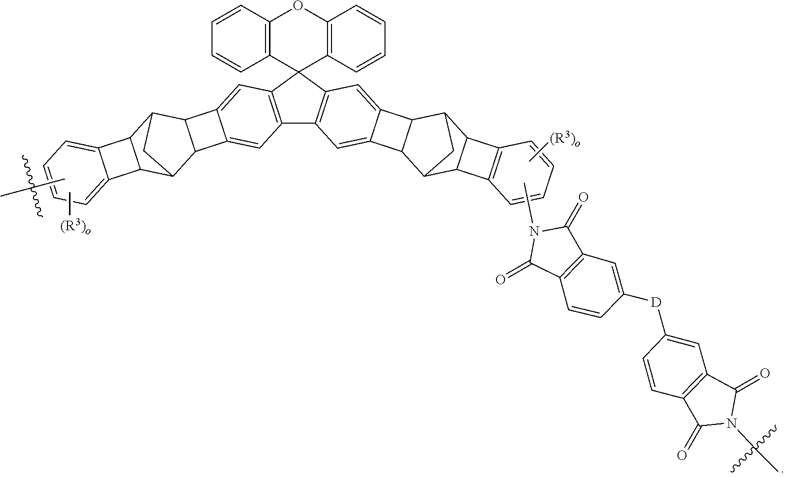

In certain embodiments, the gutter layer is present. In further embodiments, the gutter layer comprises polysiloxane. In yet further embodiments, the thickness of the gutter layer is from 0.01 microns to about 10 microns. In still further embodiments, the thickness of the gutter layer is about 0.01 microns. In certain embodiments, the thickness of the gutter layer is about 0.1 microns. In further embodiments, the thickness of the gutter layer is about 1 micron. In yet further embodiments, the thickness of the gutter layer is about 2 microns. In still further embodiments, the thickness of the gutter layer is about 3 microns. In certain embodiments, the thickness of the gutter layer is about 4 microns. In further embodiments, the thickness of the gutter layer is about 5 microns. In yet further embodiments, the thickness of the gutter layer is about 6 microns. In still further embodiments, the thickness of the gutter layer is about 7 microns. In certain embodiments, the thickness of the gutter layer is about 8 microns. In further embodiments, the thickness of the gutter layer is about 9 microns. In yet further embodiments, the thickness of the gutter layer is about 10 microns. In still further embodiments, the gutter layer is absent.

In certain embodiments, the composite membranes disclosed herein further comprise:
a sealing layer comprising a permeable elastic polymer, said sealing layer having a first side, a second side, and a thickness;
wherein the second side of the selective layer is disposed along the first side of the sealing layer.

In certain embodiments, the thickness of the sealing layer is from 0.01 microns to about 10 microns. In further embodiments, the thickness of the sealing layer is about 0.01 microns. In yet further embodiments, the thickness of the sealing layer is about 0.1 microns. In still further embodiments, the thickness of the sealing layer is about 1 micron. In certain embodiments, the thickness of the sealing layer is about 2 microns. In further embodiments, the thickness of the sealing layer is about 3 microns. In yet further embodiments, the thickness of the sealing layer is about 4 microns. In still further embodiments, the thickness of the sealing layer is about 5 microns. In certain embodiments, the thickness of the sealing layer is about 6 microns. In further embodiments, the thickness of the sealing layer is about 7 microns. In yet further embodiments, the thickness of the sealing layer is about 8 microns. In still further embodiments, the thickness of the sealing layer is about 9 microns. In certain embodiments, the thickness of the sealing layer is about 10 microns. In further embodiments, the sealing layer comprises polysiloxane.

In certain embodiments, the composite membranes disclosed herein further comprise:
a non-woven layer comprising a polymeric material, said non-woven layer having a first side, a second side, and a thickness;
wherein the second side of the non-woven layer is disposed along the first side of the support layer; and
the polymeric material is a polyolefin or polyester.

In certain embodiments, the non-woven layer comprises at least one polyester; preferably wherein the polyester is PET. In further embodiments, the non-woven layer comprises at least one polyolefin. In yet further embodiments, the at least one polyolefin is selected from polyethylene, and polypropylene, or combinations thereof. In still further embodiments, the at least one polyolefin is a combination of polypropylene and polyethylene.

In certain embodiments, the thickness of the non-woven layer is from about 50 microns to about 300 microns. In further embodiments, the thickness of the non-woven layer is about 50 microns. In yet further embodiments, the thickness of the non-woven layer is about 100 microns. In still further embodiments, the thickness of the non-woven layer is about 150 microns. In certain embodiments, the thickness of the non-woven layer is about 200 microns. In further embodiments, the thickness of the non-woven layer is about 250 microns. In yet further embodiments, the thickness of the non-woven layer is about 300 microns.

The composite membranes of the present disclosure exhibit gas permeance values for particular gases which may be expressed in the unit GPU, which is defined as: 1 GPU=10⁻⁶ cm³(STP)/(cm² s cm Hg). In certain embodiments, the composite membrane has a gas permeance for He (P_{He}) from about 1 to about 2000 GPU. In some embodiments, the membrane has a gas permeance for He (P_{He}) from about 0.1 GPU to about 5 GPU. In certain embodiments, the membrane has a gas permeance for He (P_{He}) from about 6 GPU to about 10 GPU. In some embodiments, the membrane has a gas permeance for He (P_{He}) from about 11 GPU to about 75 GPU. In certain embodiments, the membrane has a gas permeance for He (P_{He}) from about 76 GPU to about 200 GPU. In some embodiments, the membrane has a gas permeance for He (P_{He}) from about 201 GPU to about 600 GPU. In certain embodiments, the membrane has a gas permeance for He (P_{He}) greater than about 200 GPU. In further embodiments, the composite membrane has a gas permeance for He (P_{He}) of about 1 GPU. In yet further embodiments, the composite membrane has a gas permeance for He (PH) of about 250 GPU. In still further embodiments, the composite membrane has a gas permeance for He (P_{He}) of about 500 GPU. In certain embodiments, the composite membrane has a gas permeance for He (P_{He}) of about 750 GPU. In further embodiments, the composite membrane has a gas permeance for He (P_{He}) of about 1000 GPU. In yet further embodiments, the composite membrane has a gas permeance for He (PH) of about 1250 GPU. In still further embodiments, the composite membrane has a gas permeance for He (P_{He}) of about 1500 GPU. In certain embodiments, the composite membrane has a gas permeance for He (P_{He}) of about 1750 GPU. In further embodiments, the composite membrane has a gas permeance for He (P_{He}) of about 2000 GPU.

In certain embodiments, the composite membrane has a gas permeance for CH₄ (P_{CH4}) from about 0.1 to about 100 GPU. In some embodiments, the membrane has a gas permeance for CH₄ (P_{CH4}) from about 0.1 GPU to about 5 GPU. In certain embodiments, the membrane has a gas permeance for CH₄ (P_{CH4}) from about 6 GPU to about 10 GPU. In some embodiments, the membrane has a gas permeance for CH₄ (P_{CH4}) from about 11 GPU to about 75 GPU. In certain embodiments, the membrane has a gas permeance for CH₄ (P_{CH4}) from about 76 GPU to about 200 GPU. In some embodiments, the membrane has a gas permeance for CH₄ (P_{CH4}) from about 201 GPU to about 600 GPU. In certain embodiments, the membrane has a gas permeance for CH₄ (P_{CH4}) greater than about 200 GPU. In further embodiments, the composite membrane has a gas permeance for CH₄ (P_{CH4}) of about 0.1 GPU. In yet further embodiments, the composite membrane has a gas permeance for CH₄ (P_{CH4}) of about 1 GPU. In still further embodiments, the composite membrane has a gas permeance for CH₄ (P_{CH4}) of about 10 GPU. In some embodiments, the composite membrane has a gas permeance for CH₄ (P_{CH4}) of about 5 GPU. In certain embodiments, the composite membrane has a gas permeance for CH₄ (P_{CH4}) of about 20 GPU. In further embodiments, the composite membrane has a gas permeance for CH₄ (P_{CH4}) of about 30 GPU. In yet further embodiments, the composite membrane has a gas permeance for CH₄ (P_{CH4}) of about 40 GPU. In still further embodiments, the composite membrane has a gas permeance for CH₄ (P_{CH4}) of about 50 GPU. In certain embodiments, the composite membrane has a gas permeance for CH₄ (P_{CH4}) of about 60 GPU. In further embodiments, the composite membrane has a gas permeance for CH₄ (P_{CH4}) of about 70 GPU. In yet further embodiments, the composite membrane has a gas permeance for CH₄ (P_{CH4}) of about 80 GPU. In still further embodiments, the composite membrane has a gas permeance for CH₄ (P_{CH4}) of about 90 GPU. In certain embodiments, the composite membrane has a gas permeance for CH₄ (P_{CH4}) of about 100 GPU.

In certain embodiments, the composite membrane has a gas permeance for H₂ (P_{H2}) from about 1 to about 2000 GPU. In some embodiments, the membrane has a gas permeance for H₂ (P_{H2}) from about 0.1 GPU to about 5 GPU. In certain embodiments, the membrane has a gas permeance for H₂ (P_{H2}) from about 6 GPU to about 10 GPU. In some embodiments, the membrane has a gas permeance for H₂ (P_{H2}) from about 11 GPU to about 75 GPU. In certain embodiments, the membrane has a gas permeance for H₂ (P_{H2}) from about 76 GPU to about 200 GPU. In some embodiments, the membrane has a gas permeance for H₂ (P_{H2}) from about 201 GPU to about 600 GPU. In certain embodiments, the membrane has a gas permeance for H₂ (P_{H2}) greater than about 200 GPU. In further embodiments, the composite membrane has a gas permeance for H₂ (P_{H2}) of about 1 GPU. In yet further embodiments, the composite membrane has a gas permeance for H₂ (P_{H2}) of about 250 GPU. In still further embodiments, the composite membrane has a gas permeance for H₂ (P_{H2}) of about 500 GPU. In certain embodiments, the composite membrane has a gas permeance for H₂ (P_{H2}) of about 750 GPU. In further embodiments, the composite membrane has a gas permeance for H₂ (P_{H2}) of about 1000 GPU. In yet further embodiments, the composite membrane has a gas permeance for H₂ (P_{H2}) of about 1250 GPU. In still further embodiments, the composite membrane has a gas permeance for H₂ (P_{H2}) of about 1500 GPU. In certain embodiments, the composite membrane has a gas permeance for H₂ (P_{H2}) of about 1750 GPU. In further embodiments, the composite membrane has a gas permeance for H₂ (P_{H2}) of about 2000 GPU.

In certain embodiments, the composite membrane has a gas permeance for N₂ (P_{N2}) from about 0.1 to about 100 GPU. In some embodiments, the membrane has a gas permeance for N₂ (P_{N2}) from about 0.1 GPU to about 5 GPU. In certain embodiments, the membrane has a gas permeance for N₂ (P_{N2}) from about 6 GPU to about 10 GPU. In some embodiments, the membrane has a gas permeance for N₂ (P_{N2}) from about 11 GPU to about 75 GPU. In certain embodiments, the membrane has a gas permeance for N₂ (P_{N2}) from about 76 GPU to about 200 GPU. In some embodiments, the membrane has a gas permeance for N₂ (P_{N2}) from about 201 GPU to about 600 GPU. In certain embodiments, the membrane has a gas permeance for N₂ (P_{N2}) greater than about 200 GPU. In further embodiments, the composite membrane has a gas permeance for N₂ (P_{N2}) of about 0.1 GPU. In yet further embodiments, the composite membrane has a gas permeance for N₂ (P_{N2}) of about 1 GPU. In still further embodiments, the composite membrane has a gas permeance for N₂ (P_{N2}) of about 10 GPU. In certain embodiments, the composite membrane has a gas permeance for N₂ (P_{N2}) of about 20 GPU. In further embodiments, the composite membrane has a gas permeance for N₂ (P_{N2}) of about 30 GPU. In yet further embodiments, the composite membrane has a gas permeance for N₂ (P_{N2}) of about 40 GPU. In still further embodiments, the composite membrane has a gas permeance for N₂ (P_{N2}) of about 50 GPU. In certain embodiments, the composite membrane has a gas permeance for N₂ (P_{N2}) of about 60 GPU. In further embodiments, the composite membrane has a gas permeance for N₂ (PN₂) of about 70 GPU. In yet further embodiments, the composite membrane has a gas permeance for N₂ (P_{N2}) of about 80 GPU. In still further embodiments, the composite membrane has a gas permeance for N₂ (P_{N2}) of about 90 GPU. In certain embodiments, the composite membrane has a gas permeance for N₂ (P_{N2}) of about 100 GPU.

In certain embodiments, the composite membrane has a gas permeance for O₂ (P_{O2}) from about 2 to about 500 GPU. In some embodiments, the membrane has a gas permeance for O₂ (P_{O2}) from about 0.1 GPU to about 5 GPU. In certain embodiments, the membrane has a gas permeance for O₂ (P_{O2}) from about 6 GPU to about 10 GPU. In some embodiments, the membrane has a gas permeance for O₂ (P_{O2}) from about 11 GPU to about 75 GPU. In certain embodiments, the membrane has a gas permeance for O₂ (P_{O2}) from about 76 GPU to about 200 GPU. In some embodiments, the membrane has a gas permeance for O₂ (P_{O2}) from about 201 GPU to about 600 GPU. In certain embodiments, the membrane has a gas permeance for O₂ (P_{O2}) greater than about 200 GPU. In further embodiments, the composite membrane has a gas permeance for O₂ (P_{O2}) of about 2 GPU. In yet further embodiments, the composite membrane has a gas permeance for O₂ (P_{O2}) of about 50 GPU. In still further embodiments, the composite membrane has a gas permeance for O₂ (P_{O2}) of about 100 GPU. In certain embodiments, the composite membrane has a gas permeance for O₂ (PO₂) of about 250 GPU. In further embodiments, the composite membrane has a gas permeance for O₂ (P_{O2}) of about 300 GPU. In yet further embodiments, the composite membrane has a gas permeance for O₂ (P_{O2}) of about 350 GPU. In still further embodiments, the composite membrane has a gas permeance for O₂ (P_{O2}) of about 400 GPU. In certain embodiments, the composite membrane has a gas permeance for O₂ (P_{O2}) of about 450 GPU. In further embodiments, the composite membrane has a gas permeance for O₂ (PO2) of about 500 GPU.

In certain embodiments, the composite membrane has a gas permeance for C₂F₂H₂ (1,1-difluoroethene, refrigerant R1132a, Pc₂F₂H₂) from about 0.01 to about 1 GPU. In some embodiments, the membrane has a gas permeance for C₂F₂H₂ (P_{C2F2H2}) from about 0.1 GPU to about 5 GPU. In certain embodiments, the membrane has a gas permeance for C₂F₂H₂ (P_{C2F2H2}) from about 6 GPU to about 10 GPU. In some embodiments, the membrane has a gas permeance for C₂F₂H₂ (P_{C2F2H2}) from about 11 GPU to about 75 GPU. In certain embodiments, the membrane has a gas permeance for C₂F₂H₂ (P_{C2F2H2}) from about 76 GPU to about 200 GPU. In some embodiments, the membrane has a gas permeance for C₂F₂H₂ (P_{C2F2H2}) from about 201 GPU to about 600 GPU. In certain embodiments, the membrane has a gas permeance for C₂F₂H₂ (P_{C2F2H2}) greater than about 200 GPU.

In certain embodiments, the composite membrane has a gas permeance for C₂H₂F₄ (R134a, halocarbon 134a, 1,1,1,2-tetrafluoroethane, P_{C2H2F4}) from about 0.001 GPU to about 0.1 GPU. In some embodiments, the membrane has a gas permeance for C₂H₂F₄ (P_{C2H2F4}) from about 0.1 GPU to about 5 GPU. In certain embodiments, the membrane has a gas permeance for C₂H₂F₄ (P_{C2H2F4}) from about 6 GPU to about 10 GPU. In some embodiments, the membrane has a gas permeance for C₂H₂F₄ (P_{C2H2F4}) from about 11 GPU to about 75 GPU. In certain embodiments, the membrane has a gas permeance for C₂H₂F₄ (P_{C2H2F4}) from about 76 GPU to about 200 GPU. In some embodiments, the membrane has a gas permeance for C₂H₂F₄ (P_{C2H2F4}) from about 201 GPU to about 600 GPU. In certain embodiments, the membrane has a gas permeance for C₂H₂F₄ (P_{C2H2F4}) greater than about 200 GPU. In further embodiments, the composite membrane has a gas permeance for C₂H₂F₄ (P_{C2H2F4}) of about 0.001 GPU, about 0.01 GPU, or about 0.1 GPU.

In certain embodiments, the composite membrane is selective for separating CH₄ from He. In some embodiments, the selectivity of the composite membrane (P_{He}/P_{CH4}) is from about 100 to about 600. In some embodiments, the selectivity of the composite membrane (P_{He}/P_{CH4}) is from about 0 to about 50. In certain embodiments, the selectivity of the composite membrane (PHeCPcH4) is from about 51 to about 150. In some embodiments, the selectivity of the composite membrane (P_{He}/P_{CH4}) is from about 151 to about 300. In certain embodiments, the selectivity of the composite membrane (PHCPcH4) is from about 301 to about 450. In some embodiments, the selectivity of the composite membrane (PH/P_{CH4}) is from about 451 to about 3500. In certain embodiments, the selectivity of the composite membrane (PHCPcH4) is greater than about 450. In some embodiments, the selectivity of the composite membrane (PHCPcH4) is from about 0 to about 10. In certain embodiments, the selectivity of the composite membrane (P_{He}/P_{CH4}) is from about 11 to about 50. In some embodiments, the selectivity of the composite membrane (PHCPcH4) is from about 51 to about 150. In certain embodiments, the selectivity of the composite membrane (PHCPcH4) is greater than about 150. In some embodiments, the selectivity of the composite membrane (PHCPcH4) is from about 150 to about 3500. In certain embodiments, the selectivity of the composite membrane (PHCPcH4) is from about 100 to about 500. In further embodiments, the selectivity of the composite membrane (P_{He}/P_{CH4}) is from about 100 to about 400. In yet further embodiments, the selectivity of the composite membrane (P_{He}/P_{CH4}) is from about 200 to about 300. In still further embodiments, the selectivity of the composite membrane (P_{He}/P_{CH4}) is selected from about 200, about 225, about 250, about 275, about 300, about 325, about 350, about 375, about 400, about 425, about 450, about 475, and about 500.

In certain embodiments, the composite membrane is selective for separating H₂ from N₂. In some embodiments, the selectivity of the composite membrane (PH2/P_{N2}) is from about 0 to about 50. In certain embodiments, the selectivity of the composite membrane (PH2/P_{N2}) is from about 51 to about 150. In some embodiments, the selectivity of the composite membrane (PH2/P_{N2}) is from about 151 to about 300. In certain embodiments, the selectivity of the composite membrane (PH2/P_{N2}) is from about 301 to about 450. In some embodiments, the selectivity of the composite membrane (PH2/P_{N2}) is from about 451 to about 3500. In certain embodiments, the selectivity of the composite membrane (PH2/P_{N2}) is greater than about 450. In some embodiments, the selectivity of the composite membrane (PH2/P_{N2}) is from about 0 to about 10. In certain embodiments, the selectivity of the composite membrane (PH2/P_{N2}) is from about 11 to about 50. In some embodiments, the selectivity of the composite membrane (PH2/P_{N2}) is from about 51 to about 150. In certain embodiments, the selectivity of the composite membrane (PH2/P_{N2}) is greater than about 150. In some embodiments, the selectivity of the composite membrane (PH2/P_{N2}) is from about 150 to about 3500. In further embodiments, the selectivity of the composite membrane (PH2/P_{N2}) is from about 100 to about 300. In yet further embodiments, the selectivity of the composite membrane (PH2/P_{N2}) is from about 150 to about 200. In still further embodiments, the selectivity of the composite membrane (PH2/P_{N2}) is selected from about 150, about 175, about 200, about 225, about 250, about 275, and about 300.

In certain embodiments, the composite membrane is selective for separating CO₂ from C₂F₂H₂ (1,1-difluoroethene, refrigerant R1132a). In some embodiments, the selectivity of the composite membrane (P_{CO2}/P_{C2F2H2}) is from about 0 to about 50. In certain embodiments, the selectivity of the composite membrane (P_{CO2}/P_{C2F2H2}) is from about 51 to about 150. In some embodiments, the selectivity of the composite membrane (P_{CO2}/P_{C2F2H2}) is from about 151 to about 300. In certain embodiments, the selectivity of the composite membrane (P_{CO2}/P_{C2F2H2}) is from about 301 to about 450. In some embodiments, the selectivity of the composite membrane (P_{CO2}/P_{C2F2H2}) is from about 451 to about 3500. In certain embodiments, the selectivity of the composite membrane (P_{CO2}/P_{C2F2H2}) is greater than about 450. In some embodiments, the selectivity of the composite membrane (P_{CO2}/P_{C2F2H2}) is from about 0 to about 10. In certain embodiments, the selectivity of the composite membrane (P_{CO2}/P_{C2F2H2}) is from about 11 to about 50. In some embodiments, the selectivity of the composite membrane (P_{CO2}/P_{C2F2H2}) is from about 51 to about 150. In certain embodiments, the selectivity of the composite membrane (P_{CO2}/P_{C2F2H2}) is greater than about 150. In some embodiments, the selectivity of the composite membrane (P_{CO2}/P_{C2F2H2}) is from about 150 to about 3500. In further embodiments, the selectivity of the composite membrane (P_{CO2}/P_{C2F2H2}) is from about 75 to about 200. In yet further embodiments, the selectivity of the composite membrane (P_{CO2}/P_{C2F2H2}) is from about 100 to about 150. In still further embodiments, the selectivity of the composite membrane (P_{CO2}/P_{C2F2H2}) is selected from about 100, about 110, about 120, about 130, about 140, and about 150.

In certain embodiments, the composite membrane is selective for separating CO₂ from C₂H₂F₄ (R134a, halocarbon 134a, 1,1,1,2-tetrafluoroethane). In some embodiments, the selectivity of the composite membrane (P_{CO2}/P_{C2H2F4}) is from about 0 to about 50. In certain embodiments, the selectivity of the composite membrane (P_{CO2}/P_{C2H2F4}) is from about 51 to about 150. In some embodiments, the selectivity of the composite membrane (P_{CO2}/P_{C2H2F4}) is from about 151 to about 300. In certain embodiments, the selectivity of the composite membrane (P_{CO2}/P_{C2H2F4}) is from about 301 to about 450. In some embodiments, the selectivity of the composite membrane (P_{CO2}/P_{C2H2F4}) is from about 451 to about 3500. In certain embodiments, the selectivity of the composite membrane (P_{CO2}/P_{C2H2F4}) is greater than about 450. In some embodiments, the selectivity of the composite membrane (P_{CO2}/P_{C2H2F4}) is from about 0 to about 10. In certain embodiments, the selectivity of the composite membrane (P_{CO2}/P_{C2H2F4}) is from about 11 to about 50. In some embodiments, the selectivity of the composite membrane (P_{CO2}/P_{C2H2F4}) is from about 51 to about 150. In certain embodiments, the selectivity of the composite membrane (P_{CO2}/P_{C2H2F4}) is greater than about 150. In some embodiments, the selectivity of the composite membrane (P_{CO2}/P_{C2H2F4}) is from about 150 to about 3500. In further embodiments, the selectivity of the composite membrane (P_{CO2}/P_{C2H2F4}) is from about 500 to about 1500. In yet further embodiments, the selectivity of the composite membrane (P_{CO2}/P_{C2H2F4}) is from about 900 to about 1300. In still further embodiments, the selectivity of the composite membrane (P_{CO2}/P_{C2H2F4}) is selected from about 900, about 950, about 975, about 1000, about 1025, about 1050, about 1075, about 1100, about 1150, about 1200, about 1250, and about 1300.

The composite membranes of the present disclosure represent an improvement over what had previously been demonstrated, at least because they exhibit selectivity for gas separation without the need for long-term curing. In certain embodiments, the composite material exhibits said selectivity without being cured for more than about 100 days. In further embodiments, the composite material exhibits said selectivity without being cured for more than about 7 days. In yet further embodiments, the composite material exhibits said selectivity without being cured.

As will be appreciated, composite membranes can take any number of morphological forms which are known in the art. In certain embodiments, the composite membrane is in the form of hollow fibers, tubes, sheets, or combinations thereof.

### Methods of Making Composite Membranes

In further aspects, provided herein are methods of preparing a composite membrane of the present disclosure. In certain embodiments, the method comprises:
providing a support mixture comprising a support polymer precursor, a first solvent, and a second solvent, the support mixture having a first solvent:second solvent ratio; contacting the support mixture with a substrate, thereby forming a nascent support; curing the nascent support, the thereby forming a mesoporous support;
providing a selective solution comprising a selective polymer precursor and a third solvent;
coating the mesoporous support with the selective solution, thereby forming a nascent membrane;
annealing and drying the nascent membrane to form the composite membrane.

In certain embodiments, the support mixture further comprises a salt. In further embodiments, the first solvent:second solvent ratio is from about 5:1 to about 15:1, preferably wherein the first solvent:second solvent ratio is about 10:1. In yet further embodiments, the plurality of pores has a pore diameter and a pore volume which are controlled by the first solvent:second solvent ratio. In still further embodiments, the annealing and drying the nascent membrane to form the composite membrane does not comprise curing for more than 100 days. In certain embodiments, the annealing and drying the nascent membrane to form the composite membrane does not comprise curing.

### Methods of Separating Fluids

In yet further aspects, provided herein are methods for separating a mixture of fluids comprising a first fluid and a second fluid, the methods comprising:
contacting a fluid mixture with a composite membrane of the present disclosure, thereby separating the mixture of fluids into:
a permeate comprising a first portion of the first fluid and a first portion of the second fluid; and
a retentate comprising a second portion of the second fluid.

As will be appreciated, the efficiency and selectivity of such separations will be affected by any number of process parameters, including the initial composition of the mixture of fluids, pressures, temperatures, etc. Additionally, as will be apparent to one of skill in the art, when describing percentages that are greater than or less than (or higher or lower than) other percentages, this describes an additive or subtractive change in the total percentage. For instance, for a mixture of fluids comprising 50% of the first fluid and 50% of the second fluid, where the percentage of the first fluid is said to increase by 5%, this would result in a mixture comprising 55% first fluid.

In certain embodiments, the volume percent of the first fluid in the permeate is higher than the volume percent of the first fluid in the mixture of fluids by about 1% to about 99%. In further embodiments, the volume percent of the first fluid in the permeate is higher than the volume percent of the first fluid in the mixture of fluids by at least about 1%, about 5%, about 10%, about 20%, about 30%, about 40%, about 50%, about 60%, about 70%, about 80%, about 90%, about 95%, about 97.5%, or about 99%. In yet further embodiments, the volume percent of the first fluid in the permeate is higher than the volume percent of the first fluid in the mixture of fluids by at most about 1%, about 5%, about 10%, about 20%, about 30%, about 40%, about 50%, about 60%, about 70%, about 80%, about 90%, about 95%, about 97.5%, or about 99%. In yet further embodiments, the volume percent of the first fluid in the permeate is higher than the volume percent of the first fluid in the mixture of fluids by about 1%, about 5%, about 10%, about 20%, about 30%, about 40%, about 50%, about 60%, about 70%, about 80%, about 90%, about 95%, about 97.5%, or about 99%.

In certain embodiments, the volume percent of the second fluid in the permeate is lower than the volume percent of the second fluid in the mixture of fluids by about 1% to about 99%. In further embodiments, the volume percent of the second fluid in the permeate is lower than the volume percent of the second fluid in the mixture of fluids by at least about 1%, about 5%, about 10%, about 20%, about 30%, about 40%, about 50%, about 60%, about 70%, about 80%, about 90%, about 95%, about 97.5%, or about 99%. In yet further embodiments, the volume percent of the second fluid in the permeate is lower than the volume percent of the second fluid in the mixture of fluids by at most about 1%, about 5%, about 10%, about 20%, about 30%, about 40%, about 50%, about 60%, about 70%, about 80%, about 90%, about 95%, about 97.5%, or about 99%. In still further embodiments, the volume percent of the second fluid in the permeate is lower than the volume percent of the second fluid in the mixture of fluids by about 1%, about 5%, about 10%, about 20%, about 30%, about 40%, about 50%, about 60%, about 70%, about 80%, about 90%, about 95%, about 97.5%, or about 99%.

In certain embodiments, the volume percent of the first fluid in the permeate is from about 99% to about 1%. In further embodiments, the volume percent of the first fluid in the permeate is greater than about 99%, about 95%, about 90%, about 80%, about 70%, about 60%, about 50%, about 40%, about 30%, about 20%, about 10%, about 5%, about 2.5%, and about 1%; preferably wherein volume percent of the first fluid in the permeate is greater than about 95%. In yet further embodiments, the volume percent of the first fluid in the permeate is less than about 99%, about 95%, about 90%, about 80%, about 70%, about 60%, about 50%, about 40%, about 30%, about 20%, about 10%, about 5%, about 2.5%, and about 1%; preferably wherein volume percent of the first fluid in the permeate is less than about 95%. In still further embodiments, the volume percent of the first fluid in the permeate is about 99%, about 95%, about 90%, about 80%, about 70%, about 60%, about 50%, about 40%, about 30%, about 20%, about 10%, about 5%, about 2.5%, and about 1%; preferably wherein volume percent of the first fluid in the permeate is about 95%.

In certain embodiments, the volume percent of the second fluid in the permeate is from about 99% to about 1%. In further embodiments, the volume percent of the second fluid in the permeate is less than about 99%, about 95%, about 90%, about 80%, about 70%, about 60%, about 50%, about 40%, about 30%, about 20%, about 10%, about 5%, about 2.5%, and about 1%; preferably wherein volume percent of the second fluid in the permeate is less than about 5%. In yet further embodiments, the volume percent of the second fluid in the permeate is greater than about 99%, about 95%, about 90%, about 80%, about 70%, about 60%, about 50%, about 40%, about 30%, about 20%, about 10%, about 5%, about 2.5%, and about 1%; preferably wherein volume percent of the second fluid in the permeate is greater than about 5%. In still further embodiments, the volume percent of the second fluid in the permeate is about 99%, about 95%, about 90%, about 80%, about 70%, about 60%, about 50%, about 40%, about 30%, about 20%, about 10%, about 5%, about 2.5%, and about 1%; preferably wherein volume percent of the second fluid in the permeate is about 5%.

In certain embodiments, the volume of the first fluid in the permeate is higher than about 10% to about 99% by volume of the first fluid in the mixture of fluids. In further embodiments, the volume of the first fluid in the permeate is higher than about 10% by volume, about 20% by volume, about 30% by volume, about 40% by volume, about 50% by volume, about 60% by volume, about 70% by volume, about 80% by volume, about 90% by volume, about 95% by volume, about 98% by volume, or about 99% by volume of the volume of the first fluid in the mixture of fluids; preferably wherein the volume of the first fluid in the permeate is higher than about 80% of the volume of the first fluid in the mixture of fluids. In yet further embodiments, the volume of the first fluid in the permeate is lower than about 10% by volume, about 20% by volume, about 30% by volume, about 40% by volume, about 50% by volume, about 60% by volume, about 70% by volume, about 80% by volume, about 90% by volume, about 95% by volume, about 98% by volume, or about 99% by volume of the volume of the first fluid in the mixture of fluids; preferably wherein the volume of the first fluid in the permeate is lower than about 80% of the volume of the first fluid in the mixture of fluids. In still further embodiments, the volume of the first fluid in the permeate is about 10% by volume, about 20% by volume, about 30% by volume, about 40% by volume, about 50% by volume, about 60% by volume, about 70% by volume, about 80% by volume, about 90% by volume, about 95% by volume, about 98% by volume, or about 99% by volume of the volume of the first fluid in the mixture of fluids; preferably wherein the volume of the first fluid in the permeate is about 80% of the volume of the first fluid in the mixture of fluids.

In certain embodiments, the first fluid is He, and the second fluid is CH₄. In further embodiments, the first fluid is H₂, and the second fluid is N₂.

In certain embodiments, the pores of the support member are substantially parallel to the direction of fluid flow through the composite membrane (i.e., direct flow separation). In further embodiments, the pores of the support member are substantially perpendicular to the direction of fluid flow through the composite membrane (i.e., tangential flow separation).

### EXAMPLES

The invention now being generally described, it will be more readily understood by reference to the following examples which are included merely for purposes of illustration of certain aspects and embodiments of the present invention, and are not intended to limit the invention.

### General Procedure 1: Support Dope Preparation

To a glass jar with a screw top lid is added PEI (polyetherimide, e.g., Ultem 1000) powder previously dried in a vacuum oven at 110° C. overnight, an appropriate solvent mixture, and optionally lithium nitrate, is added. The jar is capped and placed on rollers until a homogenous solution is obtained. The solution is placed upright and allowed to degas for at least 24 hours and stored in a desiccator until use. Examples 1-4 provide exemplary support dope preparations.

### Example 1: Support Dope Preparation—Method 1

To a glass jar with a screw top lid was added Ultem 1000 powder previously dried in a vacuum oven at 110° C. overnight (30 g), N-methylpyrrolidinone (99 mL), anhydrous THF (16.9 mL), water (1.5 mL), and lithium nitrate (1.5 g). The jar was capped and placed on rollers until a homogenous solution was obtained. The solution was stood upright and allowed to degas for at least 24 hours and stored in a desiccator until use. This provided a dope that is 20% Ultem, 68% NMP, 10% THF, 1% water, 1% lithium nitrate by weight.

### Example 2: Support Dope Preparation—Method 2

To a glass jar with a screw top lid was added Ultem 1000 powder previously dried in a vacuum oven at 110° C. overnight (18 g), DMF (65.1 mL), and anhydrous dioxane (19.9 mL). The jar was capped and placed on rollers until a homogenous solution was obtained. The solution was stood upright and allowed to degas for at least 24 hours and stored in a desiccator until use. This provided a dope that is 18% Ultem, 61.5% NMP, and 20.5% dioxane by weight.

### Example 3: Support Dope Preparation—Method 3

To a glass jar with a screw top lid was added Ultem 1000 powder previously dried in a vacuum oven at 110° C. overnight (30 g), DMSO (51.8 mL), anhydrous dioxane (55.3 mL), and ethanol (7.6 mL). The jar was capped and placed on rollers until a homogenous solution was obtained. The solution was stood upright and allowed to degas for at least 24 hours and stored in a desiccator until use. This provided a dope that is 20% Ultem, 38% DMSO, 38% dioxane, and 4% ethanol by weight.

### Example 4: Support Dope Preparation—Method 4

To a glass jar with a screw top lid was added Ultem 1000 powder previously dried in a vacuum oven at 110° C. overnight (30 g), DMSO (54.5 mL), and anhydrous dioxane (58.2 mL). The jar was capped and placed on rollers until a homogenous solution was obtained. The solution was stood upright and allowed to degas for at least 24 hours and stored in a desiccator until use. This provided a dope that is 20% Ultem, 40% DMSO, and 40% dioxane.

### Example 5: Membrane Support Fabrication—Method 1

An A4 sized piece of nonwoven fabric (Novatexx 2471, PP/PE) was taped to an appropriately sized piece of glass with polyimide tape. The glass was then clamped to an automated casting table (Elcometer 4340) and a casting blade with a blade height of 10 mil (254 μm) was placed at the top of the nonwoven sheet. Polymer dope solution (20 mL) was poured onto the nonwoven sheet in front of the casting blade and then casted at a rate of 4.2 m/min. After 10 seconds, the nascent membrane was immersed in a coagulation bath of deionized water to induce phase separation and left in water for 24 hours for solvent exchange. The membrane was then placed in isopropanol for 24 hours for further solvent exchange, after which it was placed in a 1% w/v solution of 1, 3-propanediamine in methanol for 24 hours to cross-link the membrane. After the completion of the cross-linking reaction the membrane was soaked in fresh isopropanol three times for 30 minutes each, followed by fresh hexanes three times for 30 minutes each. The membrane was then air dried and stored until use.

### Example 6: Membrane Support Fabrication—Method 2

An A4 sized piece of nonwoven fabric (Novatexx 2471, PP/PE) was taped to an appropriately sized piece of glass with polyimide tape. The glass was then clamped to an automated casting table (Elcometer 4340) and a casting blade with a blade height of 10 mil (254 μm) was placed at the top of the nonwoven sheet. Polymer dope solution (20 mL) was poured onto the nonwoven sheet in front of the casting blade and then casted at a rate of 4.2 m/min. After 10 seconds, the nascent membrane was immersed in a coagulation bath of deionized water to induce phase separation and left in water for 24 hours for solvent exchange. The membrane was then placed in isopropanol for 24 hours for further solvent exchange, after which it was placed in a 1% w/v solution of 1, 3-propanediamine in methanol for 24 hours to cross-link the membrane, followed by a 5% w/v solution of 1, 3-propanediamine for 24 hours. After the completion of the cross-linking reaction the membrane was soaked in fresh isopropanol three times for 30 minutes each, followed by fresh hexanes three times for 30 minutes each. The membrane was then air dried and stored until use.

### General Procedure 2: Polymer Cross-Linking for Membrane Support Fabrication

Following solvent exchange in isopropanol, the polymer membrane of the membrane supports are cross-linked by placing in a 1% w/v solution of 1,3-diaminopropane in either ethanol or isopropanol for 4-24 h to cross-link the membrane. The resulting cross-linked membrane supports are air dried and stored for later use.

### General Procedure 3: Thin Film Composite (TFCQ Fabrication

A membrane support prepared by General Procedure 1 is taped to a glass plate and clamped to a casting table (e.g., Elcometer 4340). A polymer solution, having a concentration from about 15 mg/mL to about 45 mg/mL, in a solvent (e.g., chloroform, THF, 2-Me-THF, 1,3-dioxolane, diethyl ketone, or toluene) is poured onto the membrane substrate and coated with a Mayer rod (1 mil, 25.4 μm) at a speed of about 4.2 m/min. One or more additional polymer layers may be subsequently added by the same method. The membrane is annealed in a chloroform vapor for about 5 min to solvent anneal the nascent film. The resulting membrane composite is air dried (e.g., from about 5 min to about 16 h at ambient temperature), followed by drying at 60° C. (e.g., from about 6 h to about 16 h). Exemplary TFCs prepared by these methods ranged in size from about 4 in×6 in to about 6 in×12 in. Examples 7-9 provide exemplary TFC fabrication methods.

### Example 7: TFC Fabrication—Method 1

A 4″×6″ piece of Ultem membrane support was taped to a glass plate with heat resistant polyimide tape and clamped to a casting table (Elcometer 4340). A 1 wt % polymer solution in chloroform cooled to 4° C. (0.5 mL, 15 mg/mL) was poured onto the membrane substrate and coated with a Mayer rod (1 mil, 25.4 μm) at a speed of 4.2 m/min. The membrane was allowed to air dry for 15 min. Then a 3 wt % polymer solution in chloroform cooled to 4° C. (0.5 mL, 45 mg/mL) was poured onto the membrane substrate and coated with a Mayer rod (1 mil, 25.4 μm) at a speed of 4.2 m/min. The membrane was then placed into a glass chamber saturated with chloroform vapor for 5 minutes to solvent anneal the nascent film. The membrane composite was then covered and air dried for 48 hours, followed by drying at 50° C. for 24 hours.

### Example 8: TFC Fabrication—Method 2

A 4″×6″ piece of Ultem membrane support was taped to a glass plate with heat resistant polyimide tape and clamped to a casting table (Elcometer 4340). A 2.5 wt % polymer solution in chloroform cooled to 4° C. (0.5 mL, 15 mg/mL) was poured onto the membrane substrate and coated with a Mayer rod (1 mil, 25.4 μm) at a speed of 4.2 m/min. The membrane was then placed into a glass chamber saturated with chloroform vapor for 5 minutes to solvent anneal the nascent film. The membrane composite was then covered and air dried for 16 hours, followed by drying at 60° C. for 6 hours.

### Example 9: TFC Fabrication—Method 3

A 4″×6″ piece of Ultem membrane support was taped to a glass plate with heat resistant polyimide tape and clamped to a casting table (Elcometer 4340). A 2.5 wt % polymer solution in chloroform cooled to 4° C. (0.5 mL, 15 mg/mL) was poured onto the membrane substrate and coated with a Mayer rod (1 mil, 25.4 μm) at a speed of 4.2 m/min. The membrane was then placed into a glass chamber saturated with chloroform vapor for 5 minutes to solvent anneal the nascent film. The membrane composite was then covered and air dried for 16 hours, followed by drying at 60° C. for 6 hours.

### Example 10: Permeation Experiments

Experiments were performed on a constant-volume variable pressure apparatus at 35° C. and 15 psi upstream pressure. The thin-film composite membranes were masked with epoxy on a brass support and degassed under high vacuum at 35° C. for 1 h. The permeance, P, of gasses were determined using the following equation:

$$P = \frac{{V}_{D}}{( {p}_{2} - \overline{{p}_{1}} ) ART} [ {( \frac{{dp}_{1}}{dt} )}_{ss} - {( \frac{{dp}_{1}}{dt} )}_{leak} ] ,$$

where V_{D} is the downstream volume, p₂ is the upstream pressure, p̅₁ is the average downstream pressure calculated in the time interval considered, A is the exposed area of the membrane, and

$${( \frac{{dp}_{1}}{dt} )}_{ss} and {( \frac{{dp}_{1}}{dt} )}_{leak}$$

are the change in downstream pressure at steady-state permeation and when the system is sealed, respectively. Ideal gas pair selectivity for gases A and B (A/B) are defined to be P_{A}/P_{B} where P_{A} and P_{B} are the permeances of gases A and B, respectively.

Permeation results of a thin-film composite membrane made using support dope preparation method 2 and membrane support fabrication method 2 are shown in Table 10A, and selectivity results are shown in Table 10B-E.

TABLE 10A
Gas Permeance Results of Thin Film Composite Membranes
made using support dope preparation method 2
and membrane support fabrication method 2

| Gas | Permeance Range | |
|---|---|---|
| He | 1-2000 | GPU |
| CH₄ | 0.1-100 | GPU |
| H₂ | 1-2000 | GPU |
| N₂ | 0.1-100 | GPU |
| O₂ | 2-500 | GPU |
| CO₂ | 1-1000 | GPU |

where 1 GPU = 10⁻⁶ cm³(STP)/(cm² s cm Hg)

TABLE 10B
Selectivity Results of Thin Film Composite Membranes
made using support dope preparation method 2
and membrane support fabrication method 2

| Gas Pair | Selectivity |
|---|---|
| He/CH₄ | +++ |
| H₂/N₂ | +++ |
| O₂/N₂ | + |

Key: Selectivity: + (0-50); ++ (51-150); +++ (151-300); ++++ (301-450); +++++ (>450).

TABLE 10C
Selectivity Results of Thin Film Composite Membranes made
using support dope of Example 12 and polymer of Example 12

| Gas Pair | Selectivity |
|---|---|
| H₂/CH₄ | +++ |
| H₂/CO₂ | + |
| CO₂/CH₄ | + |
| He/N₂ | +++ |
| He/CH₄ | ++++ |
| O₂/N₂ | + |

Key: Selectivity: + (0-50); ++ (51-150); +++ (151-300); ++++ (301-450); +++++ (>450).

TABLE 10D
Selectivity Results of Thin Film Composite Membranes made using
support dope of Example 3, support fabrication of Example
5, TFC fabrication of Example 9, and polymer of Example 13.

| Gas Pair | Selectivity |
|---|---|
| H₂/CH₄ | +++ |
| H₂/CO₂ | + |
| CO₂/CH₄ | + |
| He/N₂ | ++ |
| He/CH₄ | ++ |
| O₂/N₂ | + |

Key: Selectivity: + (0-50); ++ (51-150); +++ (151-300); ++++ (301-450); +++++ (>450).

TABLE 10E
Selectivity Results of Thin Film Composite Membranes made using
support dope of Example 3, support fabrication of Example
5, TFC fabrication of Example 9, and polymer of Example 15.

| Gas Pair | Selectivity |
|---|---|
| H₂/CH₄ | ++ |
| H₂/CO₂ | + |
| CO₂/CH₄ | + |

Key: Selectivity: + (0-50); ++ (51-150); +++ (151-300); ++++ (301-450); +++++ (>450).

### Example 11: General Procedure 4—General Synthesis of Representative Polyimide-Type Polymers

In an oven-dried Schlenk tube equipped with a magnetic stirrer and under a steady flow of N₂ 1.0 mmol of diamine monomer and 1.0 mmol of a diphthalic anhydride are added. After purging the tube for 10 min at room temperature, 2.3 mL of m-cresol and 5-6 drops of isoquinoline are added, and the temperature was raised to 100° C. while stirred. After the reaction system is dissolved completely, the temperature is further adjusted to 190° C. After 4 hours, a viscous polymer solution is obtained, the reaction is then terminated and diluted with 5 ml CHCl₃. The desired polyimide is precipitated in ethanol. The resulting fibrous precipitate is obtained by washing with ethanol several times, and drying overnight at 120° C. under vacuum.

### Example 12: Synthesis of a Representative Polyimide-Type Polymer

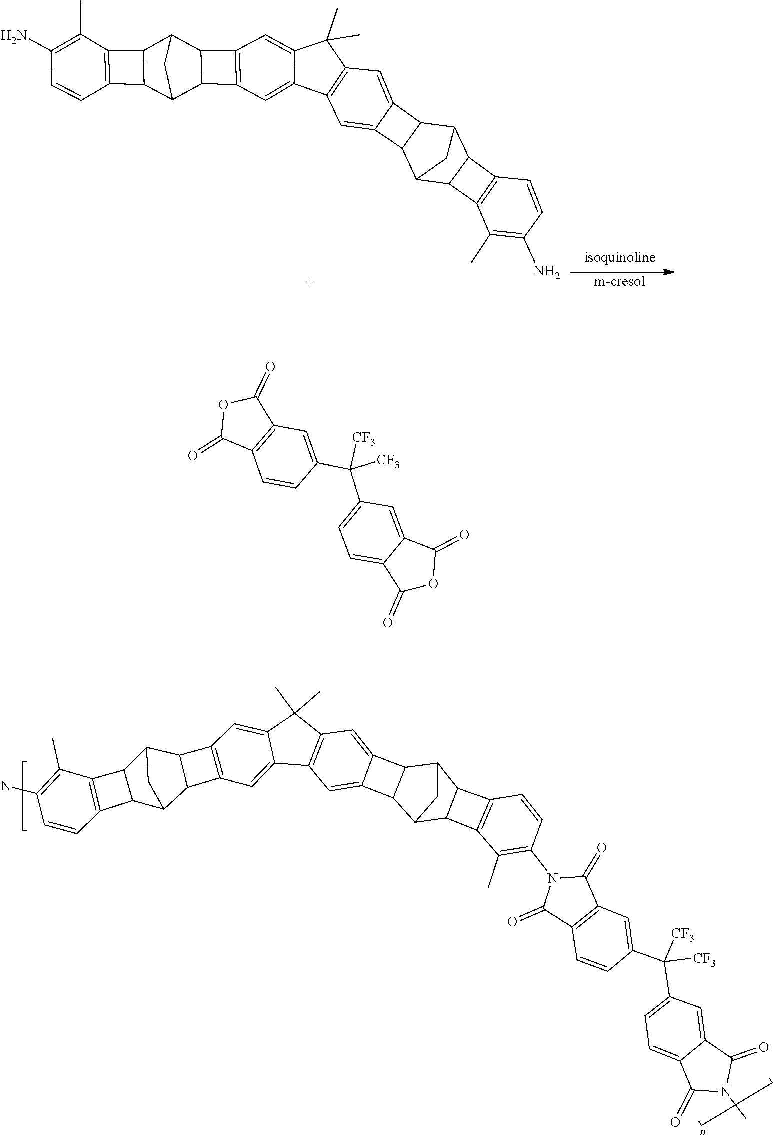

In an oven-dried Schlenk tube equipped with a magnetic stirrer and under a steady flow of N₂ 584 mg (1.0 mmol) of diamine monomer and 444 mg (1.0 mmol) of 4,4′-(Hexafluoro-isopropylidene) diphthalic anhydride (6FDA) were added. After purging the tube for 10 min at room temperature, 2.3 mL of m-cresol and 5-6 drops of isoquinoline were added, and the temperature was raised to 100° C. while stirred. After the reaction system was dissolved completely, the temperature was further adjusted to 190° C. After 4 hours, a viscous polymer solution was obtained, the reaction was then terminated and diluted with 5 ml CHCl₃. The desired polyimide was precipitated in ethanol. The resulting fibrous precipitate was obtained by washing with ethanol several times, and drying overnight at 120° C. under vacuum.

¹H-NMR (CDCl₃, 400 MHz, δ): 8.03 (d, J=7.9 Hz, 1H), 7.91 (s, 2H), 7.34 (t, J=9.5 Hz, 1H), 7.10-7.04 (m, 1H), 7.01 (d, J=13.3 Hz, 2H), 3.31 (s, 4H), 2.46 (d, J=22.9 Hz, 2H), 2.07 (s, 3H), 1.58 (brs, 3H), 1.48-1.40 (m, 3H), 0.89 (s, 2H).

### Example 13: Synthesis of Composite Membrane 1 Using the Polymer of Example 12

The support dope was prepared using the method of Example 3. The membrane support was fabricated using the method of Example 5. Support dope compositions are as follows:
20% PEI, 40% DMSO, 40% Dioxane
20% PEI, 39% DMSO, 39% Dioxane, 2% EtOH
20% PEI, 38% DMSO, 38% Dioxane, 4% EtOH

### TFC Casting Method

0.4 mL of 2.5 wt % of polyimide from Example 12 in chloroform (37.5 mg/mL) was cast onto 2.5″×6″ support with 1 mil (25.4 μm) Meyer rod, 5 min solvent annealing in chloroform vapor chamber, 24 hours drying at room temperature, 16 hours at 60° C. Provided membranes with active layer thickness from 700 nm-1 μm

### Example 14: Synthesis of Composite Membrane 2

The support dope was prepared using the method of Example 3. The membrane support was fabricated using the method of Example 5. The TFC was fabricated using the method of Example 9. Composite membrane was made using the following polymer:

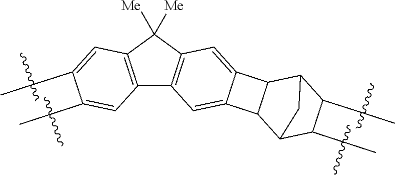 [SMILES: *c1cc2c(cc1*)C(C)(C)c1cc3c(cc1-2)C1C2CC(C(*)C2*)C31]

### Example 15: Synthesis of Composite Membrane 4

The support dope was prepared using the method of Example 3. The membrane support was fabricated using the method of Example 5. The TFC was fabricated using the method of Example 9. Composite membrane was made using the following polymer:

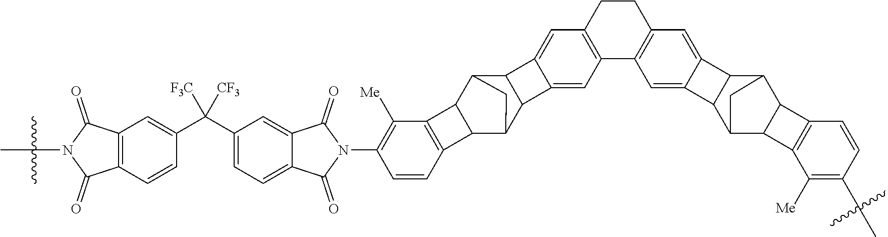 [SMILES: *c1ccc2c(c1C)C1C3CC(C4c5cc6c(cc5C34)-c3cc4c(cc3CC6)C3C5CC(C43)C3c4ccc(N6C(=O)c7ccc(C(c8ccc9c(c8)C(=O)N(*)C9=O)(C(F)(F)F)C(F)(F)F)cc7C6=O)c(C)c4C53)C21]

### Example 16: General Procedure for Continuous Membrane Support Fabrication

Membrane supports are fabricated on a roll-to-roll machine using the desired support dope composition and the desired non-woven fabric (e.g., PET polyester (e.g., Hollytex 3329) or Novatexx 2471, PP/PE), line speeds of 3-7 ft/min, humidities of 10-80% r.h., temperatures of 23° C.-32° C., slot die height from 50 μm-150 μm, producing sheets ranging from 10-500 feet in length, 12 in. width. The resulting membrane is cross-linked and dried for later use according to General Procedure 2.

### Example 17: Exemplary Support Dope Compositions for Continuous Support Fabrication

The following support dope compositions were prepared using general procedure 1:
20% PEI (polyetherimide), 19% DMSO (dimethylsulfoxide), 19% DMAc (dimethylacetamide), 38% 1,4-dioxane, 4% EtOH (ethanol).
20% PEI, 19% DMSO, 19% NMP (N-methyl-2-pyrrolidone), 38% 1,4-dioxane, 4% EtOH.
20% PEI, 19% DMSO, 19% NMP, 38% 1,3-dioxolane, 4% EtOH.
20% PEI, 19% DMSO, 19% NMP, 28% 1,3-dioxolane, 10% gamma-valerolactone, 4% EtOH.
20% PEI, 37.95% DMSO, 37.95% 1,4-dioxane, 4% EtOH, 0.1% water.
20% PEI, 28% NMP, 28% DMSO, 20% gamma-valerolactone, 4% diethylene glycol.

### Example 18: Exemplary Cross-Linking Methods for Use in General Procedure 2

Provided below are cross-linking conditions for use in General Procedure 2.
cross-linking solution: 1% w/v 1,3-diaminopropane in ethanol; temperature: 50° C.; time: 8 hr.
cross-linking solution: 1% w/v 1,3-diaminopropane in isopropanol; temperature: 50° C., time: 24 hr.
cross-linking solution: 1% w/v 1,3-diaminopropane in isopropanol; temperature: 60° C., time: 4 hr.

### Example 19: Exemplary Conditions for Use in General Procedure 3

Exemplary solvents successfully used in polymer coating step:
Chloroform (CHCl₃)
THF
2-Me-THF
1,3-dioxolane
diethyl ketone
toluene (PhMe)

Exemplary solvent combinations successfully used in polymer coating step:
CHCl₃
THF
1,3-dioxolane
1:1 CHCl₃/PhMe
1:1 THF/PhMe
1:1 1,3-dioxolane/PhMe
1:1 1,3-dioxolane/diethyl ketone
1:1 2-Me-THF/PhMe
1:1:2 THF/diethyl ketone/PhMe

Exemplary drying conditions successfully used in drying step:
15 min air dried at ambient temperature/16 h at 60° C.
16 h air dried at ambient temperature/16 h at 60° C.
5 min air dried at ambient temperature/6 h at 60° C.

### Example 20: Exemplary Composite Membrane 5

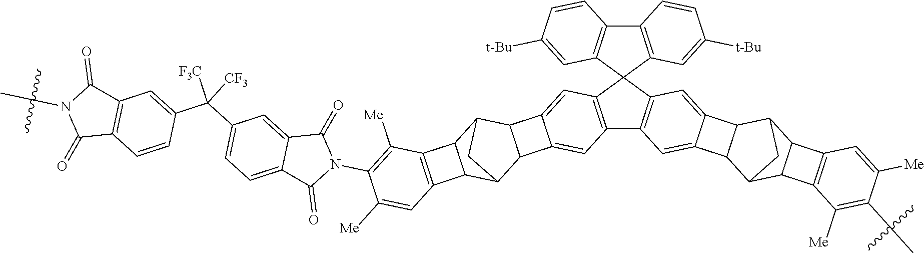 [SMILES: *c1c(C)cc2c(c1C)C1C3CC(C4c5cc6c(cc5C34)-c3cc4c(cc3C63c5cc(C(C)(C)C)ccc5-c5ccc(C(C)(C)C)cc53)C3C5CC(C43)C3c4cc(C)c(N6C(=O)c7ccc(C(c8ccc9c(c8)C(=O)N(*)C9=O)(C(F)(F)F)C(F)(F)F)cc7C6=O)c(C)c4C53)C21]

¹H NMR (500 MHz, CDCl₃) δ 8.04 (s, 2H), 7.94 (s, 4H), 7.70 (s, 2H), 7.56-7.45 (m, 2H), 7.37 (s, 3H), 6.93-6.74 (m, 3H), 6.61 (d, J=46.0 Hz, 2H), 6.36 (d, J=10.8 Hz, 2H), 3.37-3.11 (m, 8H), 2.46 (d, J=9.7 Hz, 2H), 2.22 (d, J=13.4 Hz, 3H), 2.14 (d, J=10.1 Hz, 6H), 1.99 (d, J=40.0 Hz, 6H), 1.25-1.04 (m, 17H), 0.83 (d, J=47.7 Hz, 4H).

### Example 21: Exemplary Composite Membrane 6

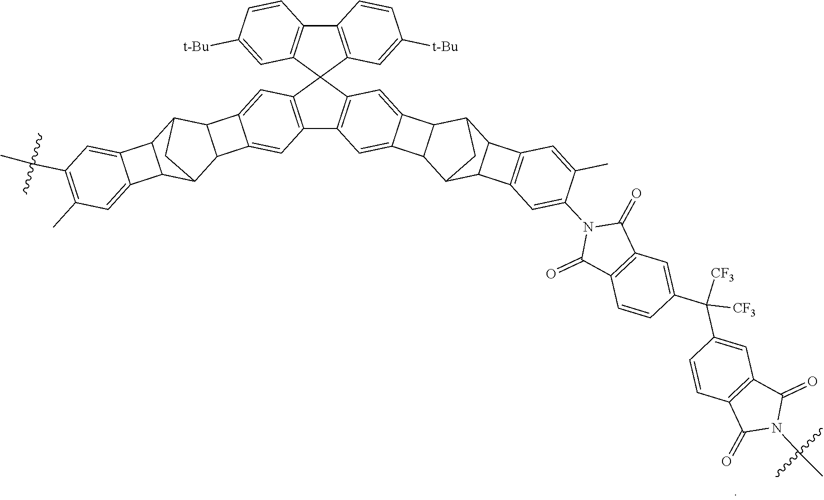 [SMILES: *c1cc2c(cc1C)C1C3CC(C21)C1c2cc4c(cc2C31)-c1cc2c(cc1C41c3cc(C(C)(C)C)ccc3-c3ccc(C(C)(C)C)cc31)C1C3CC(C21)C1c2cc(N4C(=O)c5ccc(C(c6ccc7c(c6)C(=O)N(*)C7=O)(C(F)(F)F)C(F)(F)F)cc5C4=O)c(C)cc2C31]

¹H NMR (500 MHz, CDCl₃) δ 8.04 (s, 2H), 7.92 (s, 5H), 7.75-7.65 (m, 2H), 7.50 (t, J=9.0 Hz, 2H), 7.46-7.31 (m, 2H), 6.98 (d, J=32.7 Hz, 4H), 6.78 (t, J=26.2 Hz, 3H), 6.66 (s, 1H), 6.35 (d, J=5.6 Hz, 2H), 3.39-3.13 (m, 8H), 2.54-2.40 (m, 2H), 2.25 (d, J=16.4 Hz, 2H), 2.10 (d, J=14.3 Hz, 4H), 2.02 (d, J=16.1 Hz, 3H), 1.29-1.05 (m, 18H), 0.81 (d, J=31.1 Hz, 4H).

### Example 22: Exemplary Composite Membrane 7a and 7b

### Membrane 7a

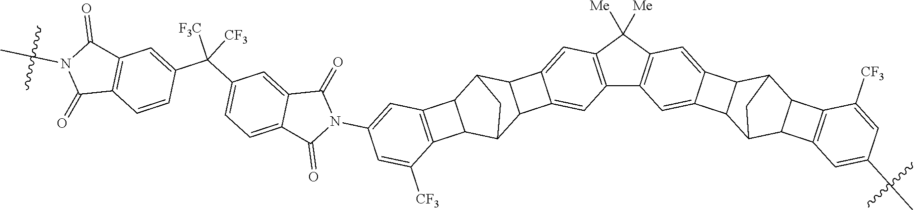 [SMILES: *c1cc2c(c(C(F)(F)F)c1)C1C3CC(C4c5cc6c(cc5C34)C(C)(C)c3cc4c(cc3-6)C3C5CC(C43)C3c4cc(N6C(=O)c7ccc(C(c8ccc9c(c8)C(=O)N(*)C9=O)(C(F)(F)F)C(F)(F)F)cc7C6=O)cc(C(F)(F)F)c4C53)C21]

¹H NMR (500 MHz, CDCl₃) δ 8.07 (d, J=6.9 Hz, 2H), 8.00-7.86 (m, 4H), 7.47 (s, 2H), 7.43-7.31 (m, 2H), 7.28-7.23 (m, 2H), 7.16-7.02 (m, 3H), 3.51 (d, J=22.1 Hz, 4H), 3.37 (d, J=15.4 Hz, 4H), 2.64-2.51 (m, 4H), 1.46 (d, J=12.8 Hz, 7H), 1.07-0.80 (m, 5H).

### Membrane 7b

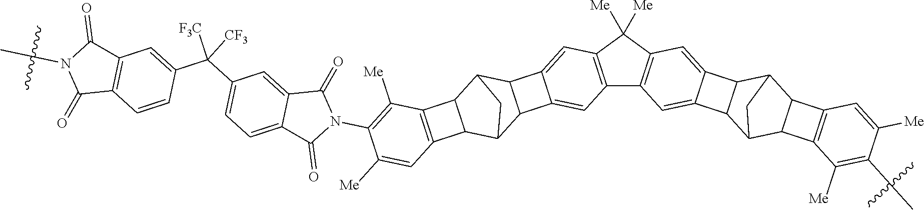 [SMILES: *c1c(C)cc2c(c1C)C1C3CC(C4c5cc6c(cc5C34)-c3cc4c(cc3C6(C)C)C3C5CC(C43)C3c4cc(C)c(N6C(=O)c7ccc(C(c8ccc9c(c8)C(=O)N(*)C9=O)(C(F)(F)F)C(F)(F)F)cc7C6=O)c(C)c4C53)C21]

¹H NMR (500 MHz, CDCl₃) δ 8.06 (d, J=8.1 Hz, 2H), 7.95 (s, 4H), 7.36 (t, J=9.8 Hz, 2H), 7.13-7.04 (m, 2H), 6.90 (s, 2H), 3.31 (d, J=11.3 Hz, 8H), 2.52-2.41 (m, 4H), 2.16 (d, J=5.0 Hz, 6H), 2.03 (d, J=5.4 Hz, 6H), 1.46 (d, J=12.2 Hz, 6H), 0.93 (s, 4H).

### Example 23: Exemplary Composite Membrane 8

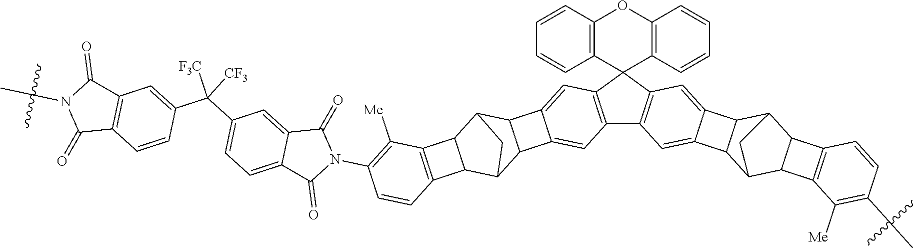 [SMILES: *c1ccc2c(c1C)C1C3CC(C4c5cc6c(cc5C34)-c3cc4c(cc3C63c5ccccc5Oc5ccccc53)C3C5CC(C43)C3c4ccc(N6C(=O)c7ccc(C(c8ccc9c(c8)C(=O)N(*)C9=O)(C(F)(F)F)C(F)(F)F)cc7C6=O)c(C)c4C53)C21]

¹H NMR (500 MHz, CDCl₃) δ 8.04 (d, J=7.8 Hz, 2H), 7.92 (s, 4H), 7.43 (t, J=7.7 Hz, 2H), 7.21 (s, 4H), 7.09-6.91 (m, 4H), 6.79 (d, J=7.3 Hz, 4H), 6.42 (d, J=6.7 Hz, 2H), 3.35-3.14 (m, 7H), 2.41 (dd, J=60.7, 15.6 Hz, 5H), 2.05 (d, J=34.0 Hz, 6H), 0.87 (s, 4H).

### Example 24: Exemplary Composite Membrane 9

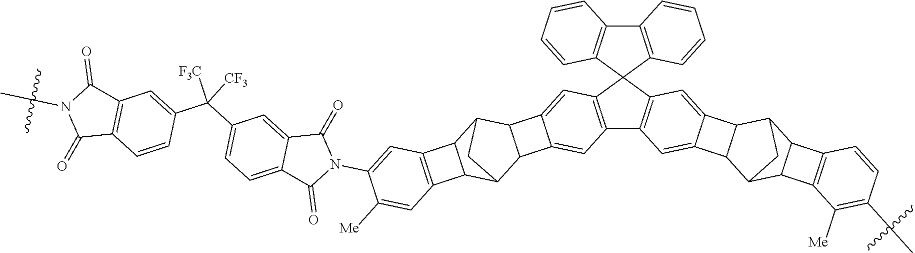 [SMILES: *c1ccc2c(c1C)C1C3CC(C4c5cc6c(cc5C34)-c3cc4c(cc3C63c5ccccc5-c5ccccc53)C3C5CC(C6c7cc(C)c(N8C(=O)c9ccc(C(c%10ccc%11c(c%10)C(=O)N(*)C%11=O)(C(F)(F)F)C(F)(F)F)cc9C8=O)cc7C56)C43)C21]

¹H NMR (500 MHz, CDCl₃) δ 8.11-7.98 (m, 2H), 7.92 (s, 2H), 7.84 (s, 2H), 7.48 (d, J=7.3 Hz, 2H), 7.37 (d, J=10.1 Hz, 2H), 7.13 (d, J=10.9 Hz, 2H), 6.98 (d, J=33.2 Hz, 3H), 6.79-6.63 (m, 3H), 6.35 (d, J=8.6 Hz, 2H), 3.36-3.11 (m, 5H), 2.56-2.43 (m, 2H), 2.36-2.18 (m, 2H), 2.05 (dd, J=45.0, 13.1 Hz, 6H), 0.83 (d, J=29.6 Hz, 3H).

### Example 25: Exemplary Composite Membrane 10

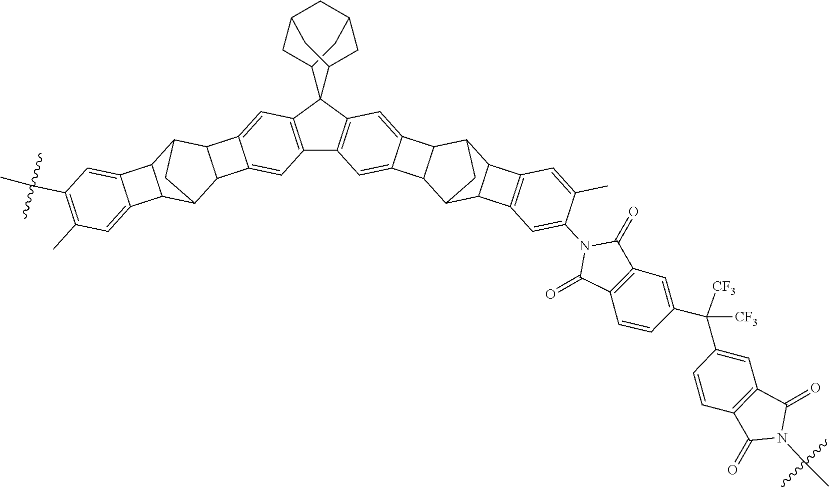 [SMILES: *c1cc2c(cc1C)C1C3CC(C21)C1c2cc4c(cc2C31)-c1cc2c(cc1C41C3CC4CC(C3)CC1C4)C1C3CC(C21)C1c2cc(N4C(=O)c5ccc(C(c6ccc7c(c6)C(=O)N(*)C7=O)(C(F)(F)F)C(F)(F)F)cc5C4=O)c(C)cc2C31]

¹H NMR (500 MHz, CDCl₃) δ 8.05 (d, J=7.2 Hz, 2H), 7.99-7.87 (m, 4H), 7.78-7.71 (m, 2H), 7.44 (d, J=11.4 Hz, 2H), 7.04 (t, J=9.6 Hz, 4H), 3.34 (d, J=16.6 Hz, 8H), 2.93 (s, 4H), 2.57-2.45 (m, 4H), 2.20 (s, 3H), 2.15-2.05 (m, 6H), 2.00 (s, 3H), 1.78 (s, 5H), 1.01-0.88 (m, 4H).

### Example 26: General Procedure for Obtaining Performance Data of Exemplary TFCs

The permeance (in GPU) was tested for a selection of exemplary Thin-Film Composite membranes (as specified in each of the subsequent examples) made according to methods of General Procedure 3. Single-gas permeation experiments were performed at pressures from about 1 bar to about 50 bar and temperatures from about 25° C. to about 100° C.

### Example 27: Gas Permeance and Selectivity Experiments with Composite Membrane 1

Composite Membrane 1 was fabricated, comprising the polymer below:

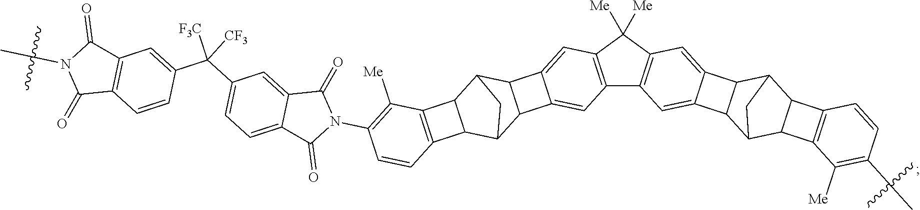 [SMILES: *c1ccc2c(c1C)C1C3CC(C4c5cc6c(cc5C34)-c3cc4c(cc3C6(C)C)C3C5CC(C43)C3c4ccc(N6C(=O)c7ccc(C(c8ccc9c(c8)C(=O)N(*)C9=O)(C(F)(F)F)C(F)(F)F)cc7C6=O)c(C)c4C53)C21]

having a Mₙ (number average molecular weight) from about 20 k-150 k, an M_{w} (weight average molecular weight) range from about 35 k-375 k, and a PDI (polydispersity index) range from about 1.7 to about 3.0. Gas permeation and selectivity results for the resulting TFC membranes are provided in Tables 27A-T.

TABLE 27A
Selectivity Results of TFC Membranes
of Example 27 at 1 bar and 35° C.

| Gas Pair | Selectivity |
|---|---|
| H₂/CH₄ | +++ |
| He/CH₄ | +++ |
| CO₂/CH₄ | + |
| CO₂/N₂ | + |
| O₂/N₂ | + |
| N₂/CH₄ | + |
| H₂/CO₂ | + |
| H₂/C₂H₄ | +++ |
| H₂/C2H₆ | +++++ |
| H₂/C₃H₈ | +++++ |
| H₂/C₄H₁₀ | +++ |

Key: + (0-50); ++ (51-150); +++ (151-300); ++++ (301-450); +++++ (>450).

TABLE 27B
Gas Permeance of TFC Membranes of Example
27 at 50° C. and varied pressures
Gas Permeance (GPU)

| | H₂ | He | N₂ | CH₄ | CO₂ | O₂ |
|---|---|---|---|---|---|---|
| 60 psi | **** | **** | * | * | *** | ** |
| 120 psi | **** | **** | * | * | *** | ** |
| 180 psi | **** | **** | * | * | *** | ** |
| 240 psi | **** | **** | * | * | *** | ** |
| 300 psi | **** | **** | * | * | *** | ** |

Key: * (0.1-5 GPU); ** (6-10 GPU); *** (11-75 GPU); **** (76-200 GPU); ***** (>200 GPU).
Where 1 GPU = 10⁻⁶ cm³(STP)/(cm² s cm Hg)

TABLE 27C
Selectivity Results of TFC Membranes of
Example 27 at 50° C. and varied pressures
Selectivities

| | H₂/ | H₂/ | He/ | He/ | CO₂/ | O₂/ | CO₂/ | CO₂/ |
|---|---|---|---|---|---|---|---|---|
| | CH₄ | N₂ | CH₄ | N₂ | CH₄ | N₂ | N₂ | O₂ |
| 60 psi | +++ | ++ | +++ | +++ | + | + | + | + |
| 120 psi | +++ | +++ | +++ | +++ | + | + | + | + |
| 180 psi | +++ | +++ | +++ | +++ | + | + | + | + |
| 240 psi | +++ | +++ | +++ | +++ | + | + | + | + |
| 300 psi | +++ | +++ | +++ | +++ | + | + | + | + |

Key: + (0-50); ++ (51-150); +++ (151-300); ++++ (301-450); +++++ (>450).

TABLE 27D
Gas Permeance of TFC Membranes of Example
27 at 75° C. and varied pressures
Gas Permeance (GPU)

| | H₂ | He | N₂ | CH₄ | CO₂ | O₂ |
|---|---|---|---|---|---|---|
| 60 psi | ***** | ***** | * | * | *** | *** |
| 120 psi | ***** | ***** | * | * | *** | *** |
| 180 psi | ***** | ***** | * | * | *** | *** |
| 240 psi | ***** | ***** | * | * | *** | *** |
| 300 psi | ***** | ***** | * | * | *** | *** |

Key: * (0.1-5 GPU); ** (6-10 GPU); *** (11-75 GPU); **** (76-200 GPU); ***** (>200 GPU).
Where 1 GPU = 10⁻⁶ cm³(STP)/(cm² s cm Hg)

TABLE 27E
Selectivity Results of TFC Membranes of
Example 27 at 75° C. and varied pressures
Selectivities

| | H₂/ | H₂/ | He/ | He/ | CO₂/ | O₂/ | CO₂/ | CO₂/ |
|---|---|---|---|---|---|---|---|---|
| | CH₄ | N₂ | CH₄ | N₂ | CH₄ | N₂ | N₂ | O₂ |
| 60 psi | ++ | ++ | +++ | ++ | + | + | + | + |
| 120 psi | ++ | ++ | +++ | ++ | + | + | + | + |
| 180 psi | ++ | ++ | +++ | ++ | + | + | + | + |
| 240 psi | +++ | ++ | +++ | ++ | + | + | + | + |
| 300 psi | +++ | ++ | +++ | ++ | + | + | + | + |

Key: + (0-50); ++ (51-150); +++ (151-300); ++++ (301-450); +++++ (>450).

TABLE 27F
Gas Permeance of TFC Membranes of Example
27 at 100° C. and varied pressures
Gas Permeance (GPU)

| | H₂ | He | N₂ | CH₄ | CO₂ | O₂ |
|---|---|---|---|---|---|---|
| 60 psi | ***** | ***** | * | * | *** | *** |
| 120 psi | ***** | ***** | * | * | *** | *** |
| 180 psi | ***** | ***** | * | * | *** | *** |
| 240 psi | ***** | ***** | * | * | *** | *** |
| 300 psi | ***** | ***** | * | * | *** | *** |

Key: * (0.1-5 GPU); ** (6-10 GPU); *** (11-75 GPU); **** (76-200 GPU); ***** (>200).
Where 1 GPU = 10⁻⁶ cm³(STP)/(cm² s cm Hg)

TABLE 27G
Selectivity Results of TFC Membranes of
Example 27 at 100° C. and varied pressures
Selectivities

| | H₂/ | H₂/ | He/ | He/ | CO₂/ | O₂/ | CO₂/ | CO₂/ |
|---|---|---|---|---|---|---|---|---|
| | CH₄ | N₂ | CH₄ | N₂ | CH₄ | N₂ | N₂ | O₂ |
| 60 psi | ++ | ++ | ++ | ++ | + | + | + | + |
| 120 psi | ++ | ++ | ++ | ++ | + | + | + | + |
| 180 psi | ++ | ++ | ++ | ++ | + | + | + | + |
| 240 psi | +++ | ++ | ++ | ++ | + | + | + | + |
| 300 psi | +++ | ++ | ++ | ++ | + | + | + | + |

Key: + (0-50); ++ (51-150); +++ (151-300); ++++ (301-450); +++++ (>450).

TABLE 27H
H₂/CH₄ Selectivity Results of TFC Membranes
of Example 27 at 35° C. and varied pressures

| | H₂ Permeance | CH₄ Permeance | |
|---|---|---|---|
| Pressure | (GPU) | (GPU) | H₂/CH₄ Selectivity |
| 60 | **** | * | ++++ |
| 120 | **** | * | ++++ |
| 180 | **** | * | ++++ |
| 240 | **** | * | ++++ |
| 300 | **** | * | ++++ |
| 360 | **** | * | ++++ |
| 420 | **** | * | ++++ |
| 480 | **** | * | ++++ |
| 540 | **** | * | ++++ |
| 600 | **** | * | ++++ |
| 660 | **** | * | ++++ |
| 720 | **** | * | ++++ |

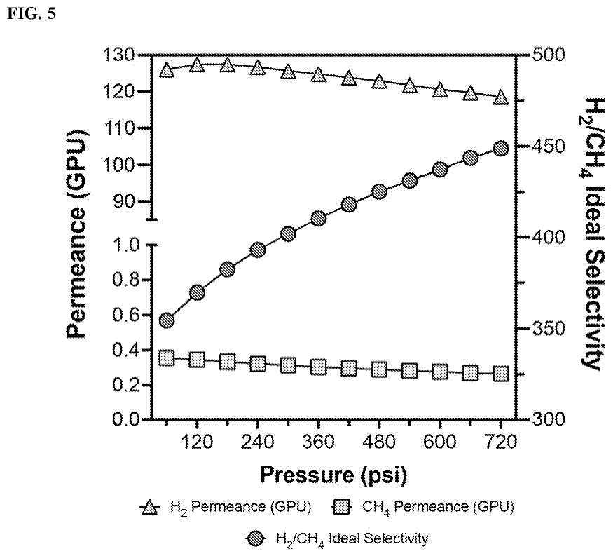

Key: Permeance: * (0.1-5 GPU); ** (6-10 GPU); *** (11-75 GPU); **** (76-200 GPU); ***** (>200 GPU).
Selectivity: + (0-50); ++ (51-150); +++ (151-300); ++++ (301-450); +++++ (>450).
1 GPU = 10⁻⁶ cm³(STP)/(cm² s cm Hg).
Data plotted in FIG. 5.

TABLE 27I
H₂/CH₄ Selectivity Results of TFC Membranes of Example 27
at 35° C. and Varied Pressures in Varied H₂/CH₄ Mixtures

| | H₂/CH₄ Selectivity | H₂/CH₄ Selectivity | H₂/CH₄ Selectivity |
|---|---|---|---|
| | (20% H₂, 80% CH₄) | (10% H₂, 90% CH₄) | (5% H₂, 95% CH₄) |
| 2 bar | +++ | +++ | +++ |
| 4 bar | +++ | +++ | +++ |
| 6 bar | +++ | +++ | +++ |
| 8 bar | +++ | +++ | +++ |

Selectivity: + (0-50); ++ (51-150); +++ (151-300); ++++ (301-450); +++++ (>450).

TABLE 27J
CO₂/CH₄ Selectivity Results of TFC Membranes of Example 27
at 35° C. and Varied Pressures in Varied CO₂/CH₄ Mixtures

| | CO₂ Permeance | CH₄ Permeance | |
|---|---|---|---|
| Pressure | (GPU) | (GPU) | CO₂/CH₄ Selectivity |
| 25 | *** | * | +++ |
| 50 | *** | * | +++ |
| 125 | *** | * | +++ |
| 200 | *** | * | +++ |
| 275 | *** | * | +++ |
| 350 | *** | * | +++ |
| 425 | *** | * | +++ |

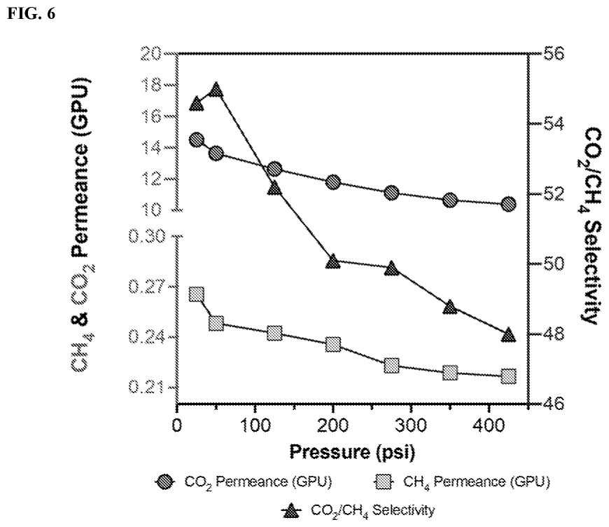

Key: Permeance: * (0.1-5 GPU); ** (6-10 GPU); *** (11-75 GPU); **** (76-200 GPU); ***** (>200 GPU).
Selectivity: + (0-10); ++ (11-50); +++ (51-150); ++++ (>150).
1 GPU = 10⁻⁶ cm³(STP)/(cm² s cm Hg).
Data plotted in FIG. 6.

TABLE 27K
Selectivity Results of TFC Membranes of Example 27
at 35° C. and 4 bar in Varied CO₂/CH₄/H₂S Mixtures

| % H₂S/% CO₂/ | | CO₂ Permeance | CO₂/CH₄ | CO₂/H₂S |
|---|---|---|---|---|
| % CH₄ | Pressure | (GPU) | Selectivity | Selectivity |
| 15/25/60 | 30 | *** | ++ | + |
| 15/25/60 | 60 | ** | ++ | + |
| 15/25/60 | 120 | ** | ++ | + |
| 20/20/60 | 30 | *** | ++ | + |
| 20/20/60 | 60 | ** | ++ | + |
| 20/20/60 | 120 | ** | ++ | + |
| 25/15/60 | 30 | *** | ++ | + |
| 25/15/60 | 60 | ** | ++ | + |
| 25/15/60 | 120 | ** | ++ | + |
| 20/10/70 | 30 | *** | ++ | + |
| 20/10/70 | 60 | ** | ++ | + |
| 20/10/70 | 120 | ** | ++ | + |

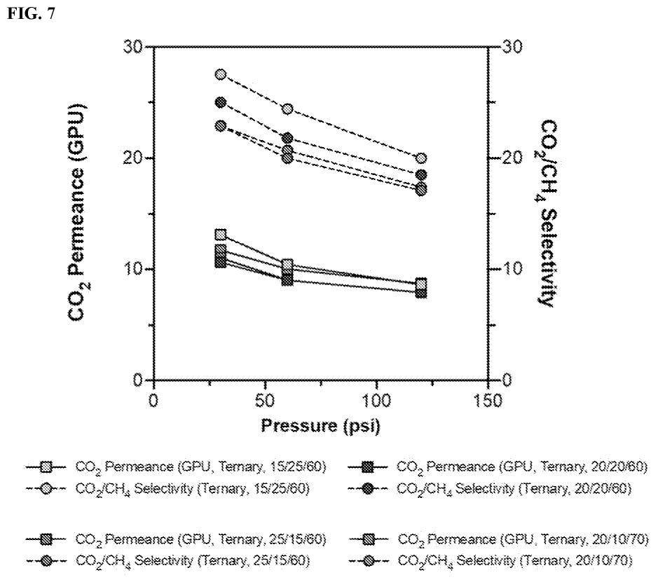

Key: Permeance: * (0.1-5 GPU); ** (6-10 GPU); *** (11-75 GPU); **** (76-200 GPU); ***** (>200 GPU).
Selectivity: + (0-10); ++ (11-50); +++ (51-150); ++++ (>150).
1 GPU = 10⁻⁶ cm³(STP)/(cm² s cm Hg).
Data plotted in FIG. 7.

TABLE 27L
Selectivity Results of TFC Membranes of Example 27 at Varied
Temperatures and Pressures in CO₂/Refrigerant Gas Mixtures

| Temperature | Pressure | CO₂/C₂F₂H₂ | CO₂/CF₂H₂ |
|---|---|---|---|
| (° C.) | (bar) | Selectivity | Selectivity |
| 35 | 25 | +++ | + |
| | 50 | +++ | + |
| 45 | 25 | +++ | + |
| | 50 | +++ | + |

Key: + (0-10); ++ (11-50); +++ (51-150); ++++ (>150).

TABLE 27M
Selectivity Results of TFC Membranes of Example 20 at Varied
Temperatures and Pressures in CO₂/Refrigerant Gas Mixtures

| Temperature | Pressure | CO₂/C₂F₂H₂ | CO₂/CF₂H₂ |
|---|---|---|---|
| (° C.) | (bar) | Selectivity | Selectivity |
| 35 | 25 | +++ | ++ |
| | 50 | +++ | ++ |
| 45 | 25 | +++ | + |
| | 50 | +++ | + |

Key: + (0-10); ++ (11-50); +++ (51-150); ++++ (>150).

TABLE 27N
Permeance of TFC Membranes of Example 27 to
CO₂ at Varied Temperatures and Pressures

| Temperature (° C.) | Pressure (psi) | Permeance CO₂ (GPU) |
|---|---|---|
| 35 | 60 | *** |
| | 120 | *** |
| | 180 | *** |
| | 240 | *** |
| | 300 | *** |
| | 360 | *** |
| | 420 | *** |
| | 480 | *** |
| 45 | 60 | *** |
| | 120 | *** |
| | 180 | *** |
| | 240 | *** |
| | 300 | *** |
| | 360 | *** |
| | 420 | *** |
| | 480 | *** |

Key: Permeance: * (0.1-5 GPU); ** (6-10 GPU); *** (11-75 GPU); **** (76-200 GPU); ***** (>200 GPU).

TABLE 27O
Permeance of TFC Membranes of Example 27 to
CF₂H₂ at Varied Temperatures and Pressures

| Temperature (° C.) | Pressure (psi) | Permeance CF₂H₂ (GPU) |
|---|---|---|
| 35 | 30 | * |
| | 60 | * |
| | 90 | * |
| | 120 | * |
| | 150 | * |
| 45 | 30 | * |
| | 60 | * |
| | 90 | * |
| | 120 | * |
| | 150 | * |

Key: Permeance: * (0.1-5 GPU); ** (6-10 GPU); *** (11-75 GPU); **** (76-200 GPU); ***** (>200

TABLE 27P
Permeance of TFC Membranes of Example 27 to
C₂F₂H₂ at Varied Temperatures and Pressures

| Temperature (° C.) | Pressure (psi) | Permeance C₂F₂H₂ (GPU) |
|---|---|---|
| 35 | 15 | * |
| | 30 | * |
| | 45 | * |
| | 60 | * |
| | 75 | * |
| 45 | 15 | * |
| | 30 | * |
| | 45 | * |
| | 60 | * |
| | 75 | * |

Key: Permeance: * (0.1-5 GPU); ** (6-10 GPU); *** (11-75 GPU); **** (76-200 GPU); ***** (>200 GPU).

TABLE 27Q
Permeance of TFC Membranes of Example 20 to
CO₂ at Varied Temperatures and Pressures

| Temperature (° C.) | Pressure (psi) | Permeance CO₂ (GPU) |
|---|---|---|
| 35 | 60 | *** |
| | 120 | *** |
| | 180 | *** |
| | 240 | *** |
| | 300 | *** |
| | 360 | *** |
| | 420 | *** |
| | 480 | *** |
| 45 | 60 | *** |
| | 120 | *** |
| | 180 | *** |
| | 240 | *** |
| | 300 | *** |
| | 360 | *** |
| | 420 | *** |
| | 480 | *** |

Key: Permeance: * (0.1-5 GPU); ** (6-10 GPU); *** (11-75 GPU); **** (76-200 GPU); ***** (>200 GPU).

TABLE 27R
Permeance of TFC Membranes of Example 20 to
CF₂H₂ at Varied Temperatures and Pressures

| Temperature (° C.) | Pressure (psi) | Permeance CF₂H₂ (GPU) |
|---|---|---|
| 35 | 30 | * |
| | 60 | * |
| | 90 | * |
| | 120 | * |
| | 150 | * |
| 45 | 30 | * |
| | 60 | * |
| | 90 | * |
| | 120 | * |
| | 150 | * |

Key: Permeance: * (0.1-5 GPU); ** (6-10 GPU); *** (11-75 GPU); **** (76-200 GPU); ***** (>200 GPU).

TABLE 27S
Permeance of TFC Membranes of Example 20 to
C₂F₂H₂ at Varied Temperatures and Pressures

| Temperature (° C.) | Pressure (psi) | Permeance C₂F₂H₂ (GPU) |
|---|---|---|
| 35 | 15 | * |
| | 30 | * |
| | 45 | * |
| | 60 | * |
| | 75 | * |
| 45 | 15 | * |
| | 30 | * |
| | 45 | * |
| | 60 | * |
| | 75 | * |

Key: Permeance: * (0.1-5 GPU); ** (6-10 GPU); *** (11-75 GPU); **** (76-200 GPU); ***** (>200 GPU).

TABLE 27T
Permeance and Selectivities of TFC Membranes of Example
20 to C₂F₄H₂ at 35° C. and Varied Pressures

| Pressure | CO₂ Permeance | C₂F₄H₂ Permeance | CO₂/C₂F₄H₂ Ideal |
|---|---|---|---|
| (psi) | (GPU) | (GPU) | Selectivity |
| 15 | *** | * | +++++ |
| 30 | *** | * | +++++ |
| 45 | *** | * | +++++ |
| 60 | *** | * | +++++ |
| 75 | *** | * | +++++ |

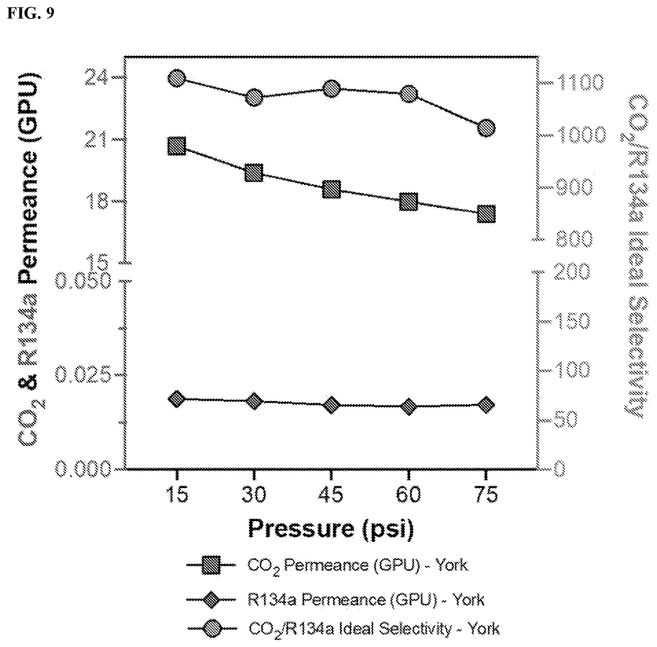

Key: Permeance: * (0.01-5 GPU); ** (6-10 GPU); *** (11-75 GPU); **** (76-200 GPU); ***** (>200 GPU).
Selectivity: + (0-50); ++ (51-150); +++ (151-300); ++++ (301-450); +++++ (>450).
1 GPU = 10⁻⁶ cm³(STP)/(cm² s cm Hg).
Data plotted in FIG. 9.

### Example 28: Gas Permeance and Selectivity Experiments of an Exemplarv Composite

### Membrane 7b

An example of Composite Membrane 7b was prepared according to Example 22, comprising the polymer below:

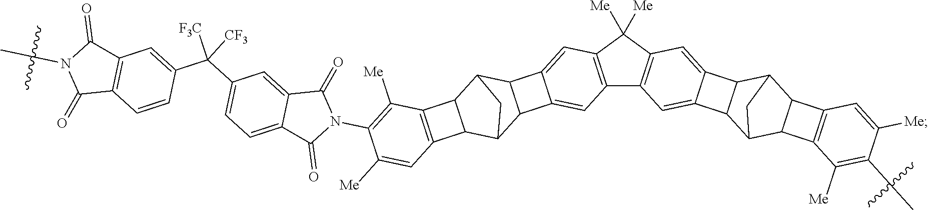 [SMILES: *c1c(C)cc2c(c1C)C1C3CC(C4c5cc6c(cc5C34)-c3cc4c(cc3C6(C)C)C3C5CC(C43)C3c4cc(C)c(N6C(=O)c7ccc(C(c8ccc9c(c8)C(=O)N(*)C9=O)(C(F)(F)F)C(F)(F)F)cc7C6=O)c(C)c4C53)C21]

having Mₙ=32.9 k; M_{w}=68.9 k; PDI=2.1. A series of permeability and selectivity experiments were performed, the results of which are provided in Table 28A and 28B.

TABLE 28A
Permeance and Selectivities of TFC Membranes of
Example 28 to Various Gases at 1 bar, 35° C.

| | Permeance | | |
|---|---|---|---|
| Gases | (GPU) | Gas Pair | Selectivity |
| He | **** | H₂/CH₄ | ++++ |
| H₂ | **** | He/CH₄ | ++++ |
| N₂ | * | CO₂/CH₄ | + |
| O₂ | * | CO₂/N₂ | + |
| CH₄ | * | O₂/N₂ | + |
| CO₂ | *** | N₂/CH₄ | + |
| | | H₂/CO₂ | + |

Key: Permeance: * (0.1-5 GPU); ** (6-10 GPU); *** (11-75 GPU); **** (76-200 GPU); ***** (>200 GPU).
Selectivity: + (0-50); ++ (51-150); +++ (151-300); ++++ (301-450); +++++ (>450).
1 GPU = 10⁻⁶ cm³(STP)/(cm² s cm Hg).

TABLE 28B
Permeance and Selectivities of TFC Membranes of Example
28 to Various Gases at varying pressures, 35° C.

| Pressure | Permeance | Permeance | H₂/CH₄ |
|---|---|---|---|
| (psi) | H₂ (GPU) | CH₄ (GPU) | Selectivity |
| 60 | **** | * | ++++ |
| 120 | **** | * | ++++ |
| 180 | **** | * | ++++ |
| 240 | **** | * | ++++ |
| 300 | **** | * | ++++ |
| 360 | **** | * | ++++ |
| 420 | **** | * | ++++ |
| 480 | **** | * | ++++ |
| 540 | **** | * | +++++ |
| 600 | **** | * | +++++ |
| 660 | **** | * | +++++ |
| 720 | **** | * | +++++ |

Key: Permeance: * (0.1-5 GPU); ** (6-10 GPU); *** (11-75 GPU); **** (76-200 GPU); ***** (>200 GPU).
Selectivity: + (0-50); ++ (51-150); +++ (151-300); ++++ (301-450); +++++ (>450).
1 GPU = 10⁻⁶ cm³(STP)/(cm² s cm Hg).

### Example 29: Gas Permeance and Selectivity Experiments of an Exemplary Composite

### Membrane 6

An example of Composite Membrane 6 was prepared according to Example 21, comprising the polymer below:

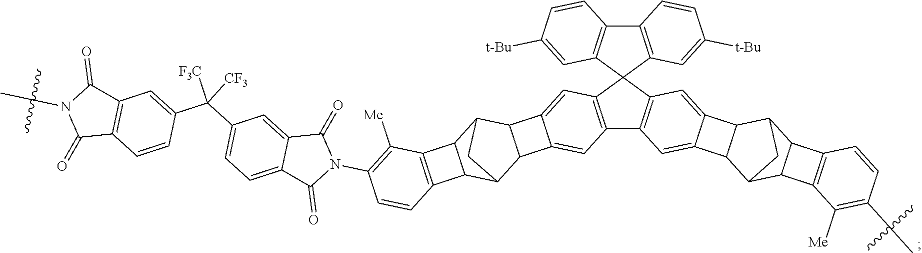 [SMILES: *c1ccc2c(c1C)C1C3CC(C4c5cc6c(cc5C34)-c3cc4c(cc3C63c5cc(C(C)(C)C)ccc5-c5ccc(C(C)(C)C)cc53)C3C5CC(C43)C3c4ccc(N6C(=O)c7ccc(C(c8ccc9c(c8)C(=O)N(*)C9=O)(C(F)(F)F)C(F)(F)F)cc7C6=O)c(C)c4C53)C21]

having Mₙ=44.9 k; M_{w}=116.2 k; PDI=2.6. A series of permeability and selectivity experiments were performed, the results of which are provided in Table 29A.

TABLE 29A
Permeance and Selectivities of TFC Membranes of
Example 28 to Various Gases at 1 bar, 35° C.

| | Permeance | | |
|---|---|---|---|
| Gases | (GPU) | Gas Pair | Selectivity |
| He | | H₂/CH₄ | +++ |
| H₂ | **** | He/CH₄ | |
| N₂ | | CO₂/CH₄ | ++ |
| O₂ | | CO₂/N₂ | |
| CH₄ | * | O₂/N₂ | |
| CO₂ | *** | N₂/CH₄ | |
| | | H₂/CO₂ | + |

Key: Permeance: * (0.1-5 GPU); ** (6-10 GPU); *** (11-75 GPU); **** (76-200 GPU); ***** (>200 GPU).
Selectivity: + (0-50); ++ (51-150); +++ (151-300); ++++ (301-450); +++++ (>450).
1 GPU = 10⁻⁶ cm³(STP)/(cm² s cm Hg).

### Example 30: Gas Permeance and Selectivity Experiments an Exemplary Composite

### Membrane 7a

An example of Composite Membrane 7a was prepared according to Example 22, comprising the polymer below:

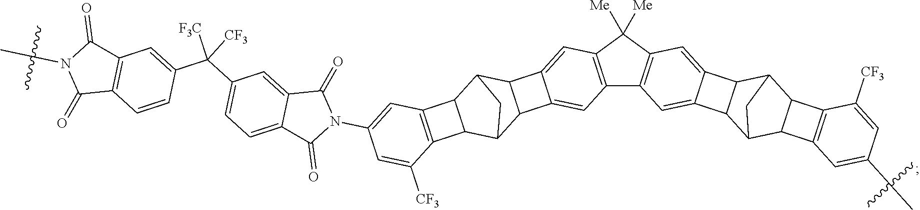 [SMILES: *c1cc2c(c(C(F)(F)F)c1)C1C3CC(C4c5cc6c(cc5C34)C(C)(C)c3cc4c(cc3-6)C3C5CC(C43)C3c4cc(N6C(=O)c7ccc(C(c8ccc9c(c8)C(=O)N(*)C9=O)(C(F)(F)F)C(F)(F)F)cc7C6=O)cc(C(F)(F)F)c4C53)C21]

having Mₙ=27.5 k; M_{w}=61.6 k; PDI=2.2. A series of permeability and selectivity experiments were performed, the results of which are provided in Table 30A.

TABLE 30A
Selectivities of TFC Membranes of Example
30 Various Temperatures and Pressures
Selectivity

| | 35° C., 1 bar | 35° C., 4 bar | 50° C., 4 bar | 60° C., 4 bar |
|---|---|---|---|---|
| H₂/CH₄ | +++++ | +++++ | +++++ | +++++ |
| He/CH₄ | ++++++ | ++++++ | ++++++ | +++++ |
| CO₂/CH₄ | + | + | + | + |
| H₂/CO₂ | + | + | + | + |
| He/CO₂ | + | + | + | + |
| He/H₂ | + | + | + | + |
| CH₄/C₂H₄ | + | + | + | + |
| H₂ GPU | ++ | ++ | ++ | ++ |
| He GPU | ++ | ++ | ++ | ++ |

Key: Selectivity: + (0-50); ++ (51-150); +++ (151-300); ++++ (301-450); +++++ (>450).

### Example 31: Gas Permeance and Selectivity Experiments an Exemplary Composite

### Membrane 8

An example of Composite Membrane 8 was prepared according to Example 23, comprising the polymer below:

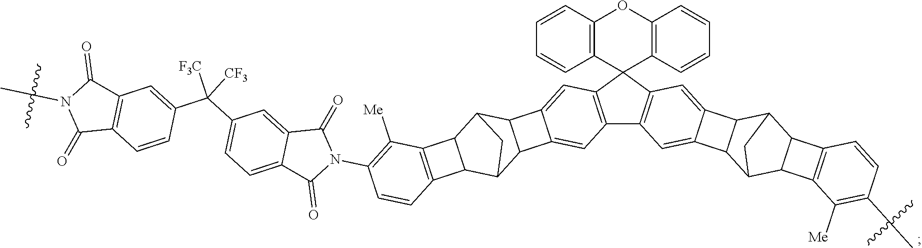 [SMILES: *c1ccc2c(c1C)C1C3CC(C4c5cc6c(cc5C34)-c3cc4c(cc3C63c5ccccc5Oc5ccccc53)C3C5CC(C43)C3c4ccc(N6C(=O)c7ccc(C(c8ccc9c(c8)C(=O)N(*)C9=O)(C(F)(F)F)C(F)(F)F)cc7C6=O)c(C)c4C53)C21]

having Mₙ=22.4 k; M_{w}=37.7 k; PDI=1.7. A series of permeability and selectivity experiments were performed, the results of which are provided in Table 31A.

TABLE 31A
Selectivities of TFC Membranes of Example
31 to Various Gases at 1 bar, 35° C.

| | Permeance | | |
|---|---|---|---|
| Gases | (GPU) | Gas Pair | Selectivity |
| He | **** | H₂/CH₄ | +++ |
| H₂ | **** | He/CH₄ | +++ |
| N₂ | * | CO₂/CH₄ | + |
| CH₄ | * | CO₂/N₂ | + |
| CO₂ | *** | O₂/N₂ | + |
| O₂ | * | N₂/CH₄ | + |
| | | H₂/CO₂ | + |

Key: Permeance: * (0.1-5 GPU); ** (6-10 GPU); *** (11-75 GPU); **** (76-200 GPU); ***** (>200 GPU).
Selectivity: + (0-50); ++ (51-150); +++ (151-300); ++++ (301-450); +++++ (>450).
1 GPU = 10⁻⁶ cm³(STP)/(cm² s cm Hg).

### Example 32: Gas Permeance and Selectivity Experiments an Exemplary Composite Membrane

An example of Composite Membrane 9 was prepared according to Example 24, comprising the polymer below:

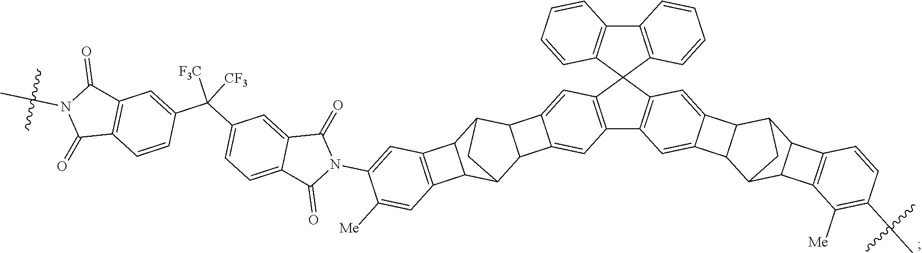 [SMILES: *c1ccc2c(c1C)C1C3CC(C4c5cc6c(cc5C34)-c3cc4c(cc3C63c5ccccc5-c5ccccc53)C3C5CC(C6c7cc(C)c(N8C(=O)c9ccc(C(c%10ccc%11c(c%10)C(=O)N(*)C%11=O)(C(F)(F)F)C(F)(F)F)cc9C8=O)cc7C56)C43)C21]

having Mₙ=29.9 k; M_{w}=54.0 k; PDI=1.8. A series of permeability and selectivity experiments were performed, the results of which are provided in Table 32A.

TABLE 32A
Permeance and Selectivities of TFC Membranes of
Example 32 to Various Gases at 1 bar, 35° C.

| | Permeance | | |
|---|---|---|---|
| Gases | (GPU) | Gas Pair | Selectivity |
| He | **** | H₂/CH₄ | +++ |
| H₂ | **** | He/CH₄ | +++ |
| N₂ | * | CO₂/CH₄ | + |
| CH₄ | * | CO₂/N₂ | + |
| CO₂ | *** | O₂/N₂ | + |
| O₂ | * | N₂/CH₄ | + |
| | | H₂/CO₂ | + |

Key: Permeance: * (0.1-5 GPU); ** (6-10 GPU); *** (11-75 GPU); **** (76-200 GPU); ***** (>200 GPU).
Selectivity: + (0-50); ++ (51-150); +++ (151-300); ++++ (301-450); +++++ (>450).
1 GPU = 10⁻⁶ cm³(STP)/(cm² s cm Hg).

### Example 33: Gas Permeance and Selectivity Experiments an Exemplary Composite

### Membrane 5

An example of Composite Membrane 5 was prepared according to Example 20, comprising the polymer below:

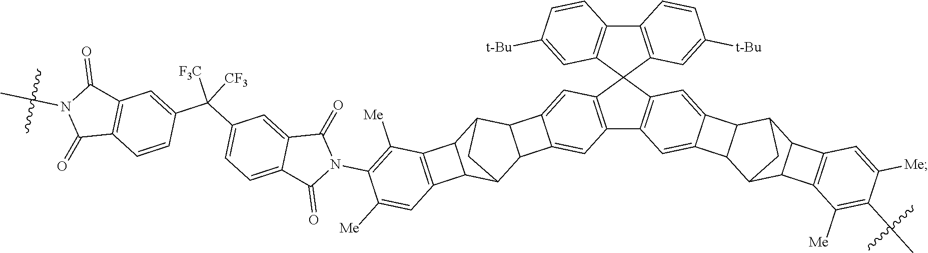 [SMILES: *c1c(C)cc2c(c1C)C1C3CC(C4c5cc6c(cc5C34)-c3cc4c(cc3C63c5cc(C(C)(C)C)ccc5-c5ccc(C(C)(C)C)cc53)C3C5CC(C43)C3c4cc(C)c(N6C(=O)c7ccc(C(c8ccc9c(c8)C(=O)N(*)C9=O)(C(F)(F)F)C(F)(F)F)cc7C6=O)c(C)c4C53)C21]

having Mₙ=23.4 k; M_{w}=58.4 k; PDI=2.5. A series of permeability and selectivity experiments were performed, the results of which are provided in Tables 33A-33C.

TABLE 33A
Permeance of TFC Membranes of Example 33 to
Varying Gases at Varying Pressures, 35° C.

| Gas Permeance (GPU) | | | | | | Selectivity | | | |
|---|---|---|---|---|---|---|---|---|---|
| Pressure | H₂ | He | Ethylene | CH₄ | CO₂ | H₂/CH₄ | H₂/C₂H₄ | CO₂/CH₄ | H₂/C₃H₈ |
| 60 psi | **** | **** | * | * | *** | +++ | +++ | + | ++++ |
| 120 psi | **** | **** | * | * | *** | +++ | ++++ | + | ++++ |
| 180 psi | **** | **** | * | * | *** | ++++ | ++++ | + | ++++ |
| 240 psi | **** | **** | * | * | *** | ++++ | ++++ | + | ++++ |
| 300 psi | **** | **** | * | * | *** | ++++ | ++++ | + | ++++ |

Key: Permeance: * (0.1-5 GPU); ** (6-10 GPU); *** (11-75 GPU); **** (76-200 GPU); ***** (>200 GPU).
Selectivity: + (0-50); ++ (51-150); +++ (151-300); ++++ (301-450); +++++ (>450).
1 GPU = 10⁻⁶ cm³(STP)/(cm² s cm Hg).

TABLE 33B
Permeance of TFC Membranes of Example 33
to Propane at Varying Pressures, 35° C.
Gas Permeance (GPU)

| Pressure | Propane (C₃H₈) |
|---|---|
| 15 psi | * |
| 30 psi | * |
| 45 psi | * |
| 60 psi | * |
| 75 psi | * |

Key: Permeance: * (0.1-5 GPU); ** (6-10 GPU); *** (11-75 GPU); **** (76-200 GPU); ***** (>200 GPU).
1 GPU = 10⁻⁶ cm³(STP)/(cm² s cm Hg).

TABLE 33C
Selectivity of TFC Membranes of Example 33 to
Varying Gases at Varying Pressures, 35° C.

| | Permeance | | | | |
|---|---|---|---|---|---|
| | P(H₂) | P(CH₄) | P(C₂H₆) | Selectivity | |
| | (GPU) | (GPU) | (GPU) | H₂/CH₄ | H₂/C₂H₆ |
| 60 psi | **** | * | * | ++++ | +++++ |
| 120 psi | **** | * | * | ++++ | +++++ |
| 180 psi | **** | * | * | ++++ | +++++ |
| 240 psi | **** | * | * | ++++ | +++++ |
| 300 psi | **** | * | * | ++++ | +++++ |
| 360 psi | **** | * | * | ++++ | +++++ |
| 420 psi | **** | * | * | ++++ | +++++ |
| 480 psi | **** | * | | ++++ | |

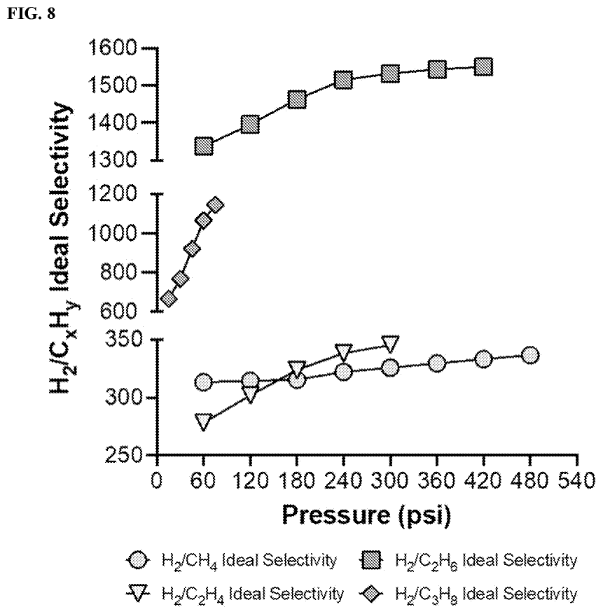

Key: Permeance: * (0.1-5 GPU); ** (6-10 GPU); *** (11-75 GPU); **** (76-200 GPU); ***** (>200 GPU).
Selectivity: + (0-50); ++ (51-150); +++ (151-300); ++++ (301-450); +++++ (>450).
1 GPU = 10⁻⁶ cm³(STP)/(cm² s cm Hg).
Data are plotted in FIG. 8.

### Example 34: Exemplary Composite Membrane 11

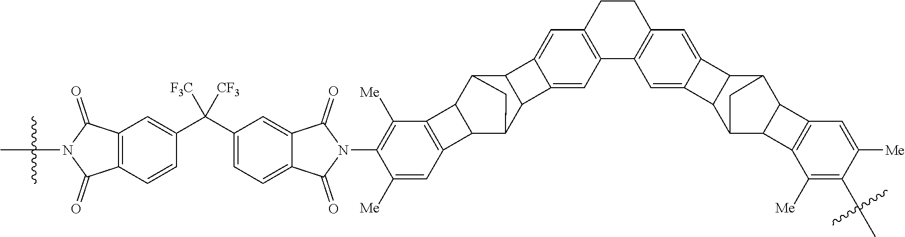 [SMILES: *c1c(C)cc2c(c1C)C1C3CC(C4c5cc6c(cc5C34)-c3cc4c(cc3CC6)C3C5CC(C43)C3c4cc(C)c(N6C(=O)c7ccc(C(c8ccc9c(c8)C(=O)N(*)C9=O)(C(F)(F)F)C(F)(F)F)cc7C6=O)c(C)c4C53)C21]

¹H NMR (500 MHz, CDC₃) δ 8.07 (d, J=8.1 Hz, 2H), 7.96 (s, 4H), 7.38 (q, J=11.7 Hz, 2H), 6.89 (d, J=10.6 Hz, 4H), 3.45-3.18 (m, 8H), 2.82 (s, 4H), 2.44 (d, J=13.0 Hz, 4H), 2.24-2.09 (m, 6H), 2.03 (d, J=5.0 Hz, 6H), 1.03-0.89 (in, 4H).

### Example 35: Gas Permeance and Selectivity Experiments an Exemplary Composite

### Membrane 11

An example of Composite Membrane 11 was prepared according to Example 34, comprising the polymer below:

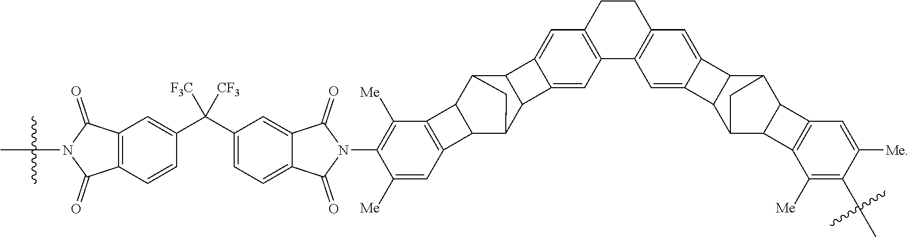 [SMILES: *c1c(C)cc2c(c1C)C1C3CC(C4c5cc6c(cc5C34)-c3cc4c(cc3CC6)C3C5CC(C43)C3c4cc(C)c(N6C(=O)c7ccc(C(c8ccc9c(c8)C(=O)N(*)C9=O)(C(F)(F)F)C(F)(F)F)cc7C6=O)c(C)c4C53)C21]

A series of permeability and selectivity experiments were performed, the results of which are provided in Table 35A.

TABLE 35A
Selectivities of TFC Membranes of Example
35 to Various Gases at 1 bar, 35° C.

| | Permeance | | |
|---|---|---|---|
| Gases | (GPU) | Gas Pair | Selectivity |
| He | **** | H₂/CH₄ | +++ |
| H₂ | **** | He/CH₄ | +++ |
| N₂ | * | CO₂/CH₄ | + |
| CH₄ | * | CO₂/N₂ | + |
| CO₂ | *** | O₂/N₂ | + |
| O₂ | * | N₂/CH₄ | + |
| | | H₂/CO₂ | + |

Key: Permeance: * (0.1-5 GPU); ** (6-10 GPU); *** (11-75 GPU); **** (76-200 GPU); ***** (>200 GPU).
Selectivity: + (0-50); ++ (51-150); +++ (151-300); ++++ (301-450); +++++ (>450).
1 GPU = 10⁻⁶ cm³(STP)/(cm² s cm Hg).

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

We claim:

1. A composite membrane comprising:
a mesoporous membrane support layer comprising a plurality of pores extending through the support layer, said support layer having a first side, a second side, and a thickness; and
optionally, a gutter layer comprising a permeable elastic polymer, said gutter layer having a first side, a second side, and a thickness;
a thin film membrane selective layer comprising a plurality of ladder polymer chains, said selective layer having a first side, a second side, and a thickness;
wherein:
when the gutter layer is present, the second side of the support layer is disposed along the first side of the gutter layer, and the second side of the gutter layer is disposed along the first side of the selective layer;
when the gutter layer is absent, the second side of the support layer is disposed along the first side of the selective layer; and
the thickness of the selective layer is less than about 10 microns.

2. The composite membrane of claim 1, wherein the thickness of the selective layer is less than about 5 microns.

3. The composite membrane of claim 1 or 2, wherein the thickness of the selective layer is less than about 3 microns.

4. The composite membrane of claim 1 or 2, wherein the thickness of the selective layer is from about 0.1 to about 10 microns.

5. The composite membrane of any one of claims 1-4, wherein the thickness of the selective layer is from about 0.1 to about 3 microns.

6. The composite membrane of claim 1-5, wherein the thickness of the selective layer is from about 0.5 to about 1.5 microns.

7. The composite membrane of any one of claims 1-5, wherein the thickness of the selective layer is selected from about 0.50 microns, 0.75 microns, about 1.0 micron, 1.25 microns, about 1.5 microns, about 1.75 microns, about 2 microns, about 2.25 microns, about 2.5 microns, about 2.75 microns, and about 3 microns; preferably wherein the thickness of the selective layer is about 1 micron.

8. The composite membrane of any one of claims 1-7, wherein the plurality of pores extending through the support layer have a pore size from about 2 nm to about 50 nm.

9. The composite membrane of any one of claims 1-8, wherein the thickness of the support layer is from about 15 microns to about 150 microns.

10. The composite membrane of claim 9, wherein the thickness of the support layer is selected from about 15 microns, about 30 microns, about 45 microns, about 60 microns, about 75 microns, about 90 microns, about 105 microns, about 120 microns, about 135 microns, and about 150 microns; preferably wherein the thickness of the support layer is between about 50 and about 60 microns.

11. The composite membrane of any one of claims 1-10, wherein the support layer comprises a polymer selected from polyethylenimine, polyether ether ketone, polyvinylidene difluoride, polyvinylfluoride, polytetrafluoroethylene, poly(acrylonitrile), polysulfone, cellulose acetate, poly ether sulfone, and polyimide.

12. The composite membrane of claim 11, wherein the support layer comprises a plurality of cross-linked polymers.

13. The composite membrane of any one of claims 1-12, wherein the plurality of ladder polymer chains comprises norbornyl arylcyclobutene ladder polymers.

14. The composite membrane of claim 13, wherein the plurality of ladder polymer chains is a plurality of polymer chains comprising at least one unit of Formula I, wherein Formula I consists of a subunit of Formula I′ and a subunit of Formula I″: 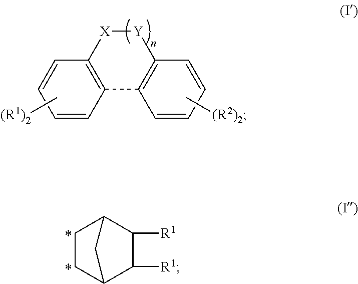
wherein:
each R¹ represents a connection point to the polymer;
each of the two R¹ groups on the subunit of Formula I′ is on an adjacent carbon to another R¹ group;
each R² represents a connection point between the subunit of Formula I′ and a carbon marked with an * on the subunit of Formula I″;
each of the two R² groups is on an adjacent carbon to another R² group;
X is, independently at each occurrence, selected from NR^{A}, O, S, CR^{B}R^{C}, S═O, and C═O;
when present, Y is, independently at each occurrence, selected from NR^{A}, O, S, CR^{B}R^{C}, and C═O;
wherein, when Y is present, at least one of X and Y is CR^{B}R^{C} or C═O;
R^{A} is, independently at each occurrence, selected from H, alkyl, —O-alkyl, and haloalkyl;
R^{B} and R^{C} are, independently at each occurrence, selected from H, OH, SH, halo, amine, alkyl, —(H)C═O, —O-alkyl, and haloalkyl;
or R^{B} and R^{C}, together with the atom to which they are attached, form a cycloalkyl, cycloalkenyl, heterocycloalkenyl, or heterocycloalkyl, which is optionally substituted with one or more R^{G}, wherein R^{G} is selected from H, alkyl, alkoxy, and hydroxy;
n is 0 or 1; and [symbol]
represents an optional bond.

15. The composite membrane of claim 14, wherein the plurality of polymer chains comprises polymers comprising a plurality of repeat units of Formula I.

16. The composite membrane of claim 14 or 15, wherein the plurality of polymer chains comprises at least one unit of Formula Ia:

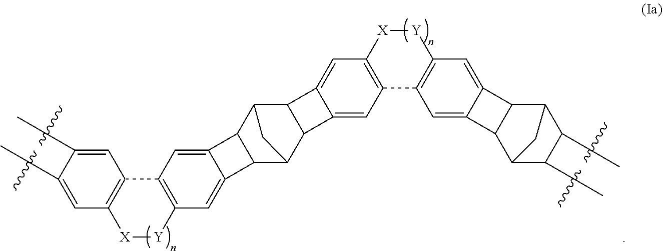

17. The composite membrane of claim 14, wherein the plurality of polymer chains further comprises polymers further comprising another co-monomer.

18. The composite membrane of any one of claims 1-12, wherein the plurality of ladder polymer chains is a plurality of polymer chains comprising at least one unit of Formula II: 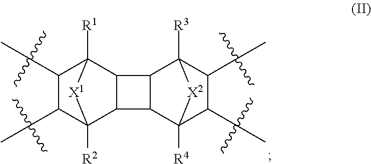
wherein R¹, R², R³, and R⁴ are, independently at each occurrence, selected from H, alkyl, aryl, heterocycloalkyl, halo, a group comprising O, a group comprising O(CO), a group comprising O(CO)O, a group comprising O(CO)N, a group comprising S, a group comprising B, a group comprising NO₂, a group comprising N, a group comprising P, a group comprising (PO), a group comprising CHO, a group comprising (CO), a group comprising (CO)O, a group comprising (CO)N, and a group comprising Si; and
wherein X¹ and X² are independently selected from —O—, —S—, —B(O)R^{a}—, —NR^{a}—, P(O)R^{a}, —(PO)(O)R^{a}—, —CO—, —C(O)R^{a}(O)R^{b}—, and —Si(O)R^{a}(O)R^{b}—, and R^{a} and R^{b} are independently selected from H, alkyl, aryl, and heterocyclyl.

19. The composite membrane of any one of claims 1-12, wherein the plurality of ladder polymer chains is a plurality of polymer chains comprising at least one unit of Formula III: 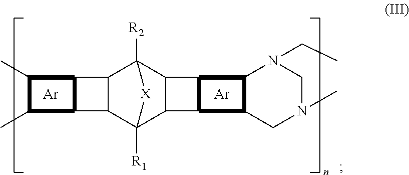
wherein:
Ar is, independently at each occurrence, selected from optionally substituted aryl;
X is selected from —O—, —S—, —B(O)R^{a}—, —NR^{a}—, —P(O)R^{a}—, —(PO)(O)R^{a}—, —CO—, —CR^{a}R^{b}—, —C(O)R^{a}(O)R^{b}—, and —Si(O)R^{a}(O)R^{b}—;
R^{a} and R^{b} are, independently at each occurrence, selected from H, alkyl, aryl, and heterocyclyl;
R₁ and R₂ are, independently at each occurrence, selected from H, linear or branched optionally substituted alkyl, optionally substituted alkoxy, optionally substituted aryl, heterocyclyl, halo, CHO, a group comprising O, a group comprising O(CO), a group comprising O(CO)O, a group comprising O(CO)N, a group comprising S, a group comprising B, a group comprising NO₂, a group comprising N, a group comprising P, a group comprising (PO), a group comprising (CO), a group comprising (CO)O, a group comprising (CO)N, and a group comprising Si; and
n is an integer greater than 1.

20. The composite membrane of any one of claims 1-12, wherein the plurality of ladder polymer chains is a plurality of polymer chains comprising at least one unit of Formula IV, wherein Formula IV consists of a subunit of Formula IV′ and a subunit of Formula IV″: 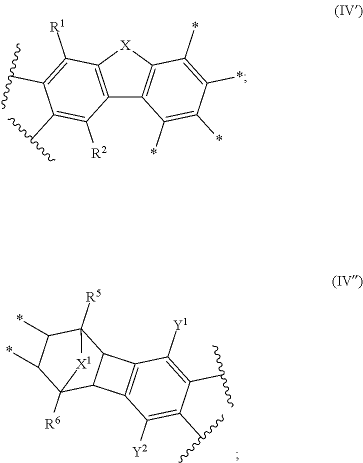
wherein:
two adjacent * of IV′ are bonds to two * of IV″, and the two remaining * of IV′ are R³ and R⁴;
X is selected from alkylene, —O—, —S—, a group comprising nitrogen, cycloalkyl, and heterocyclyl;
Y¹ and Y² are, independently at each occurrence, selected from alkyl;
R¹, R², R³, R⁴, R⁵, and R⁶ are independently selected from a group comprising O, a group comprising O(CO), a group comprising O(CO)O, a group comprising O(CO)N, a group comprising S, a group comprising B, a group comprising NO₂, a group comprising N, a group comprising P, a group comprising (PO), a group comprising CHO, a group comprising (CO), a group comprising (CO)O, a group comprising (CO)N, and a group comprising Si; and
X¹ is selected from —O—, —S—, —B(O)R^{a}—, NR^{a}—, —P(O)R^{a}—, —(PO)(O)R^{a}—, —CO—, —CR^{a}R^{b}—, —C(O)R^{a}(O)R^{b}—, and —Si(O)R^{a}(O)R^{b}—; and
R^{a} and R^{b} are independently selected from H, alkyl, aryl, and heterocyclyl.

21. The composite membrane of any one of claims 18-20, wherein R¹, R², R³, R⁴, R⁵, and R⁶ are, independently at each occurrence, selected from H, optionally substituted alkyl, optionally substituted aryl, optionally substituted heterocyclyl, halo, —OR^{a}, —O(CO)R^{a}, —O(CO)OR^{a}, —O(CO)NR^{a}R^{b}, —SR^{a}, —B(O)R^{a}(O)R^{b}, —NO₂, —NR^{a}R^{b}, —P(O)R^{a}(O)R^{b}, —PO(O)R^{a}(O)R^{b}, —CHO, —(CO)R^{a}, —(CO)OR^{a}, —(CO)NR^{a}R^{b}, and —Si(O)R^{a}(O)R^{b}(O)R^{c}; wherein R^{a}, R^{b}, and R^{c} are, independently at each occurrence, selected from H, optionally substituted alkyl groups, optionally substituted aryl groups, and optionally substituted heterocyclyl.

22. The composite membrane of claim 1, wherein the plurality of ladder polymer chains comprises at least one unit of Formula Ib: 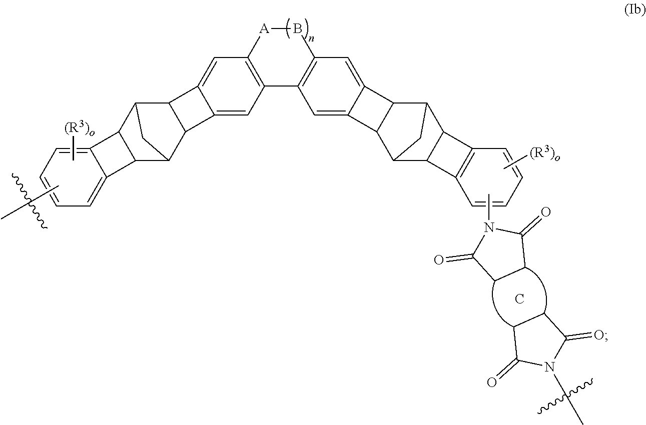
wherein:
each R³ is, independently at each occurrence, selected from C₁-C₄ alkyl, C₁-C₄ fluoroalkyl, halo, optionally substituted amino, and hydroxy;
each R⁴ and R⁵ is, independently at each occurrence, selected from H, C₁-C₄ alkyl, C₁-C₄ fluoroalkyl, halo, optionally substituted amino, and hydroxy;
A is, independently at each occurrence, selected from NR^{D}, O, S, CR^{E}R^{F}, S═O, and C═O;
when present, B is, independently at each occurrence, selected from NR^{D}, O, S, CR^{E}R^{F}, and C═O;
wherein, when B is present, at least one of A and B is CR^{E}R^{F} or C═O;
R^{D} is, independently at each occurrence, selected from H, alkyl, —O-alkyl, or haloalkyl;
R^{E} and R^{F} are, independently at each occurrence, selected from H, OH, SH, halo, amine, alkyl, —(H)C═O, —O-alkyl, and haloalkyl;
or R^{E} and R^{F}, together with the atom to which they are attached, form a cycloalkyl, cycloalkenyl, heterocycloalkenyl, or heterocycloalkyl, which is optionally substituted with one or more R^{H}, wherein R^{H} is selected from H, alkyl, alkoxy, and hydroxy;
optionally wherein R^{E} and R^{F}, together with the atoms to which they are attached, form a
group selected from 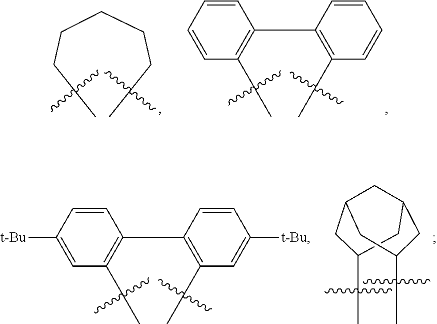
n is 0 or 1;
each o is, independently at each occurrence, 0, 1, 2, or 3; [symbol]
represents an optional bond;
C is, independently at each occurrence, selected from: 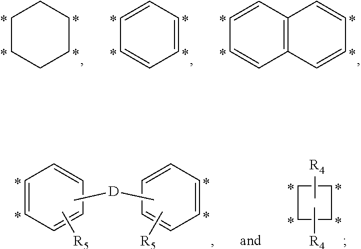
wherein each * represents a point of attachment to the unit of Formula Ib; and
D is, independently at each occurrence, a bond or selected from O, C═O, SO₂, CR₄R₄, phenylene, and

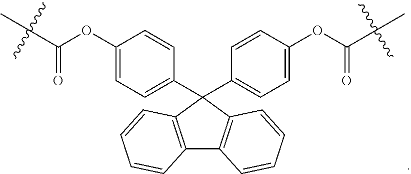 [SMILES: *C(=O)Oc1ccc(C2(c3ccc(OC(*)=O)cc3)c3ccccc3-c3ccccc32)cc1]

23. The composite membrane of claim 22, wherein the at least one unit of Formula Ib is a unit of Formula Ic:

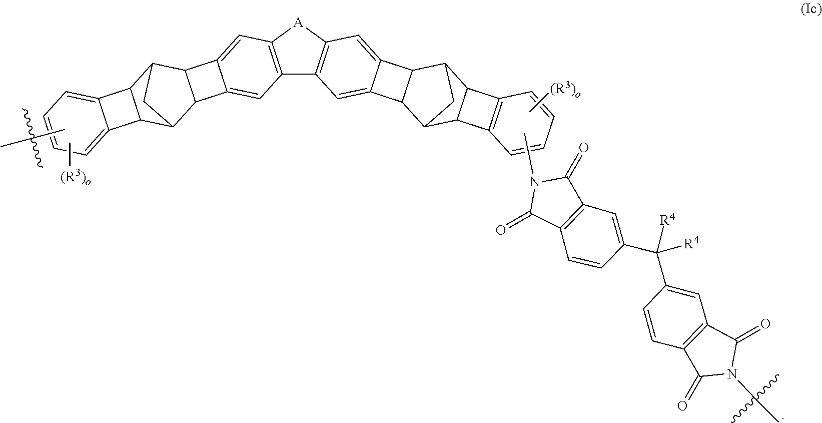

24. The composite membrane of claim 23, wherein the at least one unit of Formula Ic is:

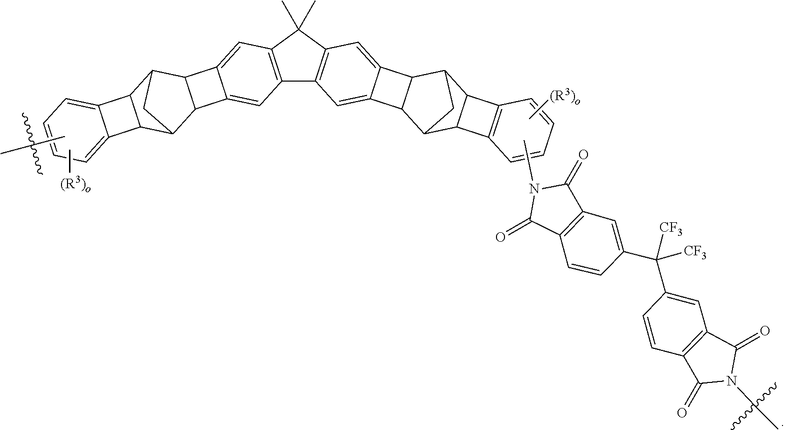

25. The composite membrane of any one of any one of claim 1-24, wherein the gutter layer is present.

26. The composite membrane of claim 25, wherein the gutter layer comprises polysiloxane.

27. The composite membrane of claim 25 or 26, wherein the thickness of the gutter layer is from 0.01 microns to about 10 microns.

28. The composite membrane of any one of claims 1-24, wherein the gutter layer is absent.

29. The composite membrane of any one of claims 1-28, further comprising:
a sealing layer comprising a permeable elastic polymer, said sealing layer having a first side, a second side, and a thickness;
wherein the second side of the selective layer is disposed along the first side of the sealing layer.

30. The composite membrane of claim 29, wherein the thickness of the sealing layer is from about 0.01 microns to about 10 microns.

31. The composite membrane of claim 29 or 30, wherein the sealing layer comprises polysiloxane.

32. The composite membrane of any one of claims 1-31, further comprising:
a non-woven layer comprising a polymeric material, said non-woven layer having a first side, a second side, and a thickness;
wherein the second side of the non-woven layer is disposed along the first side of the support layer; and
the polymeric material is a polyolefin or polyester.

33. The composite membrane of claim 32, wherein the non-woven layer comprises at least one polyester; preferably wherein the polyester is PET.

34. The composite membrane of claim 32 or 33, wherein the non-woven layer comprises at least one polyolefin.

35. The composite membrane of claim 34, wherein the at least one polyolefin is selected from polyethylene, and polypropylene, or combinations thereof.

36. The composite membrane of claim 35, wherein the at least one polyolefin is a combination of polypropylene and polyethylene.

37. The composite membrane of any one of claims 32-36, wherein the thickness of the non-woven layer is from about 50 microns to about 300 microns.

38. The composite membrane of any one of claims 1-37, wherein the composite membrane has a gas permeance for He (P_{He}) from about 1 to about 2000 GPU.

39. The composite membrane of any one of claims 1-37, wherein the composite membrane has a gas permeance for CH₄ (P_{CH4}) from about 0.1 to about 100 GPU.

40. The composite membrane of any one of claims 1-37, wherein the composite membrane has a gas permeance for H₂ (P_{H2}) from about 1 to about 2000 GPU.

41. The composite membrane of any one of claims 1-37, wherein the composite membrane has a gas permeance for N₂ (P_{N2}) from about 0.1 to about 100 GPU.

42. The composite membrane of any one of claims 1-37, wherein the composite membrane has a gas permeance for O₂ (P_{O2}) from about 2 to about 500 GPU.

43. The composite membrane of any one of claims 1-42, wherein the composite membrane is selective for separating CH₄ from He.

44. The composite membrane of claim 43, wherein the selectivity of the composite membrane (P_{He}/P_{CH4}) is from about 100 to about 400.

45. The composite membrane of claim 43, wherein the selectivity of the composite membrane (P_{He}/P_{CH4}) is from about 200 to about 300.

46. The composite membrane of claim 43, wherein the selectivity of the composite membrane (P_{He}/P_{CH4}) is selected from about 200, about 225, about 250, and about 300.

47. The composite membrane of any one of claims 1-46, wherein the composite membrane is selective for separating H₂ from N₂.

48. The composite membrane of claim 47, wherein the selectivity of the composite membrane (P_{H2}/P_{N2}) is from about 100 to about 300.

49. The composite membrane of claim 47, wherein the selectivity of the composite membrane (P_{H2}/P_{N2}) is from about 150 to about 200.

50. The composite membrane of claim 47, wherein the selectivity of the composite membrane (P_{H2}/P_{N2}) is selected from about 150, about 175, and about 200.

51. The composite membrane of any one of claims 43-50, wherein the composite material exhibits said selectivity without being cured for more than about 100 days.

52. The composite membrane of any one of claims 43-50, wherein the composite material exhibits said selectivity without being cured for more than about 7 days.

53. The composite membrane of any one of claims 43-50, wherein the composite material exhibits said selectivity without being cured.

54. The composite membrane of any one of claims 1-52, wherein the composite membrane is in the form of hollow fibers, tubes, sheets, or combinations thereof.

55. A method of preparing a composite membrane of any one of claims 1-54.

56. The method of claim 55, comprising:
providing a support mixture comprising a support polymer precursor, a first solvent, and a second solvent, the support mixture having a first solvent:second solvent ratio;
contacting the support mixture with a substrate, thereby forming a nascent support;
curing the nascent support, the thereby forming a mesoporous support;
providing a selective solution comprising a selective polymer precursor and a third solvent;
coating the mesoporous support with the selective solution, thereby forming a nascent membrane;
annealing and drying the nascent membrane to form the composite membrane.

57. The method of claim 56, wherein the support mixture further comprises a salt.

58. The method of claim 56-58, wherein the first solvent:second solvent ratio is from about 5:1 to about 15:1, preferably wherein the first solvent:second solvent ratio is about 10:1.

59. The method of any one of claims 56-58, wherein the plurality of pores has a pore diameter and a pore volume which are controlled by the first solvent:second solvent ratio.

60. The method of any one of claims 56-59, wherein annealing and drying the nascent membrane to form the composite membrane does not comprise curing for more than 100 days.

61. The method of any one of claims 56-60, wherein annealing and drying the nascent membrane to form the composite membrane does not comprise curing.

62. A method of separating a mixture of fluids comprising a first fluid and a second fluid, the method comprising:
contacting a fluid mixture with a composite membrane of any one of claims 1-54, thereby separating the mixture of fluids into:
a permeate comprising a first portion of the first fluid and a first portion of the second fluid; and
a retentate comprising a second portion of the second fluid.

63. The method of claim 62, wherein the volume percent of the first fluid in the permeate is higher than the volume percent of the first fluid in the mixture of fluids by at least about 1%, about 5%, about 10%, about 20%, about 30%, about 40%, about 50%, about 60%, about 70%, about 80%, about 90%, about 95%, about 97.5%, or about 99%.

64. The method of claim 62 or 63, wherein the volume percent of the second fluid in the permeate is lower than the volume percent of the second fluid in the mixture of fluids by at least about 1%, about 5%, about 10%, about 20%, about 30%, about 40%, about 50%, about 60%, about 70%, about 80%, about 90%, about 95%, about 97.5%, or about 99%.

65. The method of any one of claims 62-64, wherein the volume percent of the first fluid in the permeate is greater than about 99%, about 95%, about 90%, about 80%, about 70%, about 60%, about 50%, about 40%, about 30%, about 20%, about 10%, about 5%, about 2.5%, and about 1%; preferably wherein volume percent of the first fluid in the permeate is greater than about 95%.

66. The method of any one of claims 62-64, wherein the volume percent of the second fluid in the permeate is less than about 99%, about 95%, about 90%, about 80%, about 70%, about 60%, about 50%, about 40%, about 30%, about 20%, about 10%, about 5%, about 2.5%, and about 1%; preferably wherein volume percent of the second fluid in the permeate is less than about 5%.

67. The method of any one of claims 62-65, wherein the volume of the first fluid in the permeate is higher than about 10% by volume, about 20% by volume, about 30% by volume, about 40% by volume, about 50% by volume, about 60% by volume, about 70% by volume, about 80% by volume, about 90% by volume, about 95% by volume, about 98% by volume, or about 99% by volume of the volume of the first fluid in the mixture of fluids; preferably wherein the volume of the first fluid in the permeate is higher than about 80% of the volume of the first fluid in the mixture of fluids.

68. The method of any one of claims 62-67, wherein the first fluid is He, and the second fluid is CH₄.

69. The method of any one of claims 62-67, wherein the first fluid is H₂, and the second fluid is N₂.

70. The method of any one of claims 62-69, wherein the pores of the support member are substantially parallel to the direction of fluid flow through the composite membrane (i.e., direct flow separation).

71. The method of any one of claims 62-69, wherein the pores of the support member are substantially perpendicular to the direction of fluid flow through the composite membrane (i.e., tangential flow separation).
